(19) United States
(12) Patent Application Publication
(10) Pub. No.: US 2014/0178513 A1
(43) Pub. Date: Jun. 26, 2014

(54) Non ionic/electrolyte, liquid/gaseous, mechanically refined/nanoparticle dispersion Building Materials/High Wear-Heat Resistant Part Brushes, Windings, Battery Cells, Brake Pads, Die Cast Molding, Refrigeration, Polarized/Integrated Optical, Spectrometric Processors, Central Processor Unit Processors, Electronic Storage Media, Analogous Series/Parallel Circuit Generators/Transceivers, Particulate Matter PM Carbonaceous-Polyamide, Crystalline Silica, and Cellulosic Filament Extraction/Miners Suit

(71) Applicant: Robert Richard Matthews, Washington, DC (US)

(72) Inventor: Robert Richard Matthews, Washington, DC (US)

(21) Appl. No.: 13/726,531

(22) Filed: Dec. 24, 2012

Related U.S. Application Data
(63) Continuation-in-part of application No. 13/726,205, filed on Dec. 23, 2012, now abandoned.

(51) Int. Cl. B29C 47/00

(52) U.S. Cl. CPC B29C 47/0011
USPC 425/6

(57) ABSTRACT

The variable hydraulic press and distillation reservoir process scientific formula non ionic or electrolyte mechanically refined and nanoparticle dispersion preform slurry extrusion with or without ionic suspension Preform slurry high wear-heat resistant parts electronic composite coils, windings, annealing, drawn, spun, coils, windings, wire, woven textile mesh, shielding, parts brushes, inductors, antinode couplers, electric rheostats, starters, motors, alternators, generators, ionic suspension enhanced composite coils, composite windings, spun wound coils and windings beryllium Be4, magnesium Mg12, copper Cu29 and carbon nanofoam C6, electronic parts capacitors, ionic suspension circuit battery cells, electronic parts rheostats, resistors, transformers, transducers, rectifiers, power supplies, or heat sinks Preform slurry high wear-heat resistant parts aerospace, automotive, and transportation brake calipers, rotors, pads, and bushings Preform slurry non ionic or electrolyte mechanically refined and nanoparticle high wear-heat resistant parts precision casting molds 2.5 phase die cast molding Building Materials fine concrete, mortar, brick, and tiles.

### DOMESTIC PRIORITY DATA

This is an application a continuation in part of preliminary amendment to specification application Ser. No. 13/726,205 Filing Date Dec. 23, 2012.

### BACKGROUND OF THE INVENTION

Global warming and growing concerns of Greenhouse gas emissions from our dependency on fossil fuels are creating real demand and awareness for an electric alternative to fossil fuel engines and expensive replacement parts. Few technological developments of collecting and manufacturing allotropes of carbon improve upon our existing technological structure. By applying scientific utilization of preform technology variable hydraulic preform slurry non ionic or electrolyte mechanically refined and nanoparticle dispersion high wear-heat resistant parts press with manufactured or processed allotropes of carbon assembled resources we can now create the manufacture process of preform slurry non ionic or electrolyte mechanically refined and nanoparticle high wear-heat resistant parts.

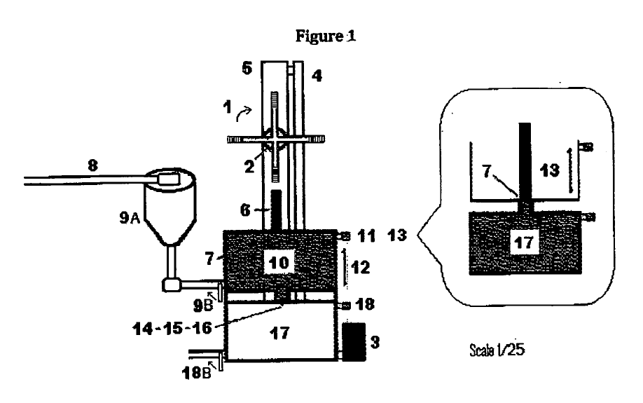

### BRIEF DESCRIPTION OF FIGS. 1, 2 and 3

FIG. 1 Variable hydraulic preform slurry non ionic or electrolyte mechanically refined and nanoparticle dispersion high wear-heat resistant parts press,

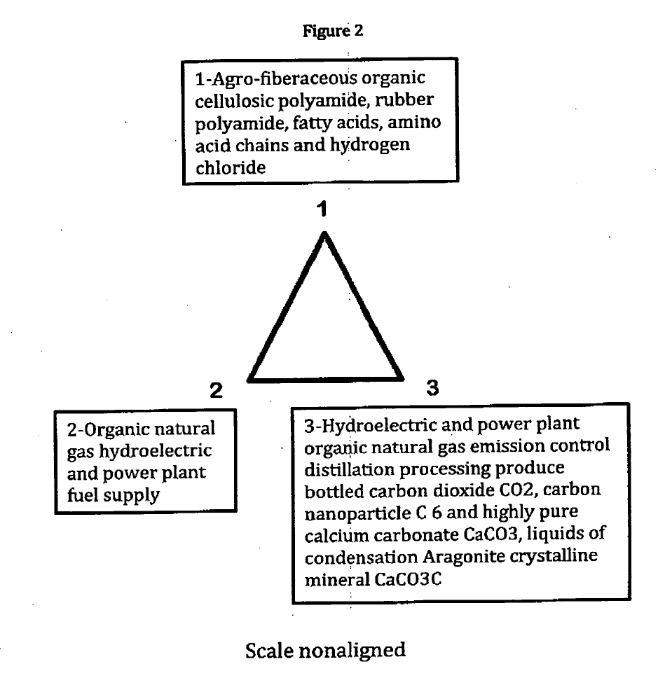

FIG. 2 Agriculture farming renewable organic futures supply over demand pyramid and

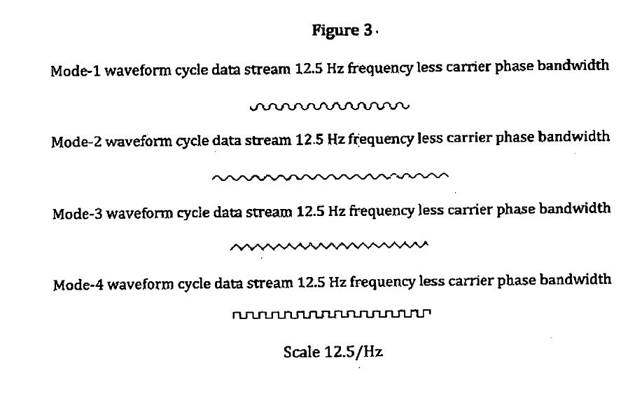

FIG. 3 Modes 1, 2, 3 and 4 waveform cycle data stream 12.5 cycles frequency less carrier phase bandwidth.

### DETAILED DESCRIPTION OF FIGS. 1, 2 and 3

FIG. 1 Variable hydraulic preform slurry non ionic or electrolyte mechanically refined and nanoparticle dispersion high wear-heat resistant parts press 1—Hydraulic control wheel 2—Electronic servo processor 3—Hydraulic pump 4—Hydraulic pipe 5—Hydraulic actuator 6—Hydraulic tool steel arm 7—Slurry non ionic and electrolyte tool steel press plate 8—Slurry non ionic and electrolyte tool steel line in 9A—Gravity feed tool steel collector 9B—Tool steel release portal control 10—Slurry non ionic and electrolyte tool steel reservoir 11—Slurry non ionic and electrolyte reservoir regulated tool steel carbonaceous-polyamide, polyamide and nanoparticle c 6 waste filtration and may liquids and gaseous 12—Slurry non ionic and electrolyte tool steel reservoir expanded 13—Slurry non ionic and electrolyte tool steel reservoir contracted 14—Slurry non ionic and electrolyte reservoir brass-tool steel aperture 15—Tool steel extrusion die cast design brass-tool steel fitting 16—Tool steel electronic servo processor or manual stop control release pull pin 17—Tool steel extrusion die cast design internal cavity 18—Tool steel extrusion die cast design internal cavity regulator carbonaceous-polyamide, polyamide and nanoparticle c 6 waste filtration and may liquids and gaseous and 18B—Tool steel vacuum release portal control, FIG. 2 Pyramid Scale Nonaligned1-Agro-fiberaceous organic cellulosic polyamide, rubber polyamide, fatty acids, amino acid chains and hydrogen chloride 2-Organic natural gas hydroelectric and power plant fuel supply 3—Hydroelectric and power plant organic natural gas emission control distillation processing produce bottled carbon dioxide CO2, carbon nanoparticle C 6 and highly pure calcium carbonate CaCO3, liquids of condensation Aragonite crystalline mineral CaCO3C and FIG. 3 Modes 1, 2, 3 and 4 waveform cycle data stream 12.5 cycles frequency less carrier phase bandwidth.

### BRIEF SUMMARY OF THE INVENTION

Scientific utilization of preform technology variable hydraulic preform slurry non ionic or electrolyte mechanically refined and nanoparticle dispersion high wear-heat resistant parts press FIG. 1 with manufactured or processed allotropes of carbon available resources enables the manufacture process of high wear-heat resistant parts electronic component composite coils beryllium Be4, magnesium Mg12, copper Cu29 and carbon nanofoam C6, spun wound windings beryllium Be4, magnesium Mg12, copper Cu29 and carbon nanofoam C6 annealing, drawn, spun, coils, windings, wire, woven textile mesh, shielding, brushes, inductors, antinode couplers, electric rheostats, starters, motors, alternators, generators, ionic suspension element enhanced composite coils, composite windings, spun wound coils beryllium Be4, magnesium Mg12, copper Cu29 and carbon nanofoam C6, spun wound windings beryllium Be4, magnesium Mg12, copper Cu29 and carbon nanofoam C6 annealing, drawn, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts, aerospace, automotive, transportation brake calipers, rotors, pads, washers, spacers, shims, dowels, bushings, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, and precision casting molds for the manufacturing of highly pure metal, super alloy, highly pure naturally occurring carbon, ceramics, silica alumina or molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, acid solids, alkaline, glass, acrylic, synthetic polymers, halide, alkalide, antimonide, nonconductive zirconia, allotropes of carbon, beryllium Be4 inductor, magnesium Mg12 inductor, carbon C6 nanoparticle conductor, copper Cu29 conductor, alternate carbon nanofoam C6 inductor ACNFI and impedance matching load or signal ceramic red brick clay insulators 1.0 to 2.5 phase extrusions for each A and B specification part.

### DETAILED DESCRIPTION OF THE INVENTION

The variable hydraulic preform slurry non ionic or electrolyte mechanically refined and nanoparticle dispersion allotropes of carbon atomic number 6 symbol C herein referred to as preform slurry non ionic or electrolyte mechanically refined and nanoparticle high wear-heat resistant parts press the center of this utility patent application specification manufacture process of specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 56 elements and/or Specification 57 alloys manufactured 1. preform slurry non ionic or electrolyte mechanically refined and nanoparticle high wear-heat resistant parts electronic component composite coils beryllium Be4, magnesium Mg12, copper Cu29 and carbon nanofoam C6, spun wound windings beryllium Be4, magnesium Mg12, copper Cu29 and carbon nanofoam C6 annealing, drawn, spun, coils, windings, wire, woven textile mesh, shielding, brushes, inductors, antinode couplers, electric rheostats, starters, motors, alternators, generators, ionic suspension element enhanced composite coils, composite windings, spun wound coils beryllium Be4 and carbon nanofoam C6 beryllium Be4 and carbon nanofoam C6, spun wound windings beryllium Be4 and carbon nanofoam C6, annealing, drawn, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts 2. preform slurry non ionic or electrolyte mechanically refined and nanoparticle high wear-heat resistant parts aerospace, automotive, and transportation brake calipers, rotors, pads, washers, spacers, shims, dowels, and bushings 3. preform slurry non ionic or electrolyte mechanically refined and nanoparticle high wear-heat resistant parts precision casting molds for the manufacturing of highly pure metal, super alloy, highly pure naturally occurring carbon, ceramics, silica alumina or molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, acid solids, alkaline, glass, acrylic, synthetic polymers, halide, alkalide, antimonide, nonconductive zirconia, allotropes of carbon, beryllium Be4 inductor, magnesium Mg12 inductor, carbon C6 nanoparticle conductor, copper Cu29 conductor, alternate carbon nanofoam C6 inductor ACNFI and impedance matching load or signal ceramic red brick clay insulators 1.0 to 2.5 phase extrusions for each A and B specification part 4. Building Materials preform slurry specification formula non ionic or electrolyte acid, base, or alkyl distillation reservoir specification vacuum processing with or without scientific electrolysis covalent bonding sequence drawing and spinning formula solutions mechanically refined and nanoparticle dispersion fine concrete, mortar, brick, and tiles.

A cool complete vacuum area less than atmospheric gaseous draws any one particulate matter while fluxing gaseous suspension creates the partial vacuum causing atmospheric suspension particulate matter diffusion equal particle distribution or saturation. Suspension electrolysis positive and negative voltage charges of readymade particulate matter electron valences form molecular diffusion covalent bonding in suspension efficient particle distribution.

A prepared heated specification particulate matter partial vacuum fluxing suspension distillation reservoir continually extracting expanded higher temperature particulate matter melts the instantaneous creation of particulate matter parts of any one, two or more particulate matter materials resultant compound particulate matters.

The specification making of particulate matter molten diffusion melts and Liquids of condensation metals, paste, gels and vapour gels including extremely high optical grade silicon filtered and non filtered, high optical grade allotropes of carbonaceous-silicon particulate matter, high optical grade allotropes of carbonaceous-silicon particulate matter polyamides synthetic resins, high optical grade silicon filtered and non filtered polyamides synthetic resins, potassium ash and feldspar K 19, zirconium Zr 40, S 16 quartz-bearing basalt Ca 20, cobalt Co 27, silica dioxide Si CO₂, sodium oxide Na₂O, calcium oxide CaO, Aragonite crystalline mineral CaCO3, calcium carbonate CaCO3, Potassium Selenite K2SeO3, Calcium sulfate CaSO4, Gypsum hydrate CaSO4 2H2O, 2-methyl-1,3-butadiene, acrylonitrile, cellulose acetate, methyl methacrylate, polyamides, polyethylene, poly ethylene terephthalate, polyesters, polymeric sulfur polyphosphazenes NPCl2, polypropylene, polystyrene, silicones, toluene diisocyanate polyurethane, copolymer based polyacrylic and polyacrylonitrile sodium polyacrylate, tetrafluoroethene, vinyl acetate, vinyl/poly vinyl chloride, synthetic polymer resins, hybrid allotropes of carbon, molecular silica hybrid allotropes of carbon molecular dioxide Si C O₂, molecular sodium oxide Na ₂O compound, molecular calcium oxide Ca O, alkalines with or without magnesium Mg powdered resins, beryllium Be4 inductor, magnesium Mg12 inductor, carbon C6 nanoparticle conductor, copper Cu29 conductor and alternate carbon nanofoam C6 inductor ACNFI, molecular and nanoparticle alumina Al13, Filtered and Non Filtered Beads and Gels, Group 17 the Halogens, Noble Gases, Chlorophyll A, Chlorophyll B, Sulfate SO 4, Methane CH 4, Ammonia NH3, Sulfuric acid H2SO4, Sodium potassium Na K, polymer of isoprene 2-methyl-1 3-butadiene, Acrylonitrile, Cellulose acetate, Methyl methacrylate, Polyamides, Polyethylene, Poly ethylene terephthalate, Polyesters, Polymeric sulfur polyphosphazenes NPCl2, Polypropylene, Polystyrene, Silicones, Toluene diisocyanate polyurethane, Copolymer based polyacrylic and polyacrylonitrile sodium polyacrylate, Tetrafluoroethene, Vinyl acetate, Vinyl/poly vinyl chloride, Sodium chloride NaCl, Ammonium chloride NH 4 C, Phosphorus chlorides PCl3, POCl3 and PCl5, Phosphorus pentachloride P4O10, Sodium hydrogen carbonate NaHCO3, Sodium hydroxide NaOH, Sodium sulfate Na2SO4, saturated aqueous solution Boric oxide B2O3, Hydrochloric acid HCl, chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 56 elements and/or Specification 57 alloys, 1—H—Hydrogen, 2—He—Helium, 3—Li—Lithium, 4—Be—Beryllium, 5—B—Boron, 6—C—Carbon, 7—N—Nitrogen, 8—O—Oxygen, 9—F—Fluorine, 10—Ne—Neon, 11—Na—Sodium, 12—Mg—Magnesium, 13—Al—Aluminum, 14—Si—Silicon, 15—P—Phosphorus, 16—S—Quartz, 17—Cl—Chlorine, 18—Ar—Argon, 19—K—Potassium, 20—Ca—Calcium, 22—Ti—Titanium, 24—Cr—Chromium, 25—Mn—Manganese, 26—Fe—Iron, 27—Co—Cobalt, 28—Ni—Nickel, 29—Cu—Copper, 30—Zn—Zinc, 31—Ga—Gallium, 40—Zr—Zirconium, 41—Nb—Niobium, 42—Mo—Molybdenum, 47—Ag—Silver, 48—Cd—Cadmium, 49—In—Indium, 50—Sn—Tin, 51—Sb—Antimony, 55—Cs—Cesium, 74—W—Tungsten, 78—Pt—Platinum, 79—Au—Gold, specially high heat resistant highly pure metals and alloys, Specification 56 elements, natural cellulosic polyamides resins, natural cellulosic polyamide rubber resins, natural carbonaceous resins, allotropes of carbonaceous nanoparticles, and natural cellulosic fiberaceous resins, allotropes of carbonaceous-silicon particulate matter cement clinkers and sands, high tensile strength heat resistant allotropes of carbonaceous-metals, allotropes of carbonaceous-polyamides synthetic resins, extremely hard heat resistant heavy mineral cement clinkers and sands, fine minerals and sands, ceramic red brick clay impedance matching load or signal insulators, and complex alkaline and acid powders. Starch hydrolyzed polyacrylonitrile superabsorbent non ionic Polysaccharide tool steel and super alloy extrusion in a continuous linearized drawing annealing spinning supersaturated Liquid gel vapours gel into rubbery consistency and resiliency of Polymeric Sulfur molten diffusion melts temperatures 100° C. melts sulfur polymer will turn red color and viscous melts Greater than Less than >159° C. Less than viscous melts Greater than Less than >175° C. 178° C. 250° C. Less than viscous melts into yellow color And 0° C. or 32° F. Liquids of condensation And melts may 2 0 2 oxidation enrichment non ionic Polysaccharide And ionic suspension electrolyte Phosphate Sodium carbon nanoparticle C 6 P 3 S3Na 3, Nitronium carbon C 6 NC 4, Hydrogen chloride carbon C 6 HCl, Phosphorus chlorides carbon C 6 PCl3, POCl3 and PCl5, Phosphorus pentachloride carbon C 6 P4O10, Nitronium chloride carbon C 6 PCl 3 2 NO2Cl, Chloride carbon C 6 Cl 4, Hydrocarbon C 6 HC 4, Methane carbon C 6 CH 4, Ammonia carbon C 6 NH 3, Sulfuric acid carbon C 6 H2SO 4 And Sodium potassium carbon C 6 Na K form supercooled below zero freezing Greater than <0° C. or 32° F. Liquids of condensation formula condensation nuclei particulate matter partial and complete suspension above and below normal atmospheric pressure including supercritical+/−positive pressurization and negative vacuum pump in atmospheres and bars of pressure The Liquids of condensation negative partial diffusion gaseous and may complete suspension interface tool steel and super alloy molten melts Polymeric sulfur Greater than Greater than Less than > consistency and resiliency of Polymeric Sulfur hot melt pour drawn into plumbing in a continuous stream, drawing, may annealing, spinning sulfur polymer gel forming solution under and above normal atmospheric pressure including supercritical+/−positive and negative in atmospheres and bars of pressure The Liquids of condensation negative partial diffusion gaseous and may complete suspension supercooled interface tool steel and super alloy drawn into plumbing sulfur polymer forms into yellow color rubbery fibers of the Polymeric sulfur gel in a continuous stream drawing annealing spinning gel sulfur polymer yellow color may hydraulic fracturing for optical purity or purified enrichment into optical sulfur polymer molecules forming eight member arrangement Polymeric sulfur SO 4, Polymeric sulfur silicon SO 4 SIO2 silicon gels and crystalline gels potassium ash and feldspar K 19, zirconium Zr 40, S 16 quartz-bearing basalt Ca 20, cobalt Co 27, silica dioxide Si CO2, sodium oxide Na₂O, calcium oxide CaO, Aragonite crystalline mineral CaCO3, calcium carbonate CaCO3, Potassium Selenite K2SeO3, Calcium sulfate CaSO4, Gypsum hydrate CaSO4 2H2O, 2-methyl-1,3-butadiene, acrylonitrile, cellulose acetate, methyl methacrylate, natural cellulosic particulate matter C 6 carbonaceous-polyamide, polyethylene, poly ethylene terephthalate, polyesters, polymeric sulfur polyphosphazenes NPCl2, polypropylene, polystyrene, silicones, toluene diisocyanate polyurethane, copolymer based polyacrylic and polyacrylonitrile sodium polyacrylate, tetrafluoroethene, vinyl acetate, vinyl/poly vinyl chloride, synthetic polymer resins, hybrid allotropes of carbon and molecular dioxide C O₂ compound, molecular silica hybrid allotropes of carbon molecular dioxide Si C O₂ compound, molecular sodium oxide Na ₂O compound, and molecular calcium oxide Ca O And may Natural cellulosic polymer of isoprene 2-methyl-1 3-butadiene gel Liquids of condensation nuclei type particulate matter non ionic Alkali and ionic Liquid gel And Crystalline mineralization optical beads gels pellets paste spinning yarn optical gel cable sheet and line annealing drawing spinning optical cable sheet and line and forged extrusions gel forming casting rod or plate drop into drawing annealing spinning or draw anneal and turn spun pressed roll any turn, full, two, one, one half and one quarter turns form cable sheet and line fiber optical visor full view panel visual display up VDU and heads up display HUD All integrated and polarized spectrometry and processors. Liquids of condensation nuclei type particulate matter non ionic Alkali And Ionic suspension electrolyte including Salts, Sulfosalts and Sulfides Liquid condensation metal may 2 0 2 oxidation enrichment non ionic Polysaccharide And ionic suspension electrolyte Phosphate Sodium carbon C 6 P 3 S 3 Na 3 particulate matter condensation metal and/or ceramic alkali and clay, Hexafluorophosphate carbon C 6 PF 6 particulate matter condensation metal and/or ceramic alkali and clay, Nitronium carbon C 6 NC 4 particulate matter condensation metal and/or ceramic alkali and clay, Hydrogen chloride carbon C 6HCl particulate matter condensation metal and/or ceramic alkali and clay, Phosphorus chlorides carbon C 6 PCl3, POCl3 and PCl5 particulate matter condensation metal and/or ceramic alkali and clay, Phosphorus pentachloride carbon C 6 P4O10 particulate matter condensation metal and/or ceramic alkali and clay, Nitronium chloride carbon C 6 PCl 3 2 NO2Cl particulate matter condensation metal and/or ceramic alkali and clay, Chloride carbon C 6 Cl 4 particulate matter condensation metal and/or ceramic alkali and clay, Hydrocarbon C 6 HC 4 particulate matter condensation metal and/or ceramic alkali and clay, Methane carbon C 6 CH 4 particulate matter condensation metal and/or ceramic alkali and clay, Ammonia carbon C 6 NH 3 particulate matter condensation metal and/or ceramic alkali and clay, Sulfuric acid carbon C 6 H2SO 4 particulate matter condensation metal and/or ceramic alkali and clay And Sodium potassium carbon C 6 Na K particulate matter condensation metal and/or ceramic alkali and clay form Liquid condensation metal alkali and clay C 6 carbon nanoparticle, cesium, chromate, silver, gold, platinum, titanium, tungsten, niobium, manganese, steel, tin, copper, aluminum, gallium, nickel, cadmium, zinc, potassium, magnesium, lithium, indium, salts, sulfosalts, sulfides, antimonide, halide, alkalide, and acid complex enriched solidified powder condensation particulate matter Liquid condensation metals include Polymeric sulfur copper Cu carbon C 6 SO 4 And Hexafluorophosphate copper Cu29 carbon C 6 PF 6 And nanoparticle alumina al13. Liquids of condensation paste, gels, vapour gels form ionic suspension element battery cell or liquid metal series and parallel processor printed circuits, drawing, annealing, spinning yarn, wire, sheet flat strips, cable Line, shielding interwoven and composite mesh light makeweight high tensile strength form convex and right angle shapes up to three dimensional design Building Materials and Formed Fabrication.

The specification making of supersaturated particulate matter under and above normal atmospheric pressure measured in atmospheres and bars of pressure one, two or more particulate matter materials supercooled 0° C. or 32° F. interface tool steel, and specification acid, bases, and alkyls gaseous partial and complete suspensions of preform slurry non ionic or electrolyte forming as a naturally occurring phenomenon named cloud condensation nuclei or CCNs also known as cloud seeds are small particles typically 0.2 μm, or 1/100th the size of the average cloud droplet. The liquid vapour requires a non-gaseous surface to make the transition from a vapour to a liquid. The supercooled liquids of condensation nuclei particulate matter one, two or more condensation nuclei particulate matter materials resultant condensation nuclei particulate matters maybe electrolysis spun drawn evaporated dispersed casted extruded and formed into resin powders. The liquids of condensation crystalline mineralization formula superfine and ultrafine nuclei particulate matter are derived at the mineral specific density and supersaturating crystallization mineralization specification supercooled temperature and crystallization pressure. The liquids of condensation nuclei particulate matter materials maybe continuously solution processed into silicon gels and crystalline gels potassium ash and feldspar K 19, zirconium Zr 40, S 16 quartz-bearing basalt Ca 20, cobalt Co 27, silica dioxide Si CO₂, sodium oxide Na₂O, calcium oxide CaO, Aragonite crystalline mineral CaCO3, calcium carbonate CaCO3, Potassium Selenite K2SeO3, Calcium sulfate CaSO4, Gypsum hydrate CaSO4 2H2O, 2-methyl-1,3-butadiene, acrylonitrile, cellulose acetate, methyl methacrylate, polyamides, polyethylene, poly ethylene terephthalate, polyesters, polymeric sulfur polyphosphazenes NPCl2, polypropylene, polystyrene, silicones, toluene diisocyanate polyurethane, copolymer based polyacrylic and polyacrylonitrile sodium polyacrylate, tetrafluoroethene, vinyl acetate, vinyl/poly vinyl chloride, synthetic polymer resins, hybrid allotropes of carbon and molecular dioxide C O2 compound, molecular silica hybrid allotropes of carbon molecular dioxide Si C O2 compound, molecular sodium oxide Na 2O compound, and molecular calcium oxide Ca O, alkalines with or without magnesium Mg powdered resins, beryllium Be4 inductor, magnesium Mg12 inductor, carbon C6 nanoparticle conductor, copper Cu29 conductor and alternate carbon nanofoam C6 inductor ACNFI, molecular and nanoparticle alumina Al13, Filtered and Non Filtered Beads and Gels, Group 17 the Halogens, Noble Gases, Chlorophyll A, Chlorophyll B, Sulfate SO 4, Methane CH 4, Ammonia NH3, Sulfuric acid H2SO4, Sodium potassium Na K, polymer of isoprene 2-methyl-1 3-butadiene, Acrylonitrile, Cellulose acetate, Methyl methacrylate, Polyamides, Polyethylene, Poly ethylene terephthalate, Polyesters, Polymeric sulfur polyphosphazenes NPCl2, Polypropylene, Polystyrene, Silicones, Toluene diisocyanate polyurethane, Copolymer based polyacrylic and polyacrylonitrile sodium polyacrylate, Tetrafluoroethene, Vinyl acetate, Vinyl/poly vinyl chloride, Sodium chloride NaCl, Ammonium chloride NH 4 C, Phosphorus chlorides PCl3, POCl3 and PCl5, Phosphorus pentachloride P4010, Sodium hydrogen carbonate NaHCO3, Sodium hydroxide NaOH, Sodium sulfate Na2SO4, saturated aqueous solution Boric oxide 8203, Hydrochloric acid HCl, chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 56 elements and/or Specification 57 alloys, 1—H—Hydrogen, 2—He—Helium, 3—Li—Lithium, 4—Be—Beryllium, 5—B—Boron, 6—C—Carbon, 7—N—Nitrogen, 8—O—Oxygen, 9—F—Fluorine, 10—Ne—Neon, 11—Na—Sodium, 12—Mg—Magnesium, 13—Al—Aluminum, 14—Si—Silicon, 15—P—Phosphorus, 16—S—Quartz, 17—Cl—Chlorine, 18—Ar—Argon, 19—K—Potassium, 20—Ca—Calcium, 22—Ti—Titanium, 24—Cr—Chromium, 25—Mn—Manganese, 26—Fe—Iron, 27—Co—Cobalt, 28—Ni—Nickel, 29—Cu—Copper, 30—Zn—Zinc, 31—Ga—Gallium, 40—Zr—Zirconium, 41—Nb—Niobium, 42—Mo—Molybdenum, 47—Ag—Silver, 48—Cd—Cadmium, 49—In—Indium, 50—Sn—Tin, 51—Sb—Antimony, 55—Cs—Cesium, 74—W—Tungsten, 78—Pt—Platinum, 79—Au—Gold, specially high heat resistant highly pure metals and alloys, Specification 56 elements, natural cellulosic polyamides resins, natural cellulosic polyamide rubber resins, natural carbonaceous resins, allotropes of carbonaceous nanoparticles, and natural cellulosic fiberaceous resins drawn annealing print rolled film sheet cut strip drawing annealed spun wound wrapped wire coil interwoven shielding cable line spinning yarn and thread insulates spools and woven textile mesh. The supercooled liquids of condensation nuclei particulate matter one, two or more condensation nuclei particulate matter materials resultant condensation nuclei particulate matters natural polymer, natural polyamide, natural cellulosic rubber, silicon, specification 56 elements, specification 57 alloys, alumina nanoparticle and carbon nanoparticle supersaturated deceleration liquid and vapour fluid transfer into synthetic polymer melt molten diffusion hydraulic forged molding rod and plate cast one half turn spin, drop, drawing, annealing, spinning, rolled and cut yarn, sheet, film and strip. The supercooled liquids of condensation nuclei particulate matter one, two or more condensation nuclei particulate matter materials resultant condensation nuclei particulate matters polymer, polyamide, silicon, specification 56 elements, alumina nanoparticle and carbon nanoparticle supersaturated deceleration liquid and vapours fluid transfer into specification formula acid, base and alkyl electron valences into plumbing drawing and spinning solution including silicon, natural polymer, natural polyamide, natural polymer, natural cellulosic rubber, specification 56 elements, alumina nanoparticle and carbon nanoparticle tool steel interface fluid timed supercooling deceleration specification of continuous linear dispersion gel electron valences into plumbing drawing, annealing, spinning and rolled cut yarn, sheet, film and strip. The supercooled liquids of condensation nuclei particulate matter one, two or more condensation nuclei particulate matter materials resultant condensation nuclei particulate matters polymer, polyamide, silicon, specification 56 elements, alumina nanoparticle and carbon nanoparticle supersaturated deceleration liquid and vapour fluid transfer into supercritical supercooled deceleration hydraulic forged molding rod and plate dispersion cast one half turn spin, drop, drawing, annealing, spinning, rolled and cut yarn, sheet, film and strip.

Distillation reservoir and recovery basin made of super alloy, and/or ceramic, and/or allotropes of carbon or beryllium Be4 inductor, magnesium Mg12 inductor, carbon C6 nanoparticle conductor, copper Cu29 conductor and alternate carbon nanofoam C6 inductor ACNFI filler and adhesive insulator including variable hydraulic press plate for specification distillation processing. Polarized windshields, optical glass, polymers gels distillation positively and negatively charging electrolysis of molten glass, optical glass, reflective beads, polymer gels, lenses, up to or greater >1.25 inch left to right vertical and horizontal picture resolution integrated and polarized photogray, photocolor and photochemical light filtered light identification photo chemically active electron molecule film mirrors, polarized windshield casted or molten diffusion forged, and molten specification materials 1.0 to 2.0 phase casted or extruded and distillation processing of specification highly pure metal, super alloy, ceramic, and alkaline. Windshield and specification materials are chemically surface treated distillation processed with specification acid and bases and Specification 56 elements or mechanically refined and nanoparticle specification acid and bases dispersions. Molten diffusion-plating with or without electrolysis of mechanically refined and nanoparticle Specification 56 elements, Specification 57 alloys, copper nanoparticles, colloidal gold, silver nanoparticles, iron nanoparticles, molecular tool steel, molecular super alloy, element nanoparticles, platinum nanoparticles printed circuits, super alloy including allotropes of carbon printed circuits, allotropes of carbon printed circuits, beryllium Be4 inductor, magnesium Mg12 inductor, carbon C6 nanoparticle conductor, copper Cu29 conductor and alternate carbon nanofoam C6 inductor ACNFI printed circuits, allotropes of carbon ionic suspension element printed circuits nickel, cadmium, lithium, magnesium, and nanoparticle alumina molecular ionic dispersion or molecular ionic covalent bonding series, parallel printed circuits, random access memory RAM and writable random access memory WRAM. Electrolysis distillation positively and negatively charged electron molecules allotropes of carbon, beryllium Be4 inductor, magnesium Mg12 inductor, carbon C6 nanoparticle conductor, copper Cu29 conductor and alternate carbon nanofoam C6 inductor ACNFI, nanoparticle alumina, Specification 56 elements, and Specification 57 alloys with greater and lesser than normal atmospheric pressure, super heating, super cooling scientific molecular diffusion, and fractional distillation are accomplished. Distillation processing mechanically refined particles measure in microns Symbol μ lower-case letter mu metric SI equivalent silica mineral, mineral sands, heavy minerals, alumina, nanoparticle alumina, highly pure naturally occurring carbon, alkaline, acid solids, allotropes of carbon, beryllium Be4 inductor, magnesium Mg12 inductor, carbon C6 nanoparticle conductor, copper Cu29 conductor and alternate carbon nanofoam C6 inductor ACNFI, gold, silver, platinum, lead, acrylic and synthetic polymers, catalyst gaseous and electrolysis process materials for sintering and smelting pouring molten materials to apertures of variable hydraulic press plate, die cast extrusion molds, crucibles, and mold casings. Other distillation processing mechanically refined and nanoparticle preform slurry non ionic or electrolyte dispersion or molten highly pure metal, super alloy, highly pure naturally occurring carbon, allotropes of carbon, beryllium Be4 inductor, magnesium Mg12 inductor, carbon C6 nanoparticle conductor, copper Cu29 conductor and alternate carbon nanofoam C6 inductor ACNFI, nanoparticle alumina, alumina, silica alumina or molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, silica mineral, mineral sands, heavy minerals, glass, acrylic, synthetic polymer, acid solid, impedance matching ceramic red brick insulator, molybdenum, ceramic zirconia, ceramic silica, ceramic clay, Aragonite crystalline mineral CaCO3, calcium carbonate CaCO3, Potassium Selenite K2SeO3, Calcium sulfate CaSO4, Gypsum hydrate CaSO4 2H2O, silicon dioxide SiO2, sodium oxide Na2O, calcium oxide CaO, alkalines, minerals, including ionic suspension elements and ceramic silica mineral insulator for Specification 56 elements highly pure metal, and Specification 57 alloys. Distillation reservoir specification manufactured battery conservation of energy cool and cold low temperature operating range made Series of right angles 2 π radians or one full turn the sum of the exterior angles form convex regular polygons corrugated and compartmented light makeweight fabrication monocombe shapes of triangle, square, pentagon, hexagon, heptagon, octagon, nonagon, polynumber and planess and right angle combinations light makeweight design electromagnetic conductive Group 17 the halogens, antimony Sb, Polysaccharide And ionic suspension electrolyte Phosphate Sodium carbon C 6 P 3 S 3 Na 3 particulate matter including Salts, Sulfosalts and Sulfides condensation metal, Hexafluorophosphate carbon C 6 PF 6 particulate matter condensation metal, Nitronium carbon C 6 NC 4 particulate matter condensation metal, Hydrogen chloride carbon C 6HCl particulate matter condensation metal, Phosphorus chlorides carbon C 6 PCl3, POCl3 and PCl5 particulate matter condensation metal, Phosphorus pentachloride carbon C 6 P4O10 particulate matter condensation metal, Nitronium chloride carbon C 6 PCl 3 2 NO2Cl particulate matter condensation metal, Chloride carbon C 6 Cl 4 particulate matter condensation metal, Hydrocarbon C 6 HC 4 particulate matter condensation metal, Methane carbon C 6 CH 4 particulate matter condensation metal, Ammonia carbon C 6 NH 3 particulate matter condensation metal, Sulfuric acid carbon C 6 H2SO 4 particulate matter condensation metal and/or ceramic alkali and clay And Sodium potassium carbon C 6 Na K particulate matter condensation metal mechanically refined particles measure in microns Symbol μ lower-case letter mu metric SI equivalent alumina particles, alkaline particles, nickel particles, cadmium particles, lithium particles, magnesium particles, fused ionic material complex mechanically refined particles measure in microns Symbol μ lower-case letter mu metric SI equivalent acid complex particles, alkaline complex particles, antimonide complex particles, halide complex particles, alkalide complex particles, mechanically refined particles measure in microns Symbol μ lower-case letter mu metric SI equivalent Specification 56 conductive elements and Specification 57 conductive alloys, allotropes of carbon, beryllium Be4 inductor, magnesium Mg12 inductor, carbon C6 nanoparticle conductor, copper Cu29 conductor, alternate carbon nanofoam C6 inductor ACNFI and nanoparticle alumina measure in nanometers Nm. Distillation processing and/or for up to four molten pours 1.0 to 2.5 phase casted or extruded molten material or preform slurry non ionic or electrolyte. Molten pours and variable hydraulic press plate preform slurry non ionic or electrolyte mechanically refined and nanoparticle dispersion under vacuum control room scientific distillation ordinary atmospheric pressure less than ordinary atmospheric pressure catalyst gases other Specification 56 elements argon, carbon monoxide, carbon dioxide, or other gases mechanically refined or nanoparticle suspension catalyst greater or lesser than ordinary atmospheric pressure molecular diffusion, super cooling, and fractional distillation specification suspension may also accomplish allotropes of carbon hybridizations. Super alloy super cooling refrigeration vacuum pump and super alloy curved or linear expression comprising a scientific aperture, a divergence measured in angulation, and a scientific aperture diffusive gaseous particle vacuum pump negative pressurized stream accelerator super cooling refrigeration deceleration with or without nanoparticle synthesizing laser ablation and multi-waveform ablation X, Y, Z alignment with or without fluxing agents, molecular alumina al13, and fractional vacuum distillation gaseous and/or positive and negative ionic charges recovery and super alloy and/or ceramics and/or highly pure naturally occurring carbon and allotropes of carbon filler and adhesive insulator distillation reservoir variable hydraulic press plate expanded and contracted greater or lesser than ordinary atmospheric pressure distillation recovery fractional vacuum distillation gaseous and/or positive distillation and variable hydraulic press plate expanded and contracted greater or lesser than ordinary atmospheric pressure distillation recovery allotropes of 6 C carbon, carbon, solid, liquid, and gases chemical non ionic groups of amphoteric polysaccharide linear or branched alkyl compounds or electrolytes and/or liquid ions and/or ionic melts and/or fused and/or acid and bases catalyst and/or catalyst slurry reservoir 6 C allotropes of carbon and liquid and/or liquid vapours and/or gaseous electrolyte catalyst acids and solid materials highly pure metal, super alloy, highly pure naturally occurring carbon, allotropes of carbon, beryllium Be4 inductor, magnesium Mg12 inductor, carbon C6 nanoparticle conductor, copper Cu29 conductor and alternate carbon nanofoam C6 inductor ACNFI, nanoparticle alumina, alumina, silica alumina or molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, silica mineral, mineral sands, heavy minerals, glass, acrylic, synthetic polymer, acid solid, impedance matching ceramic red brick insulator, molybdenum, ceramic zirconia, ceramic silica, ceramic clay, Aragonite crystalline mineral CaCO3, calcium carbonate CaCO3, Potassium Selenite K2SeO3, Calcium sulfate CaSO4, Gypsum hydrate CaSO4 2H2O, silicon dioxide SiO2, sodium oxide Na2O, calcium oxide CaO, alkalines, minerals, including ionic suspension elements and ceramic silica mineral insulator for Specification 56 elements highly pure metal, and Specification 57 alloys for building materials preform slurry specification formula non ionic or electrolyte acid, base, or alkyl distillation reservoir specification vacuum processing with or without scientific electrolysis covalent bonding sequence drawing and spinning formula solutions mechanically refined and nanoparticle dispersion fine concrete, mortar, brick, and tiles, and high wear-heat resistant parts brushes, windings, coils; battery cells, electronic resistors, capacitors, brake pads, washers, spacers, bushings, annealing, drawn, spun, coils, windings, wire, woven textile mesh, shielding, and 1.0 to 2.5 phase casted or extruded die cast molding. An insulate, electronic part, brake calipers part, rotors part, brake pads, washers, spacers, shims, dowels, bushings part light weight chemical ionic acid usually an amino acid, non ionic bases usually nitrogen/hydrogen or non ionic groups of amphoteric polysaccharide linear or branched alkyl compounds usually methyl continuous sheets cut films insulate, specification formula non ionic or electrolyte acid, base, or alkyl distillation reservoir specification vacuum processing scientific electrolysis covalent bonding sequence drawing and spinning formula solutions mechanically refined and nanoparticle dispersion continuous spinning yarn and thread, spinning yarn and thread, preform optical grade silica and forged optical grade silica with or without natural polymer, natural polymer rubber, synthetic polymer, natural polyamide, natural polyamide rubber, allotropes of C6 carbon, and all specification materials. Variable hydraulic press, plate or distillation reservoir liquid dispersion and particulate matter PM specifications of nanoparticle and condensation-nuclei type size particles measure in microns Symbol μ lower-case letter mu metric SI equivalent natural polymer, natural polymer rubber, synthetic polymer, allotropes of C6 carbon, and all specification materials slurry non ionic heated or chilled interface 8—Slurry non ionic tool steel line in heated or chilled chemical ionic acid usually an amino acid, non ionic bases usually nitrogen/hydrogen or non ionic groups of amphoteric polysaccharide linear or branched alkyl compounds usually methyl liquid dispersion liquid dispersion heated chemical non ionic groups of amphoteric polysaccharide linear or branched alkyl compounds methyl liquid dispersion natural polymer carbon, natural polymer or synthetic polymer carbon, allotropes of carbon, allotropes of carbon silica, allotropes of carbon silica alumina/nano alumina and allotropes of carbon alumina/nano alumina and all specification materials or liquid dispersion chilled polysaccharide linear or branched alkyl compounds and reinforcement of allotropes of carbon networks in suspension drying over usually fifteen minutes result network light weight natural polymer carbon, natural polymer or synthetic polymer carbon, allotropes of carbon, allotropes of carbon silica, allotropes of carbon silica alumina/nano alumina and allotropes of carbon alumina/nano alumina and all specification materials controllable, high purity, connectivity, strength, conductivity, and/or shape.

The Plant Flu Gas Detoxification System is scientifically designed and utilized to chemically control plant flu gas discharge to chemically change carbon monoxide CO, reduce carbon dioxide CO2, to a new yield of water H2O, carbon dioxide CO2, and calcium chloride CaCl2. No emissions are admitted into the atmosphere. One hundred percent 100% of the waste products are controlled as recycled materials bottled carbon dioxide CO2, calcium chloride CaCl2 solids, and Hydrogen chloride HCl chemically pure CaCO3 distillation. Plant flu gas discharge enters the flu gas stack from a fuel fired furnace. A central processing unit CPU computer controls twenty gates that are gradated vertically at even intervals along the stack. Each gate is opened and closed at intervals as the central processing unit CPU computer monitors discharge from the fuel fired furnace from scientific distribution and measurement in cubic feet per millisecond of volume of flu gas discharge. There are twenty 20 flu gas stack gates each attached and assigned to a specific cylindrical horizontal skid. There are twenty 20 cylindrical horizontal skids that receive flu gas discharge recovery at intervals from each flu gas stack gate. The flu gas discharge enters the cylindrical horizontal skid and receives a hydrochloric acid HCl suppressant. The carbon monoxide CO absorbs and neutralizes the hydrochloric acid HCl and yields water H2O and calcium chloride CaCl2. There are twenty 20 hydrochloric acid HCl injection nozzles evenly spaced along each cylindrical horizontal skid. Each cylindrical horizontal skid is channeled to a common reservoir basin recovery distillation process system. The common reservoir basin recovery distillation process system from recovery to recycled and waste material utilizes four scientific principles of distillation operation that are steam, ordinary atmospheric pressure, vacuum, and fractional. The four scientific principles of distillation steam, ordinary atmospheric pressure, vacuum, and fractional are utilized to reduce gas, oil, coal, and other fuel fired furnace power or industrial plant flu gas discharge to recyclable bottled carbon dioxide CO2, calcium chloride CaCl2 solids, water H2O, and Hydrogen chloride HCl chemically pure CaCO3 distillation. The Plant Flu Gas Detoxification System is scientifically designed and utilized to convert carbon monoxide CO and hydrochloric acid HCl to yield recyclables calcium chloride CaCl2 solids and water H20. The Plant Flu Gas Detoxification Hydrogen chloride HCl chemically pure CaCO3 distillation plant flu gas discharge to one hundred percent 100% emission free operation with recyclables bottled CO2 and Hydrogen chloride HCl chemically pure CaCO3 distillation. The Plant Flu Gas Detoxification System is scientifically designed and utilized to convert carbon monoxide CO and hydrochloric acid HCl to yield recyclables calcium chloride CaCl2 solids and water H2O. The Plant Flu Gas Detoxification Hydrogen chloride HCl chemically pure CaCO3 distillation plant flu gas discharge to one hundred percent 100% emission free operation with recyclables bottled CO2 and Hydrogen chloride HCl chemically pure CaCO3 distillation. Specification of four scientific principles of distillation steam, ordinary atmospheric pressure, vacuum, and fractional to reduce gas, oil, coal, and other fuel fired furnace power or industrial plant flu gas discharge to recyclable bottled Carbon Dioxide CO2, calcium chloride CaCl2 solids, water H2O, and Hydrogen chloride HCl chemically pure CaCO3 distillation.

Building Materials preform slurry specification formula non ionic or electrolyte acid, base, or alkyl distillation reservoir specification vacuum processing with or without scientific electrolysis covalent bonding sequence drawing and spinning formula solutions mechanically refined and nanoparticle dispersion fine concrete, mortar, brick, and tiles. Building materials preform modular fine concrete arrives in trucks readymade utilized with manufacture process connector system die cast super alloy or tool steel molten-forged crimping tool heated or cooled particulate matter carbonaceous-polyamide interwoven textile mesh, and molten-forged super alloy or tool steel connectors that work with easy to build box framing techniques, hydraulic cement on-site preform modular casting molds and preform modular fine readymade concrete poured directly from hydraulic and vacuum pumps on readymade truck. Precast or preform modular numeric screened mesh range sizes from fine to superfine concrete sand and fine to ultrafine concrete clinker hydraulic cement designation code specification in series readymade wall, doorway, ceiling, floor, corner end, window frame, fixture, and ornament precast or preform modular hydraulic dispersion formed installation system. Preform modular manufacture process connector system surveying tools and techniques ionic paint markers and alidade Very high frequency VHF and Ultra high frequency UHF industrial/business narrowband 12.5 kHz bandwidth efficiency technology utilizing crystal quartz transceiver transmitting and receiving to crystal quartz transceiver ground mode-C marker Earth Positioning System EPS transmitting and receiving mode-C for construction generator carrier phase L1 and L2 waveform transponder pulse train signals modes 4 four mode-1 convex waveform cycles ˜ less than < and equal to carrier narrowband 12.5 kHz bandwidth, mode-2 polynumber waveform cycle ˜ less than < and equal to carrier narrowband 12.5 kHz bandwidth N1, N2, N3, N4, N5, N6, N7, N8, N9, N10, N11 & N12, mode-3 inclination waveform cycle [symbol] less than < and equal to carrier narrowband 12.5 kHz bandwidth and mode-4 declination waveform cycle [symbol] less than < and equal to carrier narrowband 12.5 kHz bandwidth wavenumber data added and subtracted order identification in nanoseconds processing geodetic spatial datum reference Universal Transverse Mercator UTM geographic six-ten digit grid coordinates, distance, azimuth, and level reference identification Cartesian system datum numeric generation returns coordinates in a local east-north-up ENU Cartesian system corresponding to coordinates X, Y, Z in an Earth-Centered Earth-Fixed ECEF spheroid-centric Cartesian system. Ready mix mortar is packaged and distributed in specially made thermoplastic sealed injection molded preformed containers and airtight dispenser system. Specialized construction abatement and miners suit carbonaceous-polyamide textile interwoven mesh push to talk PTT and self-actuating microphone intercommunication system, textile woven rip-stop technique sewn fibers, liners, air tight light makeweight head gear, crystalline silica optical with or without natural polyamide, natural rubber polyamide, allotropes of C6 carbon, alumina al13, synthetic polymers, natural polymers, or natural polymers rubber filtered and non filtered visor, inner layer air pressurized isolated breathable oxygen gaseous mixture supplied by light makeweight textile woven carbonaceous-polyamide, carbonaceous-fiberaceous and composite materials knitted/stitched interwoven textile fabrics, and woven-mesh in X, Y, and Z alignment rip-stop reinforcing technique weaving thick reinforcement threads interwoven at regular intervals in a crosshatch pattern fabrics having thin and light makeweight structure from thick threads being interwoven in a thinner cloth sewn fibers oxygen tank and second inner layer carbon dioxide CO₂ accelerated negative pressurized supercooled system powered by magnesium nanoparticle light makeweight battery cell.

Supplemental super alloy super cooling refrigeration vacuum pump and super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to less than −109 degrees Fahrenheit or −78.5 degrees Celsius supercooled gaseous refrigerant super cooling super alloy or super alloy. Refrigerant specification of naturally occurring carbon dioxide CO₂ and distillation reservoir specification hybridizations of allotropes of carbon, solution pure oxides O₂, distillation reservoir covalent bonding, electrolysis, and molecular diffusion produce hybrid allotropes of carbon and molecular dioxide C O₂ compound, silica hybrid allotropes of carbon molecular dioxide Si C O₂ compound, chloride hybrid allotropes of carbon C Cl compound, methane Ch4, nitrate hybrid allotropes of carbon N C compound, and hydrogen hybrid allotropes of carbon H C compound. High negative pressurized levels are maintained by vacuum pump circuit.

Self contained naturally occurring carbon dioxide CO₂, hybrid allotropes of carbon and molecular dioxide C O₂ compound, methane Ch4, nitrate hybrid allotropes of carbon N C compound, and hydrogen hybrid allotropes of carbon H C compound refrigeration units commercial, residential, or portable super alloy vacuum pump drawing gaseous refrigerant through insulated super alloy feeder tubes in a parallel circuit to separate super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to less than −109 degrees Fahrenheit or −78.5 degrees Celsius supercooled gaseous refrigerant is then passed over super alloy and through cooling fan. High negative pressurized levels are maintained by vacuum pump circuit.

Self contained naturally occurring carbon dioxide CO₂, hybrid allotropes of carbon and molecular dioxide C O₂ compound, methane Ch4, nitrate hybrid allotropes of carbon N C compound, and hydrogen hybrid allotropes of carbon H C compound refrigeration units commercial, residential, or portable super alloy vacuum pump rated alternating current AC or direct current DC drawing gaseous refrigerant through insulated super alloy feeder tubes in a parallel circuit to separate numeric super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to less than −109 degrees Fahrenheit or −78.5 degrees Celsius supercooled gaseous refrigerant passes over super alloy and through cooling fan. Numeric isolated super alloy cylinders in series and parallel thermo conductive circuits are connected to the refrigeration unit from super alloy connecting rods super cooling the outside walls of the cylinders. The outer cylinder cools activating an electronic air compressor rated alternating current AC or direct current DC filling the inner variable cylinders with compressed air providing diffusive compensation expanding or contracting the inner cylinders as fluctuating compensator forcing the carbon dioxide CO₂ filled outer cylinders through a continuous circuit of super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to greater than −109 degrees Fahrenheit or −78.5 degrees Celsius carbon dioxide CO₂ forming dry ice in the outer internal cylinders. High negative pressurized levels are maintained by vacuum pump circuit.

Distillation and recovery basin automation mass production variable hydraulic press plate mold Super alloy, and/or ceramic, carbon C6 nanoparticle conductor, and alternate carbon nanoparticle C6 inductor ACNFI filler and adhesive insulator pour aperture located in the center and hydraulic cylinder located on the right expanded and contracted for molten pouring highly pure metal printed circuits and cells, super alloy including allotropes of carbon printed circuits and cells nickel, cadmium, lithium, lead, antimonide, halide, alkalide, Specification 56 elements printed circuits and cells, or Specification 57 alloys printed circuits and cells and/or ceramic insulator for 1.0, and 2.0 phase extrusion plates, sheets, foil, leaf and films central processing Unit CPU processor circuit, generator circuit, transceiver circuit, relay circuit, switch circuit, sensor circuit, electronic part cell circuit, battery cell circuit, electronic part circuit highly pure metals, specification 57 alloys, super alloys, specification 56 elements, beryllium Be4, beryllium Be4 inductor, magnesium Mg12, magnesium Mg12 inductor, copper Cu29 conductor, aluminum al13 conductor, carbon C6 nanoparticle conductor and alternate C6 carbon nanoparticle inductor ACNFI. Electronic storage medium data plates, sheets, foil, leaf, and films or series and parallel circuits, battery cell series and parallel circuits rated conductive, ceramic silica mineral insulator or ceramic alumina silica allotropes of carbon insulator. Distillation and recovery basin automation mass production crucible casted molten highly pure metal printed circuits and cells, super alloy, allotropes of carbon printed circuits and cells nickel, cadmium, lithium, lead, antimonide, halide, alkalide, Specification 56 elements printed circuits and cells, or Specification 57 alloys printed circuits and cells and/or ceramic insulator for 1.0, and 2.0 phase castings plates, sheets, foil, leaf, and films central processing Unit CPU processor circuit, generator circuit, transceiver circuit, relay circuit, switch circuit, sensor circuit, electronic part cell circuit, battery cell circuit, electronic part circuit highly pure metals, specification 57 alloys, super alloys, specification 56 elements, beryllium Be4, beryllium Be4 inductor, magnesium Mg12, magnesium Mg12 inductor, copper Cu29 conductor, aluminum al13 conductor, carbon C6 nanoparticle conductor and alternate C6 carbon nanoparticle inductor ACNFI. Electronic storage medium data plates, sheets, foil, leaf, and films or series and parallel circuits, battery cell series and parallel circuits rated conductive, ceramic silica mineral insulator or ceramic alumina silica allotropes of carbon insulator. Distillation and recovery basin automation mass production variable hydraulic press plate mold Super alloy, and/or ceramic, carbon C6 nanoparticle conductor, and alternate carbon nanoparticle C6 inductor ACNFI filler and adhesive insulator pour aperture located in the center and hydraulic cylinder located on the right expanded and contracted for pouring non ionic or electrolyte preform slurry with mechanically refined and nanoparticle dispersion fine printing highly pure metal printed circuits and cells, allotropes of carbon, alumina nanoparticles, copper nanoparticles, colloidal gold, silver nanoparticles, iron nanoparticles, molecular tool steel, molecular super alloy, element nanoparticles, platinum nanoparticles printed circuits and cells, super alloy including allotropes of carbon printed circuits and cells, allotropes of carbon printed circuits and cells, beryllium Be4 inductor, magnesium Mg12 inductor, carbon C6 nanoparticle conductor, copper Cu29 conductor and alternate carbon nanofoam C6 inductor ACNFI printed circuits and cells, allotropes of carbon ionic suspension element printed circuits and cells nickel, cadmium, lithium, magnesium, lead, antimonide, Specification 56 elements printed circuits and cells, or Specification 57 alloys printed circuits and cells and/or ceramic insulator for 1.0, and 2.0 phase extrusion plates, sheets, foil, leaf, and films central processing Unit CPU processor circuit, generator circuit, transceiver circuit, relay circuit, switch circuit, sensor circuit, electronic part cell circuit, battery cell circuit, electronic part circuit highly pure metals, specification 57 alloys, super alloys, specification 56 elements, beryllium Be4, beryllium Be4 inductor, magnesium Mg12, magnesium Mg12 inductor, copper Cu29 conductor, aluminum al13 conductor, carbon C6 nanoparticle conductor and alternate C6 carbon nanoparticle inductor ACNFI. Electronic storage medium data plates, sheets, foil, leaf, and films or series and parallel circuits, battery cell series and parallel circuits rated conductive, ceramic silica mineral insulator or ceramic alumina silica allotropes of carbon insulator. Distillation and recovery basin automation mass production crucible casted non ionic or electrolyte preform slurry with mechanically refined or nanoparticle dispersion fine printing highly pure metal printed circuits and cells, allotropes of carbon, alumina nanoparticles, copper nanoparticles, colloidal gold, silver nanoparticles, iron nanoparticles, molecular tool steel, molecular super alloy, element nanoparticles, platinum nanoparticles printed circuits and cells, super alloy including allotropes of carbon printed circuits and cells, allotropes of carbon printed circuits and cells, beryllium Be4 inductor, magnesium Mg12 inductor, carbon C6 nanoparticle conductor, copper Cu29 conductor and alternate carbon nanofoam C6 inductor ACNFI printed circuits and cells, allotropes of carbon ionic suspension element printed circuits and cells nickel, cadmium, lithium, magnesium, lead, antimonide, Specification 56 elements printed circuits and cells, or Specification 57 Alloys printed circuits and cells and/or ceramic for 1.0, and 2.0 phase castings plates, sheets, foil, leaf, and films central processing Unit CPU processor circuit, generator circuit, transceiver circuit, relay circuit, switch circuit, sensor circuit, electronic part cell circuit, battery cell circuit, electronic part circuit highly pure metals, specification 57 alloys, super alloys, specification 56 elements, beryllium Be4, beryllium Be4 inductor, magnesium Mg12, magnesium Mg12 inductor, copper Cu29 conductor, aluminum al13 conductor, carbon C6 nanoparticle conductor and alternate C6 carbon nanoparticle inductor ACNFI. Electronic storage medium data plates, sheets, foil, leaf, and films or series and parallel circuits, battery cell series and parallel circuits rated conductive, ceramic silica mineral insulator or ceramic alumina silica allotropes of carbon insulator. Distillation reservoir interchangeable combinations of preform slurry non ionic, electrolyte, or molten ceramic and conductive circuits 2.0 extrusions or castings are accomplished for each specification part. Specification of molten diffusion particulate matter PM melts carbonaceous-polyamide, crystalline silica optical, crystalline silica synthetic polymer optical, crystalline silica cellulosic natural polymer, and crystalline silica cellulosic rubber natural polymer optical filtered and non filtered specifications condensation-nuclei type size particles measure in microns Symbol μ lower-case letter mu metric SI equivalent crystalline silica optical, crystalline silica synthetic polymer optical, crystalline silica cellulosic natural polymer, and crystalline silica cellulosic rubber natural polymer optical added molten diffusive particulate matter PM filtered condensation-nuclei type size particles measure in microns Symbol μ lower-case letter mu metric SI equivalent filtered versions of crystalline silica optical, crystalline silica synthetic polymer optical, crystalline silica cellulosic natural polymer, and crystalline silica cellulosic rubber natural polymer optical are filtered alumina, filtered nano alumina, filtered naturally occurring carbon, filtered allotropes of—alternate carbon nanotube inductor and infrared spectrum light analogous identification, filtered radioactive radiation protection precious metals, and filtered Specification 56 Elements spectrum.

Alternate carbon nanofoam C6 inductor ACNFI and specification 56 elements inductors or conductors electronic storage media is manufactured plates, sheets, foil, or leaf on ceramic, highly pure metal, super alloy, or distillation reservoir alternate carbon nanofoam C6 inductor ACNFI annealing, drawing, and spun pressed electronic tape 3250 bits per second BPS, 6250 bits per second BPS, 7 MM millimeter, and compact disc CD writable random access memory WRAM.

Manufacture process of 1.0 to 2.5 phase extrusions die cast molding for precision casting of highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields and optical No₃-diamond dust mineralization transceiver alignment integrated and casted or molten diffusion forged polarized reflective beads translucent, blue, white, purple, yellow, red, green and orange-red radiate outwards up to and greater than 400 percent magnification for aircraft and airway systems, beryllium Be4 inductor, magnesium Mg12 inductor, carbon C6 nanoparticle conductor, copper Cu29 conductor and alternate carbon nanofoam C6 inductor ACNFI filler and adhesive insulator.

The precision casting of highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields and optical No₃-diamond dust mineralization transceiver alignment integrated and casted or molten diffusion forged polarized reflective beads translucent, blue, white, purple, yellow, red, green and orange-red radiate outwards up to and greater than 400 percent magnification for aircraft and airway systems, beryllium Be4 inductor, magnesium Mg12 inductor, carbon C6 nanoparticle conductor, copper Cu29 conductor and alternate carbon nanofoam C6 inductor ACNFI filler and adhesive insulator is a layered greater than 0% to less than 100% precision casting of highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields and optical No₃-diamond dust mineralization transceiver alignment integrated, polarized casted and molten diffusion forged reflective beads translucent, blue, white, purple, yellow, red, green and orange-red radiate outwards up to and greater than 400 percent magnification for aircraft and airway systems, beryllium Be4 inductor, magnesium Mg12 inductor, carbon C6 nanoparticle conductor, copper Cu29 conductor and alternate carbon nanofoam C6 inductor ACNFI filler and adhesive insulator and greater than 0% to less than 100% other precision casting of highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields and optical No₃-diamond dust mineralization transceiver alignment integrated, polarized casted and molten diffusion forged reflective beads translucent, blue, white, purple, yellow, red, green and orange-red radiate outwards up to and greater than 400 percent magnification for aircraft and airway systems, beryllium Be4 inductor, magnesium Mg12 inductor, carbon C6 nanoparticle conductor, copper Cu29 conductor and alternate carbon nanofoam C6 inductor ACNFI filler and adhesive insulator part that is created by pouring molten metal, alloy, halide, alkalide, antimonide, ceramic, glass, acid solid, alkaline, synthetic polymer, non molten formula ceramic slip, acid solid, alkaline, and preform slurry non ionic or electrolyte allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator into a cast mold over a process of 1.0 to 2.5 phase extrusions that create two to six molded casts for each designed master tool steel part that is manually machined and manufactured named part X external layer highly pure metal, super alloy, halide, alkalide, antimonide, ceramic, glass, acid solid, alkaline, synthetic polymer, including preform slurry non ionic or electrolyte allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator and Part Z the internal layer other highly pure metal, super alloy, halide, alkalide, antimonide, ceramic, glass, synthetic polymer, acid solid, alkaline, including preform slurry non ionic or electrolyte allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator. Manufactured process of 1.0 to 2.5 phase extrusions die cast molding for precision casting of super alloy, ceramic, and material ultimately create a single part identical to the master designed and machine manufactured part with the exception to the chemical element is now a super alloy, super alloy ceramic, or super material that may be layered greater than 0% to less than 100% highly pure metal, super alloy, super material, including allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator and greater than 0% to less than 100% other highly pure metal, super alloy, super material including allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator. Processing molded halves sequence 1 to 9 of manufacture process 1.0 to 2.5 phase extrusions die cast molding for precision casting of highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields and optical No₃-diamond dust mineralization transceiver alignment integrated, polarized casted and molten diffusion forged reflective beads translucent, blue, white, purple, yellow, red, green and orange-red radiate outwards up to and greater than 400 percent magnification for aircraft and airway systems, beryllium Be4 inductor, magnesium Mg12 inductor, carbon C6 nanoparticle conductor, copper Cu29 conductor and alternate carbon nanofoam C6 inductor ACNFI filler and adhesive insulator part X and part Z side profile not shown here of casting for part X two halves sequence 1, side profile not shown here of casting for part Z two halves sequence 2, side profile not shown here of casting for part Z extruded halves sequence 3, cast 1 half of part X sequence 4, cast 3 half of part Z sequence 5, extruded cast 5 half of part Z sequence 6, side profile not shown here of cast 5 on top cast 1 on bottom sequence 7, side profile not shown here of cast 6 on top and cast two on bottom sequence 8, fill halves joined in cast 1 and 2 filled with molten on non molten formula materials including preform slurry non ionic or electrolyte allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator sequence 9. The manufacture process begins by a designed and machined manufactured master part named part X. The master part X is used to create two external cast halves. This is accomplished by casting the master part X into the center of two ceramic molded halves with newly poured ceramic slip. After the ceramic slip dries the master part X is removed and the two ceramic molded halves are ignited and cured in a furnace.

The second master part named part Z is designed and machined manufactured greater than 0% to less than 100% less than tolerances that of the master part X or the external cast halves. Again, the master part Z is used to create two internal cast halves. This is accomplished by casting the master part Z into the center of two ceramic molded halves with newly poured ceramic slip. After the ceramic cast dries the master part Z is removed and the two ceramic molded halves are ignited and cured in a furnace. After the two ceramic cast halves cool they are used separately to make two reciprocal extrusion halves by again pouring ceramic slip into the recesses and joining both halves with new cast covers to dry. The external tolerances of all of the four cast covers X and Z are identical opposing so that X and Z halves can be joined and prepared for two separate halves molten or non molten formula highly pure metal, super alloy, or material including allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator fills. After the poured molten highly pure metal, super alloy, or materials including allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator cools or cures then both extruded halves are removed and stored. The remainder halves with highly pure metal, super alloy, or materials including allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator are then joined and prepared for a second molten fill of greater than 0% to less than 100% highly pure metal, super alloy, or materials including allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator. After the fill is cooled the whole part is removed from the cast halves and may be inspected, deburred, and/or finished.

The variable hydraulic preform slurry non ionic or electrolyte mechanically refined and nanoparticle dispersion high wear-heat resistant parts press FIG. 1 numbers 1 to 18. The 1—Hydraulic control wheel is connected to the 2—Electronic servo processor and allows the operator to expand and contract 7—Slurry non ionic and electrolyte tool steel press plate primarily to expand the 10—Slurry non ionic and electrolyte tool steel reservoir by moving the 1—Hydraulic control wheel in a fully counter clockwise fashion. This allows the operator to initiate a separate machine to pump Slurry non ionic and electrolyte into the 8—Slurry non ionic and electrolyte tool steel line in, subsequently to the 9—Gravity feed collector line out and finally to the 10—Slurry non ionic and electrolyte tool steel reservoir. Slurry non ionic and electrolyte is defined here as specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 56 elements and/or Specification 57 alloys manufactured preform slurry non ionic or electrolyte mechanically refined and nanoparticle high wear-heat resistant parts. After the 10—Slurry non ionic and electrolyte tool steel reservoir is filled the operator can electronically disengage or manually remove the manual stop control release pull pin. The operator then closes the 9B—Tool steel control to prepare for the extrusion. The operator would proceed by rotating the 1—Hydraulic control wheel in a clockwise fashion contracting the 7—Slurry non ionic and electrolyte tool steel press plate and forcing the Slurry non ionic and electrolyte comprised of non ionic or electrolyte mechanically refined and nanoparticle slurry formula into the 17—Tool steel extrusion die cast design internal cavity. The specified amount of Slurry non ionic and electrolyte is compressed to preform slurry non ionic or electrolyte mechanically refined and nanoparticle specification pressure measured in millibars Mb until the specified Slurry non ionic and electrolyte required to fill the 17—Tool steel extrusion die cast design internal cavity has been reached. The 1—Hydraulic control wheel is then locked until the 17—Tool steel extrusion die cast design internal cavity has been removed.

The 2—Electronic servo processor sends an electrical signal to the 3—Hydraulic pump of the 7—Slurry non ionic and electrolyte tool steel press plate position that is calibrated to the 1—Hydraulic control wheel.

The 3—Hydraulic pump receives an electrical signal from the 2—Electronic servo processor of the 7—Slurry non ionic and electrolyte tool steel press plate position that is calibrated to the 1—Hydraulic control wheel. The 3—Hydraulic pump pumps fluids to the 4—Hydraulic pipe.

The 4—Hydraulic pipe receives fluids from the 3—Hydraulic pump and conveys the fluids to the 5—Hydraulic actuator.

The 5—Hydraulic actuator receives fluids from the 4—Hydraulic pipe and the force from the fluids is transferred through the actuator as vertical up-and-down movement to an affixed 6—Hydraulic arm.

The 6—Hydraulic arm moves vertically up-and-down and forces the 7—Slurry non ionic and electrolyte tool steel press plate to expand and contract.

The 7—Slurry non ionic and electrolyte tool steel press plate is forced by the 6—Hydraulic arm to expand and contract.

The 8—Slurry non ionic and electrolyte tool steel line in receives Slurry non ionic and electrolyte from an external pump and conveys them to the 9A—Gravity feed tool steel collector. The 8—Slurry non ionic and electrolyte tool steel line in can be ionic process tool steel interface positive or negative electrode electronically charged for enhanced formulation.

The 9A—Gravity feed tool steel collector receives Slurry non ionic and electrolyte from the 8—Slurry non ionic and electrolyte tool steel line in and conveys them to the 10—Slurry non ionic and electrolyte tool steel reservoir.

The 10—Slurry non ionic and electrolyte tool steel reservoir receives Slurry non ionic and electrolyte from the 9A—Gravity feed tool steel collector line out.

After the 10—Slurry non ionic and electrolyte tool steel reservoir is filled the 9B—Tool steel control is utilized to close the opening to prepare for the extrusion and may be provisionally locked and stopped at any position.

The 11—Slurry non ionic and electrolyte reservoir regulated tool steel carbonaceous-polyamide, polyamide and nanoparticle c 6 waste filtration and may liquids and gaseous removes waste from the 10—Slurry non ionic and electrolyte tool steel reservoir while it is being filled with Slurry non ionic and electrolyte from common recovery distillation heated interface tool steel and thermometer gauge, ordinary atmospheric pressure, vacuum pump barometric pressure measured in millibars Mb, and fractional distillation all waste gases are processed to flu gas detoxification system.

The 12—Slurry non ionic and electrolyte reservoir expanded.

The 13—Slurry non ionic and electrolyte reservoir contracted.

The 14—Slurry non ionic and electrolyte reservoir brass or tool steel aperture and 15—Tool steel extrusion die cast design brass or tool steel fitting connects directly and conveys Slurry non ionic and electrolyte to the 17—Tool steel extrusion die cast design internal cavity. The 18—Tool steel extrusion die cast design internal cavity regulator carbonaceous-polyamide, polyamide and nanoparticle c 6 waste filtration and may liquids and gaseous and 18B—Tool steel vacuum release control and portal works in unison with the press plate drawing expanding and contracting Slurry non ionic and electrolyte removing waste from the 17—Tool steel extrusion die cast design internal cavity while it is being filled with Slurry non ionic and electrolyte from common recovery distillation heated interface tool steel and thermometer gauge, ordinary atmospheric pressure, vacuum pump barometric pressure measured in millibars Mb, and fractional distillation all waste gases are processed to flu gas detoxification system.

The 17—Tool steel extrusion die cast internal cavity is designed as a tool steel extrusion die cast mold for each highly pure naturally occurring carbon and allotropes of carbon filler and adhesive insulator part comprised of two master extrusion tool steel halves. This is accomplished by first utilizing engineering drafting and computer aided design with the most advanced tool steel part manufacture process and tool steel part machining techniques and/or by utilizing replacement ceramic molds specification number 36 to supplement the development of extrusion die cast master molding may L1 L2 processor design L1 L2 processor master fabrication design, construction engineering, box framing casting preform, and tool steel hydraulic preform modular high purity tool steel die cast extrusion molds.

Highly pure naturally occurring carbon, hybrid allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator vacuum control of nitrogen, hydrogen, chlorine, ether, amino acid, or element dispersion brake pads, electronic brushes and parts require two master extrusions tool steel mold halves for each specification part. Highly pure naturally occurring carbon, hybrid allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator parts precision casting molds requires a minimum two and a maximum of six master extrusion tool steel mold halves for each specification part. Highly pure naturally occurring carbon, hybrid allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator parts precision casting molds are utilized to manufacture highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator 1.0 to 2.5 phase extrusions and two to six master highly pure naturally occurring carbon, hybrid allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator mold halves per specification part. The manufacture process of 1.0 to 2.5 phase extrusions and die cast design for highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator requires two to six master extrusion tool steel halves for each two to six reciprocal highly pure naturally occurring carbon, hybrid allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator master precision casting molds parts allowing two A and B highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator to be combined. The 0.5 phase extrusion equals two die cast mold halves both equal to or less than one half 0.5 phase extrusion molten pour. The utility patent application specification concrete control room and monitoring station manufacturing in a complete vacuum area less than atmospheric gaseous and gases produced or added comprise the partial vacuum and may supply rich oxygen from capillary feeders at varying points to the specified highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator part molten fill A and B fills up to four pours. The highly pure naturally occurring carbon, hybrid allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator half shell or 0.5 phase extrusion are designed and utilized for state of the art manufacture process when combining highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator in combination of layered foundry fills, parts may be sprayed and dipped non conductive adhesives insulator films, and all waste gases are processed to flu gas detoxification system.

The highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator is a layered greater than 0% to less than 100% alloy component A and greater than 0% to less than 100% alloy component B part that is created in combination of layered foundry fills by utilizing two to six master highly pure naturally occurring carbon, hybrid allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator parts precision casting molds per specification part by pouring molten fill as a layered alloying component highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator four molten metal or other fill pours equal to 1.0 to 2.5 phase extrusions.
The highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator is a layered greater than 0% to less than 100% highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator A component part, and greater than 0% to less than 100% highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator B component part created in combination of layered fills of two to six master highly pure naturally occurring carbon, hybrid allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator extrusion die cast mold halves equal to 1.0 to 2.5 phase extrusions.

Super carbon alloy is defined as allotropes of carbon sintered and/or smeltered foundry manufacture process of combined highly pure metal, super alloy, and/or element. The pre and post pour technological standard is accomplished with the utility patent application specification concrete control room and monitoring station manufacturing in a complete vacuum area less than atmospheric gaseous and gases produced or added comprise the partial vacuum and may supply rich oxygen from capillary feeders at varying points and all waste gases are processed to flu gas detoxification system and includes nitrate, nitride, galvanize, anodize, and benzotriazole, methyl, tolyltriazole, sodium chemical pre and post foundry treatment submersion bath flake and prill anticorrosive purification solution washing and screening table for the manufacture of copper and metals. Hot smelters prepare iron, manganese, lithium, cadmium, lead, nickel, copper, zinc, zirconium, aluminum, titanium, molybdenum, tungsten, or metal for die cast pours and are also utilized for layered foundry fills die cast pours of highly pure metal, super alloy, carbon, ceramics, acid solid, alkaline, glass, acrylic, synthetic polymer, halide, alkalide, nonconductive zirconia, allotropes of carbon, beryllium Be4 inductor, magnesium Mg12 inductor, carbon C6 nanoparticle conductor, copper Cu29 conductor, alternate carbon nanofoam C6 inductor ACNFI and impedance matching load or signal ceramic red brick clay insulator. All mechanically refined metal ore may be sintered and/or smeltered element additive alloyed allotropes of carbon, tolyltriadole, sodium, benzotriadole, methyl, ammoniate, galvanize, anodize, nitrate, molybdenum, chromium, chromoloy, nitride, hydrochloric acid or combined alloyed sintered and/or smeltered highly pure metal, super alloy, alkaline, nonconductive zirconia, and impedance matching load or signal ceramic red brick clay insulator.

All metal ore may be sintered and/or smeltered for homogenization and specific melting point measured in degrees Celsius.

Finely screened grit size mechanically refined copper ore may be pre molten metal chemically treated manufacture process with tolyltriazole, sodium and benzotriazole, methyl, flake, and prill washing and screening table technique and chemical submersion bath for highly pure copper, brass, and bronze alloy anticorrosion purification process sequence.

Replacement ceramic cast 2.5 phase design extrusion die cast molding for super alloy.

The super alloy is a layered greater than 0% to less than 100% highly pure metal or super alloy and greater than 0% to less than 100% highly pure metal or super alloy part that is created by pouring molten metal into a cast mold over a process of 2.5 phase design extrusion that create four molded casts for each designed master steel part that is manually machined and manufactured named part X the external layer highly pure metal or super alloy and part Z the internal layer highly pure metal or super alloy. This replacement mold application is for the manufactured process of 2.5 phase design extrusion that creates a single part identical to the master designed and machined manufactured part. The new part chemical element becomes a super alloy that is layered greater than 0% to less than 100% highly pure metal, super alloy, carbon, ceramics, acid solid, alkaline, glass, acrylic, synthetic polymer, halide, alkalide, nonconductive zirconia, allotropes of carbon, beryllium Be4 inductor, magnesium Mg12 inductor, carbon C6 nanoparticle conductor, copper Cu29 conductor, alternate carbon nanofoam C6 inductor ACNFI and impedance matching load or signal ceramic red brick clay insulator and greater than 0% to less than 100% highly pure metal, super alloy, carbon, ceramics, acid solid, alkaline, glass, acrylic, synthetic polymer, halide, alkalide, nonconductive zirconia, allotropes of carbon, beryllium Be4 inductor, magnesium Mg12 inductor, carbon C6 nanoparticle conductor, copper Cu29 conductor, alternate carbon nanofoam C6 inductor ACNFI and impedance matching load or signal ceramic red brick clay insulator. The manufacture process begins by a designed and machined manufactured master part named part X. The master part X is used to create two external cast halves. This is accomplished by casting the master part X into the center of two ceramic molded halves with newly poured ceramic slip and then may be placed in a cool damp room and receive finish application with a wet sponge. After the ceramic cast dries the master part X is removed and the two ceramic molded halves are ignited and cured 3 hours in a kiln at 2000 degrees Fahrenheit or 12 hour interval day at 2000 degrees Fahrenheit.

The second master part named part Z is designed and machined manufactured greater than 0% to less than 100% less than tolerances that of the master part X or the external cast halves. The master part Z is used to create two internal cast halves. This is accomplished by casting the master part Z into the center of two ceramic molded halves with newly poured ceramic slip and then may be placed in a cool damp room and receive finish application with a wet sponge. After the ceramic cast dries the master part Z is removed and the two ceramic molded halves are ignited and cured 3 hours in a kiln at 2000 degrees Fahrenheit or 12 hour interval day at 2000 degrees Fahrenheit. After the two ceramic cast halves cool they are used separately to make two reciprocal extrusion halves by pouring ceramic slip into the recesses and joining both halves with new cast covers to dry.

The external tolerances of all of the four cast covers X and Z are identical opposing so that X and Z halves can be joined and prepared for two separate halves molten highly pure metal or super alloy fills. After the poured molten highly pure metal or super alloy cools both extruded halves are removed and stored. The remainder halves with highly pure metal or super alloy fills are then joined and prepared for a second molten fill of greater than 0% to less than 100% highly pure metal or super alloy.
After the highly pure metal or super alloy is cooled the whole part is removed from the cast halves and is inspected, deburred, and finished.

The 14—Slurry non ionic and electrolyte reservoir brass or tool steel aperture conveys Slurry non ionic or electrolyte mechanically refined and nanoparticle to the 17—Tool steel extrusion die cast design internal cavity. Slurry non ionic or electrolyte mechanically refined and nanoparticle samples are taken and photo spectrometry analyzed by optical absorption, Raman spectra, and scanning electron microscopy measured in nanometers Nm to enhance slurry formula.

The 16—Tool steel electronic servo processor or manual stop control release pull pin can be electronically disengaged or manually removed after the 10—Slurry non ionic and electrolyte tool steel reservoir is filled to begin the Slurry non ionic and electrolyte extrusion.

The 18—Tool steel extrusion die cast design internal cavity regulator carbonaceous-polyamide, polyamide and nanoparticle c 6 waste filtration and may liquids and gaseous removes waste from the 17—Tool steel extrusion die cast design internal cavity while it is being filled with Slurry non ionic and electrolyte. The 18—Tool steel extrusion die cast design internal cavity regulator carbonaceous-polyamide, polyamide and nanoparticle c 6 waste filtration and may liquids and gaseous and 18B-Tool steel vacuum release control with processing may utilize an external vacuum pump for required specifications specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 56 elements and/or Specification 57 alloys.

The manufacture process of preform slurry non ionic or electrolyte mechanically refined and nanoparticle high wear-heat resistant part is to cool it and/or dry it at room temperature in degrees Celsius or cure the part in a furnace typically for 5 to 20 minutes from 1076 degrees Fahrenheit to 3230 degrees Fahrenheit.

Preform slurry non ionic or electrolyte making of four sections 1. Preform slurry non ionic or electrolyte mechanically refined and nanoparticle high wear-heat resistant part 2. preform slurry non ionic or electrolyte mechanically refined and nanoparticle high wear-heat resistant parts electronic component composite coils beryllium Be4, magnesium Mg12, copper Cu29 and carbon nanofoam C6, spun wound windings beryllium Be4, magnesium Mg12, copper Cu29 and carbon nanofoam C6 annealing, drawn, spun, coils, windings, wire, woven textile mesh, shielding, brushes, inductors, antinode couplers, electric rheostats, starters, motors, alternators, generators, ionic suspension element enhanced composite coils, composite windings, spun wound coils beryllium Be4, magnesium Mg12, copper Cu29 and carbon nanofoam C6, spun wound windings beryllium Be4, magnesium Mg12, copper Cu29 and carbon nanofoam C6 annealing, drawn, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts 3. preform slurry non ionic or electrolyte mechanically refined and nanoparticle high wear-heat resistant parts aerospace, automotive, and transportation brake calipers, rotors, pads, washers, spacers, shims, dowels, and bushings 4. preform slurry non ionic or electrolyte mechanically refined and nanoparticle high wear-heat resistant parts precision casting molds for the manufacturing of highly pure metal, super alloy, highly pure naturally occurring carbon, ceramics, optical silica alumina or molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, acid solids, alkaline, glass, acrylic, synthetic polymers, halide, alkalide, antimonide, nonconductive zirconia, allotropes of carbon, beryllium Be4 inductor, magnesium Mg12 inductor, carbon C6 nanoparticle conductor, copper Cu29 conductor, alternate carbon nanofoam C6 inductor ACNFI and impedance matching load or signal ceramic red brick clay insulators 1.0 to 2.5 phase extrusions two to six master preform slurry non ionic or electrolyte mechanically refined and nanoparticle high wear-heat resistant parts precision casting molds. All 2.5 phase extrusions and half shell castings are processed utility patent application specification concrete control room and monitoring station manufacturing in a complete vacuum area less than atmospheric gaseous and gases produced or added comprise the partial vacuum and may supply rich oxygen from capillary feeders at varying points to molten elements in crucibles, and extrusion molds parts may be sprayed and dipped non conductive adhesives insulator films and all waste gases are processed to flu gas detoxification system.

Preform slurry non ionic or electrolyte mechanically refined and nanoparticle dispersion allotropes of carbon made by the variable hydraulic preform slurry non ionic or electrolyte mechanically refined and nanoparticle dispersion high wear-heat resistant parts press FIG. 1 numbers 1 to 18. Variable hydraulic preform slurry non ionic or electrolyte mechanically refined and nanoparticle dispersion high wear-heat resistant parts press with FIG. 1 numbers 1 to 18 specific components that conform to specified requirements to unique American Society for Testing and Materials International Standards Worldwide Identifiers. Variable hydraulic preform slurry non ionic or electrolyte mechanically refined and nanoparticle dispersion high wear-heat resistant parts press the center of the utility patent application specification slurry formula in three scientific forms of 6—Solids, 7—Liquids and 8—Gases Noble gaseous element Argon and other gaseous element specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 56 elements and/or Specification 57 alloys manufactured preform slurry non ionic or electrolyte mechanically refined and nanoparticle high wear-heat resistant parts.

Utility patent application specification concrete control room and monitoring station manufacturing in a complete vacuum area less than atmospheric gaseous and gases produced or added comprise the partial vacuum and may supply rich oxygen from capillary feeders at varying points to utility patent application specification for with die cast mold extrusion or printing hot smelters casting manufacturing of specified highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator including two to six master extrusion halves 1.0 to 2.5 phase extrusions per specification part molten foundry fill up to four pours and the manufacture process or assembly for each specification component or part thereof and all waste gases are processed to flu gas detoxification system.

Utility patent application specification concrete control room and monitoring station manufacturing in a complete vacuum area less than atmospheric gaseous and gases produced or added comprise the partial vacuum and may supply rich oxygen from capillary feeders at varying points to utility patent application specification manufacturing of highly pure metal, super alloy, carbon, ceramics, acid solid, alkaline, glass, acrylic, synthetic polymer, halide, alkalide, nonconductive zirconia, allotropes of carbon, beryllium Be4 inductor, magnesium Mg12 inductor, carbon C6 nanoparticle conductor, copper Cu29 conductor, alternate carbon nanofoam C6 inductor ACNFI and impedance matching load or signal ceramic red brick clay insulator hot pouring casting printing with molten foundry fill of die cast mold precision casting of bars, rods, plates, sheets, foil, leaf, alumina, copper, wire, annealing, drawing, and spun coils and windings for electronic component, highly pure metal, super alloy drawing, annealing, and spinning process for wire, spun cable, interwoven rebar mesh with or without interwoven textile mesh heated or supercooled particulate matter synthetic and polymer resins carbonaceous-polyamide unit of measurement in gage manufacture process connector system super alloy die cast tool steel molten-forged crimping tool that works with molten-forged mesh connectors. Other construction tools include powders nitrate hardened nitride steel grit unit of measurement in mesh or grit size. Differential pressurization molten melts extrusion or supercritical gaseous suspension particulate matter are drawn into heated chamber flash forming vapour melts molten diffusion specific material density, temperature and pressure controlled by scientific specification hydraulic automation central processing unit CPU server L1 L2 processor server hydroelectric scientific distillation hydraulic variable press plate extruding, forging, molding, casting, rod and plate casted released dropped rods drawn, annealing, spinning, rolled-wound wire, wound and wrapped coils, wound and wrapped windings, wound flat strips, woven and interwoven shielding and mesh are conductive liquid metal solder plated submersion or sprayed C 6 carbon nanoparticle, cesium, chromate, silver, gold, platinum, titanium, tungsten, niobium, manganese, steel, tin, beryllium, copper, aluminum, gallium, nickel, cadmium, zinc, potassium, magnesium, lithium, indium, salts, sulfosalts, sulfides, antimonide, halide, alkalide, acid complex, nitronium, anodize, galvanize, and benzotriazole, methyl, tolyltriazole, sodium under normal atmospheric pressure liquid metal alloy and/or carbon nanoparticle C 6 alloy drawn, rolled, wound, mechanical spinning. Particulate matter mechanical spinning unrolled and rolled synthetic and/or fiber insulate non conductive wire, strips and shielding are conductive liquid metal solder plated.

Utility patent application specification concrete control room and monitoring station manufacturing in a complete vacuum area less than atmospheric gaseous and gases produced or added comprise the partial vacuum and may supply rich oxygen from capillary feeders at varying points to utility patent application specification 1.0 to 2.5 phase extrusions manufacturing of highly pure metal or super alloy precision casting of airframe, bearings, and assemblies, motor casings, aircraft landing gear, turbine blades, assemblies, and housings parts may be sprayed and dipped non conductive adhesives insulator films and all waste gases are processed to flu gas detoxification system.

Utility patent application specification concrete control room and monitoring station manufacturing in a complete vacuum area less than atmospheric gaseous and gases produced or added comprise the partial vacuum and may supply rich oxygen from capillary feeders at varying points to highly pure metal copper pre and post foundry mechanically refined copper ore anticorrosive treatment chemical submersion bath sodium, tolyltriazole, and methyl, benziotriole flake and prill washing and screening tables and chemical submersion bath techniques are utilized and in manufacturing of highly pure other metals mechanically refined ore iron, molybdenum, aluminum, zinc, zirconium, titanium, tungsten, or metal pre and post foundry anticorrosive treatment chemical submersion bath hydrochloric acid, ammonia from nitrogen, and hydrogen anticorrosive purification treatment and all waste gases are processed to flu gas detoxification system.

Utility patent application specification concrete control room and monitoring station manufacturing in a complete vacuum area less than atmospheric gaseous and gases produced or added comprise the partial vacuum and may supply rich oxygen from capillary feeders at varying points to mechanically refined metal ore sintered and smeltered non metallic additive allotropes of carbon alloyed super alloy, steel super carbon steel, tungsten super carbon tungsten, or additive sintered and smeltered molybdenum for homogenization steel molybdenum steel, or tungsten molybdenum tungsten and all waste gases are processed to flu gas detoxification system.

Utility patent application specification manufacturing of highly pure metal, super alloy, carbon, ceramics, acid solid, alkaline, glass, acrylic, synthetic polymer, halide, alkalide, nonconductive zirconia, allotropes of carbon, beryllium Be4 inductor, magnesium Mg12 inductor, carbon C6 nanoparticle conductor, copper Cu29 conductor, alternate carbon nanofoam C6 inductor ACNFI and impedance matching load or signal ceramic red brick clay insulator 1.0 to 2.5 phase extrusions or half shell casted composite coils beryllium Be4, magnesium Mg12, copper Cu29 and carbon nanofoam C6, spun wound windings beryllium Be4, magnesium Mg12, copper Cu29 and carbon nanofoam C6 annealing, drawn, spun, coils, windings, wire, woven textile mesh, shielding, brushes, inductors, antinode couplers, electric rheostats, starters, motors, alternators, generators, ionic suspension element enhanced composite coils, composite windings, spun wound coils beryllium Be4, magnesium Mg12, copper Cu29 and carbon nanofoam C6, spun wound windings beryllium Be4, magnesium Mg12, copper Cu29 and carbon nanofoam C6 annealing, drawn, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts highly pure metal, super alloy, acid solid, alkaline, glass, acrylic, synthetic polymer, halide, alkalide, nonconductive zirconia, impedance matching load or signal ceramic red brick clay insulator, allotropes of carbon, or beryllium Be4 inductor, magnesium Mg12 inductor, carbon C6 nanoparticle conductor, copper Cu29 conductor and alternate carbon nanofoam C6 inductor ACNFI six sides rectangle, or square, or three sides continuous rod or cylinder highly pure metal, super alloy, acid solid, alkaline, glass, acrylic, synthetic polymer, halide, alkalide, nonconductive zirconia, impedance matching load or signal ceramic red brick clay insulator, allotropes of carbon, or beryllium Be4 inductor, magnesium Mg12 inductor, carbon C6 nanoparticle conductor, copper Cu29 conductor and alternate carbon nanofoam C6 inductor ACNFI, or three sides zircon, nitrate zircon, and nitrate silica with or without molecular reinforcements nanoparticle alumina and allotropes of carbon cutting tools, or two sides continuous for drill bits half shell casted tools measured in gage.

Utility patent application specification manufacturing of highly pure metal or super alloy die cast tool steel molten-forged crimping tool for rebar mesh manufacture process connector system, specific super alloy and tool steel parts that conform to specified requirements to unique American Society for Testing and Materials International Standards Worldwide Identifiers variable hydraulic preform slurry non ionic or electrolyte mechanically refined and nanoparticle dispersion high wear-heat resistant parts press FIG. 1 numbers 1 to 18 and tool steel tungsten die cast extrusion molds for with manufacturing highly pure metal, super alloy, acid solid, alkaline, glass, acrylic, synthetic polymer, halide, alkalide, nonconductive zirconia, impedance matching load or signal ceramic red brick clay insulator, allotropes of carbon, or beryllium Be4 inductor, magnesium Mg12 inductor, carbon C6 nanoparticle conductor, copper Cu29 conductor and alternate carbon nanofoam C6 inductor ACNFI.

Utility patent application specification manufacture process of replacement ceramic precision casting molds specification number 36 for with manufacturing highly pure metal, super alloy, acid solid, alkaline, glass, acrylic, synthetic polymer, halide, alkalide, nonconductive zirconia, impedance matching load or signal ceramic red brick clay insulator, allotropes of carbon, or beryllium Be4 inductor, magnesium Mg12 inductor, carbon C6 nanoparticle conductor, copper Cu29 conductor and alternate carbon nanofoam C6 inductor ACNFI.

Utility patent application specification manufacture process of preform slurry non ionic or electrolyte mechanically refined and nanoparticle dispersion allotropes of carbon with or without ionic suspension element Specification 56 elements or Specification 57 alloys extrusion or casted highly pure metal, super alloy, allotropes of carbon with or without ionic suspension element Specification 56 elements, Specification 57 alloys, and alkaline, halide, antimonide, or alkalide, nonconductive zirconia, and impedance matching load or signal ceramic red brick clay insulator casted electronic part equivalent to one composite coil, composite winding, battery cell, capacitor, and brush one, or more gradated in even intervals of electric rheostat, battery, starter, motor, alternator, generator, transformer, transducer, rectifier, power supply, junction box, or heat sink series and parallel circuits two positive and negative terminal poles commonly copper alloy measured in Volts, or of preform slurry non ionic or electrolyte beryllium Be4 inductor, magnesium Mg12 inductor, carbon C6 nanoparticle conductor, copper Cu29 conductor and alternate carbon nanofoam C6 inductor ACNFI extrusion, or casted highly pure metal, super alloy, beryllium Be4 inductor, magnesium Mg12 inductor, carbon C6 nanoparticle conductor, copper Cu29 conductor and alternate carbon nanofoam C6 inductor ACNFI, nonconductive zirconia, and impedance matching load or signal ceramic red brick clay insulator electronic part equivalent to one resistor, sensor, switch, relay, or electronic part inductor, antinode coupler, and ground series and parallel circuits two negative terminal poles commonly copper alloy measure in Ohms of inductor, antinode coupler, and ground or two positive and negative terminal poles commonly copper alloy measured in Volts. All electronic parts two sides casted conductive plate, sheet, foil, or leaf highly pure metal, super alloy, halide, antimonide, or alkalide rectangle, square, continuous rod or cylinder. Rectangle or square six sides, five sides nonconductive zirconia, impedance matching load or signal ceramic red brick clay insulator, allotropes of carbon, or beryllium Be4 inductor, magnesium Mg12 inductor, carbon C6 nanoparticle conductor, copper Cu29 conductor and alternate carbon nanofoam C6 inductor ACNFI, plate, sheet, foil, or leaf casted insulated, and one side layered or non layered conductive highly pure metal, super alloy, and/or alkaline, halide, antimonide, or alkalide, plate, sheet, foil, or leaf casted conductive, or four sides nonconductive zirconia, impedance matching load or signal ceramic red brick clay insulator, allotropes of carbon, or beryllium Be4 inductor, magnesium Mg12 inductor, carbon C6 nanoparticle conductor, copper Cu29 conductor and alternate carbon nanofoam C6 inductor ACNFI casted plate, sheet, foil, or leaf insulated, and two conductive highly pure metal, super alloy, and/or alkaline, halide, antimonide, or alkalide, plate, sheet, foil, or leaf casted series and parallel circuits and two positive and negative terminal poles commonly copper alloy measured in Volts or two negative terminal poles commonly copper alloy measured in Ohms to antinode coupler, or continuous rod or cylinder three sides, one continuous side nonconductive zirconia, impedance matching load or signal ceramic red brick clay insulator, allotropes of carbon, or beryllium Be4 inductor, magnesium Mg12 inductor, carbon C6 nanoparticle conductor, copper Cu29 conductor and alternate carbon nanofoam C6 inductor ACNFI, plate, sheet, foil, or leaf casted insulated, and two sides conductive highly pure metal, super alloy, and/or alkaline, halide, antimonide, or alkalide, plate, sheet, foil, or leaf casted series and parallel circuits and two positive and negative terminal poles commonly copper alloy measured in Volts or two negative terminal poles commonly copper alloy measured in Ohms to antinode coupler preform slurry non ionic or electrolyte casted ionic suspension element allotropes of carbon battery cell outstanding one or two sides plate, sheet, foil, or leaf casted conductive highly pure metal, super alloy, halide, antimonide, or alkalide series and parallel circuits and two positive and negative terminal poles commonly copper alloy measured in Volts or two negative terminal poles commonly copper alloy measured in Ohms to antinode coupler or electronic parts requires one, or two, or more brushes in even intervals and two or more inductors and antinode couplers with one or two sides conductive plate, sheet, foil, or leaf casted highly pure metal, super alloy, halide, antimonide, or alkalide series and parallel circuits and two positive and negative terminal poles commonly copper alloy measured in Volts or two negative terminal poles commonly copper alloy measured in Ohms to antinode coupler.

Battery crucible casted or 1.0 to 2.5 phase extrusions highly pure metal or super alloy battery cells layered, spaced and casted conductive in series and parallel circuits even or odd interval number combinations varying complex, battery cells highly pure acid solid chemical and/or highly pure chemical alkali solid complex, crucible casted conductive or 1.0 to 2.5 phase extrusions highly pure metal or super alloy layered and interval spaced conductive in series and parallel circuits. Distillation reservoir specification manufactured all conservation of energy law insulated lightweight battery cold cell with or without Group 17 the halogens, antimony Sb, Polysaccharide And ionic suspension electrolyte Phosphate Sodium carbon C 6 P 3 S 3 Na 3 particulate matter including Salts, Sulfosalts and Sulfides condensation metal, Hexafluorophosphate carbon C 6 PF 6 particulate matter condensation metal, Nitronium carbon C 6 NC 4 particulate matter condensation metal, Hydrogen chloride carbon C 6HCl particulate matter condensation metal, Phosphorus chlorides carbon C 6 PCl3, POCl3 and PCl5 particulate matter condensation metal, Phosphorus pentachloride carbon C 6 P4O10 particulate matter condensation metal, Nitronium chloride carbon C 6 PCl 3 2 NO2Cl particulate matter condensation metal, Chloride carbon C 6 Cl 4 particulate matter condensation metal, Hydrocarbon C 6 HC 4 particulate matter condensation metal, Methane carbon C 6 CH 4 particulate matter condensation metal, Ammonia carbon C 6 NH 3 particulate matter condensation metal, Sulfuric acid carbon C 6 H2SO 4 particulate matter condensation metal and/or ceramic alkali and clay And Sodium potassium carbon C 6 Na K particulate matter condensation metal with or without ionic suspension element allotropes of carbon, beryllium Be4 inductor, magnesium Mg12 inductor, carbon C6 nanoparticle conductor, copper Cu29 conductor and alternate carbon nanofoam C6 inductor ACNFI, nanoparticle alumina, alumina, and ionic suspension element Specification 56 highly pure metals or ionic suspension element Specification 57 super alloys. Battery crucible casted conductive or 1.0 to 2.5 phase extrusions highly pure metal or super alloy layered, and interval spaced series and parallel circuits and/or complex, continuous sheets cut films insulate, crucible casted conductive or 1.0 to 2.5 phase extrusions variable hydraulic preform slurry non ionic silicate alumina allotropes of carbon dispersion high wear-heat compression resistant light weight battery cells. Highly pure alkali silica, alumina, nanoparticle alumina, or elements lithium, cadmium, nickel, lead, copper, Specification 56 elements or Specification 57 alloys. One by one each battery cell crucible casted non conductive or submersion bath synthetic polymer sealed control room vacuum protocol manufacture process. Motor frame protected by synthetic woven textile fiber, silica fiber high heat-resistant insulator shielding, continuous sheets cut films insulate, preform slurry non ionic silicate allotropes of carbon dispersion high wear-heat compression resistant light weight insulator, and/or or high tensile strength super alloy woven textile shielding. One by one each battery cell crucible casted or submersion bath synthetic polymer sealed control room vacuum protocol manufacture process. All four conductive or non conductive heat-wear high tensile strength and compression resistant insulators made in light makeweight monocombe design series 2 π radians or one full turn and right angles corrugated compartmented techniques composite combinations thermoplastic sealed, layered or woven shielded.

Motor crucible casted or 1.0 to 2.5 phase extrusions highly pure metal or super alloy composite coils beryllium Be4, magnesium Mg12, copper Cu29 and carbon nanofoam C6, spun wound windings beryllium Be4, magnesium Mg12, copper Cu29 and carbon nanofoam C6, and alumina, copper, wire annealing, drawing, and spun coils, highly pure metal, super alloy drawing and annealing process for wire. Motor composite coils beryllium Be4, magnesium Mg12, copper Cu29 and carbon nanofoam C6, spun wound windings beryllium Be4, magnesium Mg12, copper Cu29 and carbon nanofoam C6 commonly copper or super alloy include continuous or numeric interval mechanical advantage spools series and parallel conversion order shapes of rod, cylinder, sphere, rectangle, or square crucible casted or 1.0 to 2.5 phase extrusions. Motor electronic components brushes allotropes of carbon with or without ionic suspension elements each brush alternate carbon nanofoam inductors, and antinode coupler continuous or numeric alternating current AC electronic load supply ramps positive and negative terminal measured in Volts and monitors positive and negative terminal measured in Volts and negative and negative terminal poles commonly copper alloy measure in Ohms of inductor, antinode coupler, and ground series and parallel circuits. Spun numeric wrapped super alloy copper wire are synthetic polymer dipped or protected synthetic woven fibers, silica woven fibers, or high tensile strength super alloy allotropes of carbon shielding. Motor frame protected by synthetic woven textile fiber, silica fiber high heat-resistant insulator shielding, continuous sheets cut films insulate, preform slurry non ionic silicate allotropes of carbon dispersion high wear-heat compression resistant light weight insulator, and/or or high tensile strength super alloy woven textile shielding. One by one all composite or wire motor coils and windings are crucible casted or submersion bath synthetic polymer sealed control room vacuum protocol manufacture process. Three heat-wear high tensile strength, continuous sheets cut films insulate and variable hydraulic preform slurry non ionic allotropes of carbon dispersion high wear-heat compression resistant light weight insulators made Series of right angles 2π radians or one full turn the sum of the exterior angles form convex regular polygons corrugated and compartmented light makeweight fabrication monocombe shapes of triangle, square, pentagon, hexagon, heptagon, octagon, nonagon, polynumber and planess and right angle combinations light makeweight design. Crucible casted or 1.0 to 2.5 phase extrusions motor rods, bearings, casings, housings, and assemblies are manufactured and assembled.

One and two or more star systems order of the universe or well-lit source radiate light onto parallel 1-optical glass lens and 2-lightweight universal spectra camera and monitor panel shell numeric horizontal and vertical sectors receiving light of added and subtracted magnification and telescopic lenses travelling to scientific mirrors reflecting light onto ˜1.25-inch analogous scanning photo chemical electron molecule film and 2-numeric horizontal and vertical sectors ˜10 inch lightweight universal spectra camera and monitor linearized panel shell integrated or polarized alignment numeric optical lenses, glass beads, and polymer gels form scientific optical light reception and identification receiving emissions of light added and subtracted magnification and telescopic lenses transposed onto analogous scanning photo chemical electron molecule enriched conductive allotropes of carbon, alumina nanoparticles, copper nanoparticles, colloidal gold, silver nanoparticles, iron nanoparticles, molecular tool steel, molecular super alloy, element nanoparticles, platinum nanoparticles series and parallel circuit film element and complex element acid, base, alkyl, ionic and non ionic film enriched conductive acid, base, alkyl, ionic and non ionic, element and enriched complex element Liquids of condensation paste, gel or vapour suspended cells occupying vertical and horizontal segments equal to photo graphic picture resolution. Numeric molecular photovoltaic reception cell and circuit chlorophyll A ionic or anionic electron valences particle parts 1+part and/or 1−part highly pure electron molecule enrichment, chlorophyll B ionic or anionic electron valences particle parts 1+part and/or 1−part highly pure electron molecule enrichment, chlorophyll A complex ionic or anionic electron valences particle parts 1+part and/or 1−part highly pure electron molecule enrichment and chlorophyll B complex ionic or anionic electron valences particle parts 1+part and/or 1−part highly pure electron molecule enrichment. Chlorophyll positive or negative parts are specification element paste, gel, liquid, vapour or gaseous suspended in comparative series and/or parallel circuit cell receptors centers and/or delineations fabricated in polynumber and planes, trifocal, trigonal and linear 1-molar, 2-planar, 3-declination, 4-inclination, 5-convex, and 6-All-star system transform-noise molecular geometry. Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts eV electron volt=volt×elementary charge or electron volts eV, Joules J, and Coulombs C volts of data stream generation series and/or parallel circuit memory alloy identification key tone in resonant wavelength frequency atomic orbital as a mathematical function order of spheroid-centric cell parts receptors centers and/or delineations fabricated in polynumber and planes, trifocal, trigonal and linear 1-molar, 2-planar, 3-declination, 4-inclination, 5-convex, and 6-All-star system transform-noise molecular geometry of one to three electrons in an atom involving d, s and/or p orbitals polynumber and planes, linear-σ and/or π 3.1415926535897932384626433832795 bonds series and/or parallel circuit and terminals greater than > or less than <Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal and/or Vertical−Horizontal from Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts eV electron volt=volt×elementary charge or electron volts eV, Joules J, and Coulombs C volts of data stream generation series and/or parallel circuit memory alloy identification key tone in resonant wavelength frequency atomic orbital as a mathematical data streamidentification key tone in resonant wavelength frequency order of spheroid-centric cell and photovoltaic film series and/or parallel circuit data stream reception and signal wavelength frequency emission. Numeric molecular photovoltaic reception cell and circuit chlorophyll A ionic or anionic charged electron valences particle parts 1+part and/or 1−part highly pure electron molecule enrichment, chlorophyll B ionic or anionic charged electron valences particle parts 1+part and/or 1−part highly pure electron molecule enrichment, chlorophyll A complex ionic or anionic charged electron valences particle parts 1+part and/or 1−part highly pure electron molecule enrichment and chlorophyll B complex ionic or anionic charged electron valences particle parts 1+part and/or 1−part highly pure electron molecule enrichment. Chlorophyll positive or negative parts are specification element paste, gel, liquid, vapour or gaseous suspended in comparative series and/or parallel circuit cell receptors centers and/or delineations fabricated in polynumber and planes, trifocal, trigonal and linear 1-molar, 2-planar, 3-declination, 4-inclination, 5-convex, and 6-All-star system transform-noise molecular geometry. Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts eV electron volt=volt×elementary charge or electron volts eV, Joules J, and Coulombs C volts of data stream generation series and/or parallel circuit memory alloy identification key tone in resonant wavelength frequency atomic orbital as a mathematical data stream generation series and/or parallel circuit memory alloy identification key tone in resonant wavelength frequency atomic orbital as a mathematical function order of spheroid-centric cell parts receptors centers and/or delineations fabricated in polynumber and planes, trifocal, trigonal and linear 1-molar, 2-planar, 3-declination, 4-inclination, 5-convex, and 6-All-star system transform-noise molecular geometry of one to three electrons in an atom involving d, s and/or p orbitals polynumber and planes, linear σ and/or π 3.1415926535897932384626433832795 bonds series and/or parallel circuit and terminals greater than > or less than <Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal and/or Vertical−Horizontal from Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy data streamidentification key tone in resonant wavelength frequency order of spheroid-centric cell and photovoltaic film series and/or parallel circuit data stream reception and signal wavelength frequency emission. Numeric molecular photovoltaic reception cell and circuit acid A ionic or anionic electron valences particle parts 1+part and/or 1−part highly pure electron molecule enrichment, acid B ionic or anionic electron valences particle parts 1+part and/or 1−part highly pure electron molecule enrichment, acid A complex ionic or anionic electron valences particle parts 1+part and/or 1−part highly pure electron molecule enrichment and acid B complex ionic or anionic electron valences particle parts 1+part and/or 1-part highly pure electron molecule enrichment. Acid positive or negative parts are specification element paste, gel, liquid, vapour or gaseous suspended in comparative series and/or parallel circuit cell receptors centers and/or delineations fabricated in polynumber and planes, trifocal, trigonal and linear 1-molar, 2-planar, 3-declination, 4-inclination, 5-convex, and 6-All-star system transform-noise molecular geometry. Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy identification key tone in resonant wavelength frequency atomic orbital as a mathematical function order of spheroid-centric cell parts receptors centers and/or delineations fabricated in polynumber and planes, trifocal, trigonal and linear 1-molar, 2-planar, 3-declination, 4-inclination, 5-convex, and 6-All-star system transform-noise molecular geometry of one to three electrons in an atom involving d, s and/or p orbitals polynumber and planes, linear σ and/or π 3.1415926535897932384626433832795 bonds series and/or parallel circuit and terminals greater than > or less than <Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal and/or Vertical−Horizontal from Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy data stream identification key tone in resonant wavelength frequency order of spheroid-centric cell and photovoltaic film series and/or parallel circuit data stream reception and signal wavelength frequency emission. Numeric molecular photovoltaic reception cell and circuit base A ionic or anionic electron valences particle parts 1+part and/or 1−part highly pure electron molecule enrichment, base B ionic or anionic electron valences particle parts 1+part and/or 1−part highly pure electron molecule enrichment, base A complex ionic or anionic electron valences particle parts 1+part and/or 1−part highly pure electron molecule enrichment and base B complex ionic or anionic electron valences particle parts 1+part and/or 1−part highly pure electron molecule enrichment. Base positive or negative parts are specification element paste, gel, liquid, vapour or gaseous suspended in comparative series and/or parallel circuit cell receptors centers and/or delineations fabricated in polynumber and planes, trifocal, trigonal and linear 1-molar, 2-planar, 3-declination, 4-inclination, 5-convex, and 6-All-star system transform-noise molecular geometry. Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy identification key tone in resonant wavelength frequency atomic orbital as a mathematical function order of spheroid-centric cell parts receptors centers and/or delineations fabricated in polynumber and planes, trifocal, trigonal and linear 1-molar, 2-planar, 3-declintion, 4-inclination, 5-convex, and 6-All-star system transform-noise molecular geometry of one to three electrons in an atom involving d, s and/or p orbitals polynumber and planes, linear σ and/or π 3.1415926535897932384626433832795 bonds series and/or parallel circuit and terminals greater than > or less than <Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal and/or Vertical−Horizontal from Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy data stream identification key tone in resonant wavelength frequency order of spheroid-centric cell and photovoltaic film series and/or parallel circuit data stream reception and signal wavelength frequency emission. Numeric molecular photovoltaic reception cell and circuit element A ionic or anionic electron valences particle parts 1+part and/or 1−part highly pure electron molecule enrichment, element B ionic or anionic electron valences particle parts 1+part and/or 1−part highly pure electron molecule enrichment, element A complex ionic or anionic electron valences particle parts 1+part and/or 1−part highly pure electron molecule enrichment and element B complex ionic or anionic electron valences particle parts 1+part and/or 1−part highly pure electron molecule enrichment. Element positive or negative parts are specification element paste, gel, liquid, vapour or gaseous suspended in comparative series and/or parallel circuit cell receptors centers and/or delineations fabricated in polynumber and planes, trifocal, trigonal and linear 1-molar, 2-planar, 3-declination, 4-inclination, 5-convex, and 6-All-star system transform-noise molecular geometry. Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy identification key tone in resonant wavelength frequency atomic orbital as a mathematical function order of spheroid-centric cell parts receptors centers and/or delineations fabricated in polynumber and planes, trifocal, trigonal and linear 1-molar, 2-planar, 3-declination, 4-inclination, 5-convex, and 6-All-star system transform-noise molecular geometry of one to three electrons in an atom involving d, s and/or p orbitals polynumber and planes, linear σ and/or π 3.1415926535897932384626433832795 bonds series and/or parallel circuit and terminals greater than > or less than <Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal and/or Vertical−Horizontal from Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy data stream identification key tone in resonant wavelength frequency order of spheroid-centric cell and photovoltaic film series and/or parallel circuit data stream reception and signal wavelength frequency emission. Numeric molecular photovoltaic reception cell and circuit element A ionic or anionic electron valences particle parts 1+part and/or 1−part highly pure electron molecule enrichment, element B ionic or anionic electron valences particle parts 1+part and/or 1−part highly pure electron molecule enrichment, element A complex ionic or anionic electron valences particle parts 1+part and/or 1−part highly pure electron molecule enrichment and element B complex ionic or anionic electron valences particle parts 1+part and/or 1−part highly pure electron molecule enrichment. Element positive or negative parts are specification element paste, gel, liquid, vapour or gaseous suspended in comparative series and/or parallel circuit cell receptors centers and/or delineations fabricated in polynumber and planes, trifocal, trigonal and linear 1-molar, 2-planar, 3-declination, 4-inclination, 5-convex, and 6-All-star system transform-noise molecular geometry. Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy identification key tone in resonant wavelength frequency atomic orbital as a mathematical function order of spheroid-centric cell parts receptors centers and/or delineations fabricated in polynumber and planes, trifocal, trigonal and linear 1-molar, 2-planar, 3-declination, 4-inclination, 5-convex, and 6-All-star system transform-noise molecular geometry of one to three electrons in an atom involving d, s and/or p orbitals polynumber and planes, linear σ and/or π 3.1415926535897932384626433832795 bonds series and/or parallel circuit and terminals greater than > or less than <Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal and/or Vertical−Horizontal from Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy data stream identification key tone in resonant wavelength frequency order of spheroid-centric cell and photovoltaic film series and/or parallel circuit data stream reception and signal wavelength frequency emission. Two sided panel shell thermoelectrically sealed vertical and horizontal sectors in series and parallel circuits highly pure metal alumina atomic symbol Al number 13 annealing, drawing, and spun rolled-wound fine wire or press rolled flat strips fine wire and shielding analogous scanning photo chemical electron molecule enriched conductive emissions data stream allotropes of carbon, alumina nanoparticles, copper nanoparticles, colloidal gold, silver nanoparticles, iron nanoparticles, molecular tool steel, molecular super alloy, element nanoparticles, platinum nanoparticles series circuit waveform generation symbol light of CMY cyan, magenta, yellow, RGB red, green, blue, and analogous scanning photo chemical electron molecule enriched conductive emissions data stream allotropes of carbon, alumina nanoparticles, copper nanoparticles, colloidal gold, silver nanoparticles, iron nanoparticles, molecular tool steel, molecular super alloy, element nanoparticles, platinum nanoparticles series circuit waveform generation symbol light of beryllium Be4 inductor, magnesium Mg12 inductor, carbon C6 nanoparticle conductor, copper Cu29 conductor and alternate carbon nanofoam C6 inductor ACNFI atomic number 6 symbol C pure light, filtered light, colored light and reflective light wavelength frequency received in nanoseconds processing by Central processing unit CPU photovoltaic electron molecule wavelength shift generator frequency counter and frequency analyzer order of Central processing unit CPU photovoltaic electron molecule wavelength shift generator added and subtracted changes order of wavenumber data stream output nanoseconds processor spectra wavelength frequency pure light, filtered light, colored light, and reflective light data stream generation random access memory RAM and Electronic Storage Medium writable random access memory WRAM compact disc. The universal spectra camera and monitor glass bead molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered optical cables light emissions data stream wavelength frequency photogray, photocolor and photochemical element optical lens light filtered light wavelength generation identification and photo active chemical electron molecule element scanning analogous series and parallel alumina atomic symbol Al and number 13 wire and shielding+/−wavelength shift generator data stream generation random access memory RAM and Electronic Storage Medium writable random access memory WRAM compact disc data streams series viewing of the universal spectra camera and monitor panel shell thermoelectrically sealed sectors numeric 1-highly pure mineral or complex element electrolyte Liquid, gel or vapour crystal mineralization acid, base or alkyl light emitting diode LED and 2-symbol generator light optical reflective beads reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead, Liquid, gel or vapour crystal mineralization acid, base or alkyl light emitting diode LED reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead, and Liquid crystal mineralization light emitting diode LED reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead alumina Al13 strips occupying vertical and horizontal segments of photo graphic picture resolution light emitting diode LED cells in CMY cyan, magenta, yellow, RGB red, green, blue, filtered light and specification colors series and parallel highly pure metal alumina atomic symbol Al number 13 annealing, drawing, and spun rolled-wound fine wire or press rolled flat strips fine wire and shielding equal to vertical and horizontal picture resolution. Chlorophyll A ionic or anionic 2-parts 1+positive and 1−negative enriched chemical electron molecules and B ionic or anionic 2-parts 1+positive and 1−negative enriched chemical electron molecules photo active chemical electron molecule element film cells in series and parallel circuits Chlorophyll A ionic or anionic 2-parts 1+positive and 1−negative enriched chemical electron molecules and B ionic or anionic 2-parts 1+positive and 1−negative enriched chemical electron molecules photo active chemical electron molecule element film cells emissions data stream in wavelength frequency counter and analyzer order of photo emissions data stream photogray, photocolor and photochemical element optical lens light filtered light wavelength generation identification scanning analogous photo active chemical electron molecule element film cells circuits data stream output+/−wavelength shift generator. The CMY cyan, magenta, yellow, RGB red, green, blue, and beryllium Be4 inductor, magnesium Mg12 inductor, carbon C6 nanoparticle conductor, copper Cu29 conductor and alternate carbon nanofoam C6 inductor ACNFI atomic number 6 symbol C pure light, filtered light, colored light and reflective light wavelength frequency received in nanoseconds processing by Central processing unit CPU photovoltaic electron molecule wavelength shift generator frequency counter and frequency analyzer order of Central processing unit CPU photovoltaic electron molecule wavelength shift generator added and subtracted changes of the order of wavenumber data stream output nanoseconds processor spectra wavelength frequency pure light, filtered light, colored light, and reflective light data streams series viewing sectors numeric 1-highly pure mineral or complex element electrolyte Liquid, gel or vapour crystal mineralization acid, base or alkyl light emitting diode LED and 2-symbol generator light optical reflective beads reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead, Liquid, gel or vapour crystal mineralization acid, base or alkyl light emitting diode LED reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead, and Liquid crystal mineralization light emitting diode LED reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead alumina Al13 strips occupying vertical and horizontal segments of photo graphic picture resolution light emitting diode LED cells in CMY cyan, magenta, yellow, RGB red, green, blue, filtered light and specification colors series and parallel highly pure metal alumina atomic symbol Al number 13 annealing, drawing, and spun rolled-wound fine wire or press rolled flat strips fine wire and shielding equal to the vertical and horizontal picture resolution. Two sided panel shell consists numeric sums of reflected delineations occupying vertical and horizontal segments equal to photo graphic picture resolution of integrated or polarized greater than higher temperatures of ˜1700° C. and 2200° C. crystalline silica optical reflective glass beads spectra light filtered and non filtered specifications, lower and greater than lower temperatures of ˜178° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications. Similarly greater than higher temperatures of ˜1700° C. and 2200° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications, lower and greater than lower temperatures of ˜178° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyimide, filtered and non filtered specifications. Liquid dispersion supersaturated liquids of condensation-nuclei matters one, two or more composites 0° C. or 32° F. of optical beads and optical cable line manufacturing are light makeweight heated or chilled chemical ionic acid usually an amino acid, non ionic bases usually nitrogen/hydrogen or non ionic groups of amphoteric polysaccharide linear or branched alkyl compounds usually methyl liquid dispersion optical grade Silica spectra light filtered and non filtered specifications, optical grade polyamide silica spectra light filtered and non filtered specifications, continuous forged liquid dispersion optical grade silica line cable spectra light filtered and non filtered specifications, continuous forged liquid dispersion optical grade polyamide silica line cable spectra light filtered and non filtered specifications equivalent condensation-nuclei type size particles measure in microns Symbol μ lower-case letter mu metric SI. Integrated or polarized alignment circuit optical reflective beads emissions of light spectra wavelength frequency onto optical reflective cables process in nanoseconds spectra wavelength frequency to central processing unit CPU wavelength shift and light symbol generator frequency counter and frequency analyzer order of wavelength frequency added and subtracted changes order of wavenumber data stream output in nanoseconds processing spectra wavelength frequency and light symbol generation pure light, filtered light, colored light, and reflective light and data stream generation random accessible memory RAM and Electronic Storage Medium writable random accessible memory WRAM compact disc. Two sided panel shell consists numeric sums of reflected centers occupying vertical and horizontal segments equal to photo graphic picture resolution of integrated or polarized greater than higher temperatures of ˜1700° C. and 2200° C. crystalline silica optical reflective glass beads spectra light filtered and non filtered specifications, lower and greater than lower temperatures of ˜178° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications. Similarly greater than higher temperatures of ˜1700° C. and 2200° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications, lower and greater than lower temperatures of ˜178° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications. Liquid dispersion supersaturated liquids of condensation-nuclei matters one, two or more composites 0° C. or 32° F. of optical beads and optical cable line manufacturing are light makeweight heated or chilled chemical ionic acid usually an amino acid, non ionic bases usually nitrogen/hydrogen or non ionic groups of amphoteric polysaccharide linear or branched alkyl compounds usually methyl liquid dispersion optical grade Silica spectra light filtered and non filtered specifications, optical grade polyamide silica spectra light filtered and non filtered specifications, continuous forged liquid dispersion optical grade silica line cable spectra light filtered and non filtered specifications, continuous forged liquid dispersion optical grade polyamide silica line cable spectra light filtered and non filtered specifications equivalent condensation-nuclei type size particles measure in microns Symbol μ lower-case letter mu metric SI. Integrated or polarized alignment circuit optical reflective beads emissions of light spectra wavelength frequency onto optical reflective cables process in nanoseconds spectra wavelength frequency to central processing unit CPU wavelength shift and light symbol generator frequency counter and frequency analyzer order of wavelength frequency added and subtracted changes order of wavenumber data stream output in nanoseconds processing spectra wavelength frequency and light symbol generation pure light, filtered light, colored light, and reflective light and data stream generation random accessible memory RAM and Electronic Storage Medium writable random accessible memory WRAM compact disc. Two sided panel shell consists numeric sums of reflective centers of integrated or polarized greater than higher temperatures of ˜1700° C. and 2200° C. crystalline silica optical reflective glass beads spectra light filtered and non filtered specifications, lower and greater than lower temperatures of ˜178° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications. Similarly greater than higher temperatures of ˜1700° C. and 2200° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications, lower and greater than lower temperatures of ˜178° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications. Liquid dispersion supersaturated liquids of condensation-nuclei matters one, two or more composites 0° C. or 32° F. of optical beads and optical cable line manufacturing are light makeweight heated or chilled chemical ionic acid usually an amino acid, non ionic bases usually nitrogen/hydrogen or non ionic groups of amphoteric polysaccharide linear or branched alkyl compounds usually methyl liquid dispersion optical grade Silica spectra light filtered and non filtered specifications, optical grade polyamide silica spectra light filtered and non filtered specifications, continuous forged liquid dispersion optical grade silica line cable spectra light filtered and non filtered specifications, continuous forged liquid dispersion optical grade polyamide silica line cable spectra light filtered and non filtered specifications equivalent condensation-nuclei type size particles measure in microns Symbol μ lower-case letter mu metric SI. Integrated or polarized alignment circuit optical reflective cables emissions of light spectra wavelength frequency symbol generator light onto optical reflective beads processed in nanoseconds spectra wavelength frequency from central processing unit CPU wavelength shift and light symbol generator frequency counter and frequency analyzer order of wavelength frequency added and subtracted changes order of wavenumber data stream output in nanoseconds processing spectra wavelength frequency and light symbol generation pure light, filtered light, colored light, and reflective light emissions data stream. The KIOSK universal spectra camera and monitor panel shell thermoelectrically sealed vertical and horizontal sectors numeric 1-highly pure mineral or complex element electrolyte Liquid, gel or vapour crystal mineralization acid, base or alkyl light emitting diode LED and 2-symbol generator light optical reflective beads reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead, Liquid, gel or vapour crystal mineralization acid, base or alkyl light emitting diode LED reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead, and Liquid crystal mineralization light emitting diode LED reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead alumina Al13 strips occupying vertical and horizontal segments of photo graphic picture resolution light emitting diode LED cells in CMY cyan, magenta, yellow, RGB red, green, blue, filtered light and specification colors integrated or polarized alignment optical high purity panel, molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels gels finished touch screen kiosk in series circuits highly pure metal alumina atomic symbol Al number 13 annealing, drawing, and spun rolled-wound fine wire or press rolled flat strips fine wire and shielding receiving negative electron molecules wavelength frequency beryllium Be4 inductor, magnesium Mg12 inductor, carbon C6 nanoparticle conductor, copper Cu29 conductor and alternate carbon nanofoam C6 inductor ACNFI touch screen kiosk sensory cells panel shell thermoelectrically sealed vertical and horizontal sectors series circuits highly pure metal alumina atomic symbol Al number 13 annealing, drawing, and spun rolled-wound fine wire or press rolled flat strips fine wire and shielding process in nanoseconds negative electron molecules wavelength frequency to central processing unit CPU wavelength generator added and subtracted changes of the order of wavenumber data stream output nanoseconds processor negative electron molecules wavelength frequency. Keyboard computing device typewriter-style arrangement of keys supplied by a central processing unit CPU processor made up of a manual mechanical arrangement of keys in series and parallel circuits occupying a horizontal plane with various ports, and plug-ins connectivity. Keyboard key parts in series and parallel analogous circuits of enriched highly pure metal molecular copper atomic symbol Cu and number 29, and alumina atomic symbol Al number 13 annealing, drawing, and spun rolled-wound fine wire or press rolled flat strips fine wire and shielding receiving negative electron molecules wavelength frequency keys from keyboard process in nanoseconds electron molecules wavelength frequency keys to central processing unit CPU processor wavelength generator added and subtracted changes of the order of wavenumber data stream output nanoseconds processing electron molecules wavelength frequency keys identification and series data stream generation random access memory RAM and Electronic Storage Medium writable random access memory WRAM compact disc data streams+/−connectivity. The keys consist of and not limited Arabic number keys 0, 1, 2, 3, 4, 5, 6, 7, 8, and 9, various symbol keys transposed on top of number keys !, @, #, $, %, ̂, &, *, (, and ), various symbol keys occupy their own keys and keys transposed on top of various symbol keys −, =, [, ], \, ;, ′, ,, ., /, _, +, {, }, |, :, ″, <, >, ?, and ˜, The International Organization for Standardization ISO basic Latin-script alphabet consists of the following 26 letters alphabet keys in upper-case Q, W, E, R, T, Y, U, I, O, P, A, S, D, F, G, H, J, K, L, Z, X, C, V, B, N, and M, alphabet key in lower-case q, w, e, r, t, y, u, l, o, p, a, s, d, f, g, h, j, k, I, z, x, c, v, b, n, and m, function specific keys space bar, enter, escape, shift, tab, alternate, escape, control, number lock, caps lock, backspace, right arrow, left arrow, up arrow, down arrow, all direction arrow, page-up, page-down, control, function, consecutive Function F1 to F12, home, end, pause, insert, and delete. Central processing unit CPU data stream generator transfer and exchange carrier phase L1 and L2 waveform pulse train signals modes 4 four mode-1 convex waveform cycles ˜ less than < and equal to carrier narrowband 12.5 kHz bandwidth, mode-2 polynumber waveform cycle ˜ less than < and equal to carrier narrowband 12.5 kHz bandwidth N1, N2, N3, N4, N5, N6, N7, N8, N9, N10, N11 & N12, mode-3 inclination waveform cycle [symbol] less than < and equal to carrier narrowband 12.5 kHz bandwidth and mode-4 declination waveform cycle [symbol] less than < and equal to carrier bandwidth wavenumber data added and subtracted order identification in nanoseconds processing Carrier phase L1 and L2 waveform frequency received by analogous efficiency data stream generator transfer and exchange Federal Communication Commission FCC industrial bandwidth kHz random access memory processing integrated internet access and search, photovoltaic video processing, audio processing, scientific calculator, drafting, plotting, drawing, keyboard entry, alidade paint marker input, level, square, force transducer, surveying measurement device, and computer integrated federal airspace system in latitudinal and longitudinal universal transverse Mercator UTM and aviation sectional data. The pure light, filtered light, colored light, and reflective light data stream output spectra wavelength frequency is received by Central processing unit CPU photovoltaic electron molecule wavelength shift generator printer of pure light, filtered light, colored light, and reflective light supersaturated particulate matter colored and shaded scale pigments natural polymer-carbonaceous inks, toner powders and printed films. Analogous series and parallel circuits highly pure metals, super alloys, specification 56 elements, beryllium Be4, beryllium Be4 inductor, magnesium Mg12, magnesium Mg12 inductor, copper Cu29 conductor, aluminum al13 conductor, carbon C6 nanoparticle conductor and alternate C6 carbon nanoparticle inductor ACNFI drawing, annealing, spun and wound coils, windings, extremely fine insulated wire, strips and insulated shielding are made for analogous series and parallel intelligence chemical electron molecule circuits photon and sensor. The analogous series and parallel intelligence chemical electron molecule circuits photon and sensor serve relays, switches, sensors, battery cells, audio processors, spectrometric processors, spectrometric processor flight computer L1 and L2 central processing unit processors spectrometric artificial horizon All-star system transform-noise visual display up VDU optical lens and optical lenses into sexton optical alidade scientific optical mirror or touch-tone key pad Universal Transverse Mercator UTM numbered coordinate entry integrated server L1 and L2 central processing unit CPU processors. The analogous series and parallel intelligence chemical electron molecule circuits photon and sensor serve relays, switches, sensors, battery cells, audio processors, spectrometric processors, spectrometric processor flight computer L1 and L2 central processing unit processors spectrometric artificial horizon All-star system transform-noise visual display up VDU optical lens and optical lenses into sexton optical alidade scientific optical mirror or touch-tone key pad Universal Transverse Mercator UTM numbered coordinate entry integrated server L1 and L2 central processing unit CPU processors component Liquids of condensation molecular enriched purification parts spheroid-centric cells analogous processors scientific g-force instrument, motion sensor, pitch-lateral flight/rate, roll-longitudinal flight/rate, yaw-directional flight/rate, magnetic-flux compensator C 6 nanoparticle brush-inductor antinode coupler compass, aircraft pitot static system super alloy pitot tube and static air barometric pressure airspeed indication, vertical speed indicator and altitude altimeter force transducer scientific measure of change in super alloy insulated scientific barometric pressure chambers and outside static air temperature-humidity processors computation not limited to Specification 56 molecular elements including and not limited to chemical compositions Acid hydrogen fluoride HF, and Alkaline phenyl Lithium C₆H₅⁻Li⁺. Microphone/Speaker component Liquids of condensation molecular enriched purification parts microphone spheroid-centric cells and speaker spheroid-centric cells serve molecular audio component circuits with or without printed audio processors. Microphone/Speaker component Liquids of condensation molecular enriched purification parts microphone spheroid-centric cells and speaker spheroid-centric cells enriched platinum Pt78, colloidal gold Au79, silver Ag47, Specification 56 molecular element, super alloy, beryllium Be4 inductor, magnesium Mg12 inductor, carbon C6 nanoparticle conductor, copper Cu29 conductor, alternate carbon nanofoam C6 inductor ACNFI, allotropes of carbon ionic suspension molecular element and complex element spheroid-centric cell including nickel Ni28 and aluminum Al13. Generators/Transceivers component Liquids of condensation molecular enriched purification and/or molecular enriched oxygen 2 0 2 enrichment crystallization and mineralization parts, molecular element and complex element spheroid-centric cell, chemical element acid, base, alkyl, specification 56 element, and super alloy. Generators/Transceivers component Liquids of condensation molecular enriched purification and/or molecular enriched oxygen 2 0 2 enrichment molecular part spheroid-centric cell and/or allotropes of carbon ionic suspension molecular element and complex element spheroid-centric cell including molecular enriched oxygen 2 0 2 enrichment part quartz S16, diamond No3, silicon dioxide SiO2, allotropes of carbon ionic suspension element molecular enriched part including nickel Ni28, cadmium Cd48, lithium Li4, magnesium Mg12, beryllium Be4, platinum Pt78, colloidal gold Au79, silver Ag47, Specification 56 molecular element, including and not limited to chemical compositions Acid hydrogen fluoride HF, Alkaline phenyl Lithium C₆H₅⁻Li⁺ and super alloy.

Specification of molten diffusion particulate matter PM melts carbonaceous-polyamide, crystalline silica optical, crystalline silica synthetic polymer optical, crystalline silica cellulosic natural polymer, and crystalline silica cellulosic rubber natural polymer optical filtered and non filtered specifications condensation-nuclei type size particles measure in microns Symbol μ lower-case letter mu metric SI equivalent crystalline silica optical, crystalline silica synthetic polymer optical, crystalline silica cellulosic natural polymer, and crystalline silica cellulosic rubber natural polymer optical added molten diffusive particulate matter PM filtered condensation-nuclei type size particles measure in microns Symbol μ lower-case letter mu metric SI equivalent filtered versions of crystalline silica optical, crystalline silica synthetic polymer optical, crystalline silica cellulosic natural polymer, and crystalline silica cellulosic rubber natural polymer optical are filtered alumina, filtered nano alumina, filtered naturally occurring carbon, filtered allotropes of—alternate carbon nanotube inductor and infrared spectrum light analogous identification, filtered radioactive radiation protection precious metals, and filtered Specification 56 Elements spectrum. Formula enhanced molten diffusion mechanically shattered crystalline needlelike chards and refined particulate matter PM Sio² gaseous suspension are drawn into heated 2200° C. molten diffusion C−6 allotropes of carbon reservoir flash forming carbonaceous-silica Si+C6 allotropes of carbon is SiC silica allotropes of C6 carbon or Sio²+2 C6(s) is SiC6(s)+2 O(g) thus allotropes of carbon Silicon-C6 is formed, formula enhanced molten diffusion mechanically shattered crystalline needlelike chards, refined or nanoparticle particulate matter PM Sio² and al13 gaseous suspension are drawn into heated 2200° C. molten diffusion C−6 allotropes of carbon reservoir flash forming carbonaceous-alumina silica Si+al13+C6 allotropes of carbon al13 alumina is Sial13C silica allotropes of carbon al13 alumina or Sio²+al13+2 C6(s) is SiC6al13(s)+2 O(g) thus allotropes of carbon alumina Silicon-C6al13 is formed. Vacuum or compression variable hydraulic press plate and pump specification gaseous negative or positive pressure in atmospheres mechanically refined and nanoparticle molecules, vacuum gaseous distillation reservoir mechanically refined and nanoparticle molecule transfer and mixing compounds, and vacuum gaseous mechanically refined and nanoparticle molecule preparation for control room casting, molding, sintering, and smeltering. Additional distillation reservoir dioxide CO₂ and carbon monoxide CO gaseous super alloy super cooling refrigeration molten diffusion particulate matter PM quenching by vacuum pump and super alloy curved or linear expression comprising a scientific aperture, a divergence measured in angulation, and a scientific aperture diffusive gaseous particle vacuum pump negative pressurized stream accelerator super cooling refrigeration deceleration and distillation reservoir supercooled quenching variable hydraulic press plate less than normal atmospheric with or without negatively pressurized distillation reservoir gaseous molecular diffusion and super alloy heated interface tool steel or supercooled temperature deceleration carbon dioxide CO₂ and carbon monoxide CO fractional distillation hybridizations that may releasing oxides of O₂ and O₁. Distillation reservoir with or without Multi waveform laser X, Y, Z field alignment carbon dioxide CO₂ and carbon monoxide CO ablation and fractional distillation synthesizing. Distillation processing particulate matter PM with or without Carbon dioxide CO₂ and Carbon Monoxide CO are vacuum pump distillation reservoir negatively charged—allotropes of carbon electron molecule electrolysis processed and reinforced with extenders and fillers negatively charged—allotropes of alternate carbon nanotube inductor ACNTI particles. The distillation reservoir may contain of a gaseous mixture consisting of carbon dioxide CO₂, carbon monoxide CO, oxides O₂, oxides O₁, and negatively charged—allotropes of alternate carbon nanotube inductor ACNTI particles. Specification of particulate matter PM carbonaceous-polyamide, crystalline silica optical, crystalline silica synthetic polymer optical, crystalline silica cellulosic natural polymer, and crystalline silica cellulosic rubber natural polymer optical filtered and non filtered specifications condensation-nuclei type size particles measure in microns Symbol μ lower-case letter mu metric SI equivalent, carbonaceous-polyamide, crystalline silica optical, crystalline silica synthetic polymer optical, crystalline silica cellulosic natural polymer, and crystalline silica cellulosic rubber natural polymer optical filtered and non filtered specifications negative charging chemical electron molecule electrolysis drawing and spinning, solution Liquid or gaseous quenching, vacuum processing evaporation and carbonaceous-polyamide, crystalline silica optical, crystalline silica synthetic polymer optical, crystalline silica cellulosic natural polymer, and crystalline silica cellulosic rubber natural polymer optical filtered and non filtered specifications high molecular-weight carbonaceous particulate matter PM in condensation-nuclei type size particles measure in microns Symbol μ lower-case letter mu metric SI equivalent fine beads are collected and vacuum packed sealed for secondary phase Function-specific optical properties manufacturing, and carbonaceous-polyamide beads vacuum packed sealed for fiberaceous filament yarn and thread Function-specific properties manufacturing. Universal pulp agro-fiberaceous cellulosic filaments and subsequent fatty acids and oils extractions cellulosic natural polymers using common distillation processing techniques. The primary agro-fiberaceous filaments sought come from agro-fiberaceous agriculture and waste materials hulls, husks, pits, straw, and peels. The end resultant filament is assorted lipid, lignin, liber, linnet, rosin and viscose. Characteristics and carbonaceous products of these woody-type plants are extracting cellulosic filaments for specification formula non ionic or electrolyte acid, base, or alkyl distillation reservoir specification vacuum processing scientific electrolysis covalent bonding sequence drawing and spinning formula solutions mechanically refined and nanoparticle dispersion continuous spinning yarn and thread while subsequent textile manufacturing. The process begins with collecting and pulverizing-shredding in specification mesh sizes massive tonnage of agro-fiberaceous agriculture and waste materials hulls, husks, pits, straw, and peels. The massive tonnage is batch processed exposure to steam begins cellulosic extractions and convections under ordinary atmospheric pressure, quenching, evaporation, condensing, solution purifying electrolysis particle separations, and chemical pH probe. From here due the complexity of the blend agro-fiberaceous materials follows a simple sequence in order of distillation techniques with varying applications of aging oxidation agents, solution oxidations, solution and vacuum pumping extraction, hydraulic fracturing, centrifuge and electrolysis spinning separation, electron molecule positive and negative electrolysis preparations, steam extractions, pH probe, solution spinning and drawing electrolysis, cooling, chopping continuous filament yarn immersion pressing, aging reagents, pH probe, dissolving, filtering, ripening, simple super alloy or highly pure metal covalent compounds Sulfate SO 4 and Methane CH 4 chemical extrusion, electrolysis solution spinning drawing and spinning filaments, wet process and gaseous purification, bleaching with chloride, ultra-violet UV lamps, or Sunlight, dying with pigments, filament yarn washing, cutting, drying, specialized vacuum packing and preservation storage.

Specification Periodic Table Element Groups Alkali Metals, Alkalide Earth Metals, Transition Metals, Other Metals, Metalloids, Non-Metals, Halogens, Noble Gases, and Rare Earth Element here in atomic number, element symbols, and names 1—H—Hydrogen, 2—He—Helium, 3—Li—Lithium, 4—Be—Beryllium, 5—B—Boron, 6—C—Carbon, 7—N—Nitrogen, 8—O—Oxygen, 9—F—Fluorine, 10—Ne—Neon, 11—Na—Sodium, 12—Mg—Magnesium, 13—Al—Aluminum, 14—Si—Silicon, 15—P—Phosphorus, 16—S—Quartz, 17—Cl—Chlorine, 18—Ar—Argon, 19—K—Potassium, 20—Ca—Calcium, 21—Sc—Scandium, 22—Ti—Titanium, 23—V—Vanadium, 24—Cr—Chromium, 25—Mn—Manganese, 26—Fe—Iron, 27—Co—Cobalt, 28—Ni—Nickel, 29—Cu—Copper, 30—Zn—Zinc, 31—Ga—Gallium, 32—Ge—Germanium, 33—As—Arsenic, 37—Rb—Rubidium, 38—Sr—Strontium, 39—Y—Yttrium, 40—Zr—Zirconium, 41—Nb—Niobium, 42—Mo—Molybdenum, 43—Tc—Technetium, 44—Ru—Ruthenium, 45—Rh—Rhodium, 46—Pd—Palladium, 47—Ag—Silver, 48—Cd—Cadmium, 49—In—Indium, 50—Sn—Tin, 51—Sb—Antimony, 52—Te—Tellurium, 55—Cs—Cesium, 56—Ba—Barium, 57—La—Lanthanum, 58—Ce—Cerium, 59—Pr—Praseodymium, 60—Nd—Neodymium, 61—Pm—Promethium, 62—Sm—Samarium, 63—Eu—Europium, 64—Gd—Gadolinium, 65—Tb—Terbium, 66—Dy—Dysprosium, 67—Ho—Holmium, 68—Er—Erbium, 69—Tm—Thulium, 70—Yb—Ytterbium, 71—Lu—Lutetium, 72—Hf—Hafnium, 73—Ta—Tantalum, 74—W—Tungsten, 75—Re—Rhenium, 76—Os—Osmium, 77—Ir—Iridium, 78—Pt—Platinum, 79—Au—Gold, 80—Hg—Mercury, 81—TI—Thallium, 82—Pb—Lead, 83—Bi—Bismuth, 84—Po—Polonium, 85—At—Astatine, 87—Fr—Francium, 88—Ra—Radium, 89—Ac—Actinium, 90—Th—Thorium, 91—Pa—Protactinium, 92—U—Uranium, 93—Np—Neptunium, 94—Pu—Plutonium, 95—Am—Americium, 96—Cm—Curium, 97—Bk—Berkelium, 98—Cf—Californium, 99—Es—Einsteinium, 100—Fm—Fermium, 101—Md—Mendelevium, 102—No—Nobelium, 103—Lr—Lawrencium, 104—Rf—Rutherfordium, 105—Db—Dubnium, 106—Sg—Seaborgium, 107—Bh—Bohrium, 108—Hs—Hassium, 109—Mt—Meitnerium, 110—Ds—Darmstadtium, 111—R9—Roentgenium, 112—Cn—Copernicium, 113—Uut—Ununtrium, 114—Uuq—Ununquadium, 115—Uup—Ununpentium, 116—Uuh—Ununhexium, 117—Uus—Ununseptium, and/or 118—Uuo—Ununoctium.

Specification Alloys metallurgy substances that are a mixture of two or more metals, or of a metal with a nonmetallic material not limited to Aluminum Alloys AA-8000 used for building wire, Al—Li aluminum, lithium, sometimes mercury, Alnico aluminum, nickel, copper, Duralumin copper, aluminum, Magnalium aluminum, 5% magnesium, Magnox magnesium oxide, aluminum, Nambe aluminum plus seven other unspecified metals, Silumin aluminum, silicon, and Zamak zinc, aluminum, magnesium, copper, Aluminum forms other complex alloys with magnesium, manganese, and platinum. Bismuth Alloys Wood's metal bismuth, lead, tin, cadmium, Rose metal bismuth, lead, tin, Field's metal, and Cerrobend. Cobalt Alloys Megallium, and Stellite cobalt, chromium, tungsten or molybdenum, carbon Talonite cobalt, chromium. Ultimet cobalt, chromium, nickel, molybdenum, iron, tungsten, and Vitallium. Copper Alloys Arsenical copper, Beryllium copper, beryllium, and Billon copper, silver. Brass copper, zinc, Calamine brass copper, zinc, Chinese silver copper, zinc, Dutch metal copper, zinc, Gilding metal copper, zinc, Muntz metal copper, zinc, Pinchbeck copper, zinc, Prince's metal copper, zinc, and Tombac copper, zinc. Bronze copper, tin, aluminum or other element, Aluminum bronze copper, aluminum, Arsenical bronze copper, arsenic, Bell metal copper, tin, Florentine bronze copper, aluminum or tin, Glucydur beryllium, copper, iron, Guanin likely a manganese bronze of copper, manganese, with iron sulfides and other sulfides, Gunmetal copper, tin, zinc, pHosphor bronze copper, tin and phosphorus, Ormolu Gilt Bronze copper, zinc, and Speculum metal copper, tin. Constantan copper, nickel, Copper-tungsten copper, tungsten, Corinthian bronze copper, gold, silver, Cunife copper, nickel, iron, Cupronickel copper, nickel, Cymbal alloys Bell metal copper, tin, Devarda's alloy copper, aluminum, zinc, Electrum copper, gold, silver, Hepatizon copper, gold, silver, Heusler alloy copper, manganese, tin, Manganin copper, manganese, nickel, Nickel silver copper, nickel, Nordic gold copper, aluminum, zinc, tin, Shakudo copper, gold, and Tumbaga copper, gold. Gallium Alloys Galinstan gallium, indium, tin. Gold Alloys Electrum gold, silver, copper, Tumbaga gold, copper, Rose gold, copper, and White gold, nickel, palladium, or platinum. Indium Alloys Field's metal indium, bismuth, tin. Iron or Ferrous Alloys Steel carbon Stainless steel chromium, nickel, AL-6XN, Alloy 20, Celestrium, Marine grade stainless, Martensitic stainless steel, and Surgical stainless steel chromium, molybdenum, nickel. Silicon steel silicon, Tool steel tungsten or manganese, Bulat steel, Chromoly chromium, molybdenum, Crucible steel, Damascus steel, HSLA steel, High speed steel, Maraging steel, Reynolds 531, and Wootz steel. Iron Anthracite iron carbon, Cast iron carbon, Pig iron carbon, and Wrought iron carbon. Fernico nickel, cobalt, Elinvar nickel, chromium, Invar nickel, Kovar cobalt, and Spiegelseisen manganese, carbon, silicon. Ferroalloys Ferroboron, Ferrochrome chromium, Ferromagnesium, Ferromanganese, Ferromolybdenum, Ferronickel, Ferrophosphorus, Ferrotitanium, Ferrovanadium, and Ferrosilicon. Lead Alloys Antimoniallead, antimony, Molybdochalkos lead, copper, Solder lead, tin, Terne lead, tin, and Type metal lead, tin, antimony. Magnesium Alloys Magnox magnesium, aluminum T-Mg—Al—Zn Bergman phase, and Elektron. Mercury Alloys Amalgam mercury and other metal except platinum. Nickel Alloys Alumel nickel, manganese, aluminum, silicon, Chromel nickel, chromium, Cupronickel nickel, bronze, copper, German silver nickel, copper, zinc, Hastelloy nickel, molybdenum, chromium, sometimes tungsten, Inconel nickel, chromium, iron, Monel metal copper, nickel, iron, manganese, Mu-metal nickel, iron, Ni—C nickel, carbon, Nichrome chromium, iron, nickel, Nicrosil nickel, chromium, silicon, magnesium, Nisil nickel, silicon, and Nitinol nickel, titanium, shape memory alloy. Potassium Alloys KLi potassium, lithium, and NaK sodium, potassium. Rare Earth Alloys Mischmetal various rare earths. Silver Alloys Argentium sterling silver, copper, germanium, Billon copper or copper bronze, sometimes with silver, Britannia silver, copper, Electrum silver, gold, Goloid silver, copper, gold, Platinum sterling silver, platinum, Shibuichi silver, copper, and Sterling silver, copper. Tin Alloys Britannium tin, copper, antimony, Pewter tin, lead, copper, and Solder tin, lead, antimony. Titanium Alloys Beta C titanium, vanadium, chromium, other metals, and 6al-4-v titanium, aluminum, vanadium. Uranium Alloys Staballoy depleted uranium with titanium or molybdenum, and Uranium may also be alloyed with plutonium. Zinc Alloys Brass zinc, copper, and Zamak zinc, aluminum, magnesium, copper. Zirconium Alloys Zircaloy zirconium and tin, sometimes with niobium, chromium, iron, nickel.

1. A cool complete vacuum area less than atmospheric gaseous draws any one particulate matter while fluxing gaseous suspension creates the partial vacuum causing atmospheric suspension particulate matter diffusion equal particle distribution or saturation. Suspension electrolysis positive and negative voltage charges of readymade particulate matter electron valences form molecular diffusion covalent bonding in suspension efficient particle distribution. Number 1. A prepared heated specification particulate matter partial vacuum fluxing suspension distillation reservoir continually extracting expanded higher temperature particulate matter melts the instantaneous creation of particulate matter parts of any one, two or more particulate matter materials resultant compound particulate matters. Number 2. The specification making of particulate matter molten diffusion melts and Liquids of condensation metals, paste, gels and vapour gels including extremely high optical grade silicon filtered and non filtered, high optical grade allotropes of carbonaceous-silicon particulate matter, high optical grade allotropes of carbonaceous-silicon particulate matter polyamides synthetic resins, high optical grade silicon filtered and non filtered polyamides synthetic resins, potassium ash and feldspar K 19, zirconium Zr 40, S 16 quartz-bearing basalt Ca 20, cobalt Co 27, silica dioxide Si CO₂, sodium oxide Na₂O, calcium oxide CaO, Aragonite crystalline mineral CaCO3, calcium carbonate CaCO3, Potassium Selenite K2SeO3, Calcium sulfate CaSO4, Gypsum hydrate CaSO4 2H2O, 2-methyl-1,3-butadiene, acrylonitrile, cellulose acetate, methyl methacrylate, polyamides, polyethylene, poly ethylene terephthalate, polyesters, polymeric sulfur polyphosphazenes NPCl2, polypropylene, polystyrene, silicones, toluene diisocyanate polyurethane, copolymer based polyacrylic and polyacrylonitrile sodium polyacrylate, tetrafluoroethene, vinyl acetate, vinyl/poly vinyl chloride, synthetic polymer resins, hybrid allotropes of carbon, molecular silica hybrid allotropes of carbon molecular dioxide Si C O₂, molecular sodium oxide Na ₂O compound, molecular calcium oxide Ca O, alkalines with or without magnesium Mg powdered resins, beryllium Be4 inductor, magnesium Mg12 inductor, carbon C6 nanoparticle conductor, copper Cu29 conductor and alternate carbon nanofoam C6 inductor ACNFI, molecular and nanoparticle alumina Al13, Filtered and Non Filtered Beads and Gels, Group 17 the Halogens, Noble Gases, Chlorophyll A, Chlorophyll B, Sulfate SO 4, Methane CH 4, Ammonia NH3, Sulfuric acid H2SO4, Sodium potassium Na K, polymer of isoprene 2-methyl-1 3-butadiene, Acrylonitrile, Cellulose acetate, Methyl methacrylate, Polyamides, Polyethylene, Poly ethylene terephthalate, Polyesters, Polymeric sulfur polyphosphazenes NPCl2, Polypropylene, Polystyrene, Silicones, Toluene diisocyanate polyurethane, Copolymer based polyacrylic and polyacrylonitrile sodium polyacrylate, Tetrafluoroethene, Vinyl acetate, Vinyl/poly vinyl chloride, Sodium chloride NaCl, Ammonium chloride NH 4 C, Phosphorus chlorides PCl3, POCl3 and PCl5, Phosphorus pentachloride P4O10, Sodium hydrogen carbonate NaHCO3, Sodium hydroxide NaOH, Sodium sulfate Na2SO4, saturated aqueous solution Boric oxide B2O3, Hydrochloric acid HCl, chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 56 elements and/or Specification 57 alloys, 1—H—Hydrogen, 2—He—Helium, 3—Li—Lithium, 4—Be—Beryllium, 5—B—Boron, 6—C—Carbon, 7—N—Nitrogen, 8—O—Oxygen, 9—F—Fluorine, 10—Ne—Neon, 11—Na—Sodium, 12—Mg—Magnesium, 13—Al—Aluminum, 14—Si—Silicon, 15—P—Phosphorus, 16—S—Quartz, 17—Cl—Chlorine, 18—Ar—Argon, 19—K—Potassium, 20—Ca—Calcium, 22—Ti—Titanium, 24—Cr—Chromium, 25—Mn—Manganese, 26—Fe—Iron, 27—Co—Cobalt, 28—Ni—Nickel, 29—Cu—Copper, 30—Zn—Zinc, 31—Ga—Gallium, 40—Zr—Zirconium, 41—Nb—Niobium, 42—Mo—Molybdenum, 47—Ag—Silver, 48—Cd—Cadmium, 49—In—Indium, 50—Sn—Tin, 51—Sb—Antimony, 55—Cs—Cesium, 74—W—Tungsten, 78—Pt—Platinum, 79—Au—Gold, specially high heat resistant highly pure metals and alloys, Specification 56 elements, natural cellulosic polyamides resins, natural cellulosic polyamide rubber resins, natural carbonaceous resins, allotropes of carbonaceous nanoparticles, and natural cellulosic fiberaceous resins, allotropes of carbonaceous-silicon particulate matter cement clinkers and sands, high tensile strength heat resistant allotropes of carbonaceous-metals, allotropes of carbonaceous-polyamides synthetic resins, extremely hard heat resistant heavy mineral cement clinkers and sands, fine minerals and sands, ceramic red brick clay impedance matching load or signal insulators, and complex alkaline and acid powders. Starch hydrolyzed polyacrylonitrile superabsorbent non ionic Polysaccharide tool steel and super alloy extrusion in a continuous linearized drawing annealing spinning supersaturated Liquid gel vapours gel into rubbery consistency and resiliency of Polymeric Sulfur molten diffusion melts temperatures 100° C. melts sulfur polymer will turn red color and viscous melts Greater than Less than >159° C. Less than viscous melts Greater than Less than >175° C. 178° C. 250° C. Less than viscous melts into yellow color And 0° C. or 32° F. Liquids of condensation And melts may 2 0 2 oxidation enrichment non ionic Polysaccharide And ionic suspension electrolyte Phosphate Sodium carbon nanoparticle C 6 P 3 S 3 Na 3, Nitronium carbon C 6 NC 4, Hydrogen chloride carbon C 6HCl, Phosphorus chlorides carbon C 6 PCl3, POCl3 and PCl5, Phosphorus pentachloride carbon C 6 P4O10, Nitronium chloride carbon C 6 PCl 3 2 NO2Cl, Chloride carbon C 6 Cl 4, Hydrocarbon C 6 HC 4, Methane carbon C 6 CH 4, Ammonia carbon C 6 NH 3, Sulfuric acid carbon C 6 H2SO 4 And Sodium potassium carbon C 6 Na K form supercooled below zero freezing Greater than <0° C. or 32° F. Liquids of condensation formula condensation nuclei particulate matter partial and complete suspension above and below normal atmospheric pressure including supercritical+/−positive pressurization and negative vacuum pump in atmospheres and bars of pressure The Liquids of condensation negative partial diffusion gaseous and may complete suspension interface tool steel and super alloy molten melts Polymeric sulfur Greater than Greater than Less than > consistency and resiliency of Polymeric Sulfur hot melt pour drawn into plumbing in a continuous stream, drawing, may annealing, spinning sulfur polymer gel forming solution under and above normal atmospheric pressure including supercritical+/−positive and negative in atmospheres and bars of pressure The Liquids of condensation negative partial diffusion gaseous and may complete suspension supercooled interface tool steel and super alloy drawn into plumbing sulfur polymer forms into yellow color rubbery fibers of the Polymeric sulfur gel in a continuous stream drawing annealing spinning gel sulfur polymer yellow color may hydraulic fracturing for optical purity or purified enrichment into optical sulfur polymer molecules forming eight member arrangement Polymeric sulfur SO 4, Polymeric sulfur silicon SO 4 SIO2 silicon gels and crystalline gels potassium ash and feldspar K 19, zirconium Zr 40, S 16 quartz-bearing basalt Ca 20, cobalt Co 27, silica dioxide Si CO2, sodium oxide Na2O, calcium oxide CaO, Aragonite crystalline mineral CaCO3, calcium carbonate CaCO3, Potassium Selenite K2SeO3, Calcium sulfate CaSO4, Gypsum hydrate CaSO4 2H2O, 2-methyl-1,3-butadiene, acrylonitrile, cellulose acetate, methyl methacrylate, natural cellulosic particulate matter C 6 carbonaceous-polyamide, polyethylene, poly ethylene terephthalate, polyesters, polymeric sulfur polyphosphazenes NPCI2, polypropylene, polystyrene, silicones, toluene diisocyanate polyurethane, copolymer based polyacrylic and polyacrylonitrile sodium polyacrylate, tetrafluoroethene, vinyl acetate, vinyl/poly vinyl chloride, synthetic polymer resins, hybrid allotropes of carbon and molecular dioxide C O₂ compound, molecular silica hybrid allotropes of carbon molecular dioxide Si C O₂ compound, molecular sodium oxide Na ₂O compound, and molecular calcium oxide Ca O And may Natural cellulosic polymer of isoprene 2-methyl-1 3-butadiene gel Liquids of condensation nuclei type particulate matter non ionic Alkali and ionic Liquid gel And Crystalline mineralization optical beads gels pellets paste spinning yarn optical gel cable sheet and line annealing drawing spinning optical cable sheet and line and forged extrusions gel forming casting rod or plate drop into drawing annealing spinning or draw anneal and turn spun pressed roll any turn, full, two, one, one half and one quarter turns form cable sheet and line fiber optical visor full view panel visual display up VDU and heads up display HUD All integrated and polarized spectrometry and processors. Liquids of condensation nuclei type particulate matter non ionic Alkali And Ionic suspension electrolyte including Salts, Sulfosalts and Sulfides Liquid condensation metal may 2 0 2 oxidation enrichment non ionic Polysaccharide And ionic suspension electrolyte Phosphate Sodium carbon C 6 P 3 S 3 Na 3 particulate matter condensation metal and/or ceramic alkali and clay, Hexafluorophosphate carbon C 6 PF 6 particulate matter condensation metal and/or ceramic alkali and clay, Nitronium carbon C 6 NC 4 particulate matter condensation metal and/or ceramic alkali and clay, Hydrogen chloride carbon C 6HCl particulate matter condensation metal and/or ceramic alkali and clay, Phosphorus chlorides carbon C 6 PCl3, POCl3 and PCl5 particulate matter condensation metal and/or ceramic alkali and clay, Phosphorus pentachloride carbon C 6 P4O10 particulate matter condensation metal and/or ceramic alkali and clay, Nitronium chloride carbon C 6 PCl 3 2 NO2Cl particulate matter condensation metal and/or ceramic alkali and clay, Chloride carbon C 6 Cl 4 particulate matter condensation metal and/or ceramic alkali and clay, Hydrocarbon C 6 HC 4 particulate matter condensation metal and/or ceramic alkali and clay, Methane carbon C 6 CH 4 particulate matter condensation metal and/or ceramic alkali and clay, Ammonia carbon C 6 NH 3 particulate matter condensation metal and/or ceramic alkali and clay, Sulfuric acid carbon C 6 H2SO 4 particulate matter condensation metal and/or ceramic alkali and clay And Sodium potassium carbon C 6 Na K particulate matter condensation metal and/or ceramic alkali and clay form Liquid condensation metal alkali and clay C 6 carbon nanoparticle, cesium, chromate, silver, gold, platinum, titanium, tungsten, niobium, manganese, steel, tin, copper, aluminum, gallium, nickel, cadmium, zinc, potassium, magnesium, lithium, indium, salts, sulfosalts, sulfides, antimonide, halide, alkalide, and acid complex enriched solidified powder condensation particulate matter Liquid condensation metals include Polymeric sulfur copper Cu carbon C 6 SO 4 And Hexafluorophosphate copper Cu29 carbon C 6 PF 6 And nanoparticle alumina al13. Liquids of condensation paste, gels, vapour gels form ionic suspension element battery cell or liquid metal series and parallel processor printed circuits, drawing, annealing, spinning yarn, wire, sheet flat strips, cable Line, shielding interwoven and composite mesh light makeweight high tensile strength form convex and right angle shapes up to three dimensional design Building Materials and Formed Fabrication. Number 3. The specification making of supersaturated particulate matter under and above normal atmospheric pressure measured in atmospheres and bars of pressure one, two or more particulate matter materials supercooled 0° C. or 32° F. interface tool steel, and specification acid, bases, and alkyls gaseous partial and complete suspensions of preform slurry non ionic or electrolyte forming as a naturally occurring phenomenon named cloud condensation nuclei or CCNs also known as cloud seeds are small particles typically 0.2 μm, or 1/100th the size of the average cloud droplet. The liquid vapour requires a non-gaseous surface to make the transition from a vapour to a liquid. The supercooled liquids of condensation nuclei particulate matter one, two or more condensation nuclei particulate matter materials resultant condensation nuclei particulate matters maybe electrolysis spun drawn evaporated dispersed casted extruded and formed into resin powders. The liquids of condensation crystalline mineralization formula superfine and ultrafine nuclei particulate matter are derived at the mineral specific density and supersaturating crystallization mineralization specification supercooled temperature and crystallization pressure. The liquids of condensation nuclei particulate matter materials maybe continuously solution processed into silicon gels and crystalline gels potassium ash and feldspar K 19, zirconium Zr 40, S 16 quartz-bearing basalt Ca 20, cobalt Co 27, silica dioxide Si CO₂, sodium oxide Na₂O, calcium oxide CaO, Aragonite crystalline mineral CaCO3, calcium carbonate CaCO3, Potassium Selenite K2SeO3, Calcium sulfate CaSO4, Gypsum hydrate CaSO4 2H2O, 2-methyl-1,3-butadiene, acrylonitrile, cellulose acetate, methyl methacrylate, polyamides, polyethylene, poly ethylene terephthalate, polyesters, polymeric sulfur polyphosphazenes NPCl2, polypropylene, polystyrene, silicones, toluene diisocyanate polyurethane, copolymer based polyacrylic and polyacrylonitrile sodium polyacrylate, tetrafluoroethene, vinyl acetate, vinyl/poly vinyl chloride, synthetic polymer resins, hybrid allotropes of carbon and molecular dioxide C O₂ compound, molecular silica hybrid allotropes of carbon molecular dioxide Si C O₂ compound, molecular sodium oxide Na ₂O compound, and molecular calcium oxide Ca O, alkalines with or without magnesium Mg powdered resins, beryllium Be4 inductor, magnesium Mg12 inductor, carbon C6 nanoparticle conductor, copper Cu29 conductor and alternate carbon nanofoam C6 inductor ACNFI, molecular and nanoparticle alumina Al13, Filtered and Non Filtered Beads and Gels, Group 17 the Halogens, Noble Gases, Chlorophyll A, Chlorophyll B, Sulfate SO 4, Methane CH 4, Ammonia NH3, Sulfuric acid H2SO4, Sodium potassium Na K, polymer of isoprene 2-methyl-1 3-butadiene, Acrylonitrile, Cellulose acetate, Methylmethacrylate, Polyamides, Polyethylene, Poly ethylene terephthalate, Polyesters, Polymeric sulfur polyphosphazenes NPCl2, Polypropylene, Polystyrene, Silicones, Toluene diisocyanate polyurethane, Copolymer based polyacrylic and polyacrylonitrile sodium polyacrylate, Tetrafluoroethene, Vinyl acetate, Vinyl/poly vinyl chloride, Sodium chloride NaCl, Ammonium chloride NH 4 C, Phosphorus chlorides PCl3, POCl3 and PCl5, Phosphorus pentachloride P4O10, Sodium hydrogen carbonate NaHCO3, Sodium hydroxide NaOH, Sodium sulfate Na2SO4, saturated aqueous solution Boric oxide B2O3, Hydrochloric acid HCl, chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 56 elements and/or Specification 57 alloys, 1—H—Hydrogen, 2—He—Helium, 3—Li—Lithium, 4—Be—Beryllium, 5—B—Boron, 6—C—Carbon, 7—N—Nitrogen, 8—O—Oxygen, 9—F—Fluorine, 10—Ne—Neon, 11—Na—Sodium, 12—Mg—Magnesium, 13—Al—Aluminum, 14—Si—Silicon, 15—P—Phosphorus, 16—S—Quartz, 17—Cl—Chlorine, 18—Ar—Argon, 19—K—Potassium, 20—Ca—Calcium, 22—Ti—Titanium, 24—Cr—Chromium, 25—Mn—Manganese, 26—Fe—Iron, 27—Co—Cobalt, 28—Ni—Nickel, 29—Cu—Copper, 30—Zn—Zinc, 31—Ga—Gallium, 40—Zr—Zirconium, 41—Nb—Niobium, 42—Mo—Molybdenum, 47—Ag—Silver, 48—Cd—Cadmium, 49—In—Indium, 50—Sn—Tin, 51—Sb—Antimony, 55—Cs—Cesium, 74—W—Tungsten, 78—Pt—Platinum, 79—Au—Gold, specially high heat resistant highly pure metals and alloys, Specification 56 elements, natural cellulosic polyamides resins, natural cellulosic polyamide rubber resins, natural carbonaceous resins, allotropes of carbonaceous nanoparticles, and natural cellulosic fiberaceous resins drawn annealing print rolled film sheet cut strip drawing annealed spun wound wrapped wire coil interwoven shielding cable line spinning yarn and thread insulates spools and woven textile mesh. The supercooled liquids of condensation nuclei particulate matter one, two or more condensation nuclei particulate matter materials resultant condensation nuclei particulate matters natural polymer, natural polyamide, natural cellulosic rubber, silicon, specification 56 elements, specification 57 alloys, alumina nanoparticle and carbon nanoparticle supersaturated deceleration liquid and vapour fluid transfer into synthetic polymer melt molten diffusion hydraulic forged molding rod and plate cast one half turn spin, drop, drawing, annealing, spinning, rolled and cut yarn, sheet, film and strip. The supercooled liquids of condensation nuclei particulate matter one, two or more condensation nuclei particulate matter materials resultant condensation nuclei particulate matters polymer, polyamide, silicon, specification 56 elements, alumina nanoparticle and carbon nanoparticle supersaturated deceleration liquid and vapours fluid transfer into specification formula acid, base and alkyl electron valences into plumbing drawing and spinning solution including silicon, natural polymer, natural polyamide, natural polymer, natural cellulosic rubber, specification 56 elements, alumina nanoparticle and carbon nanoparticle tool steel interface fluid timed supercooling deceleration specification of continuous linear dispersion gel electron valences into plumbing drawing, annealing, spinning and rolled cut yarn, sheet, film and strip. The supercooled liquids of condensation nuclei particulate matter one, two or more condensation nuclei particulate matter materials resultant condensation nuclei particulate matters polymer, polyamide, silicon, specification 56 elements, alumina nanoparticle and carbon nanoparticle supersaturated deceleration liquid and vapour fluid transfer into supercritical supercooled deceleration hydraulic forged molding rod and plate dispersion cast one half turn spin, drop, drawing, annealing, spinning, rolled and cut yarn, sheet, film and strip. Preform slurry non ionic or electrolyte mechanically refined and nanoparticle dispersion allotropes of carbon made by variable hydraulic preform slurry non ionic or electrolyte mechanically refined and nanoparticle dispersion high wear-heat resistant parts press The variable hydraulic press and distillation reservoir manufacture process scientific formula non ionic or electrolyte mechanically refined and nanoparticle, allotropes of carbon dispersion preform slurry extrusion, with or without ionic suspension element for manufactured preform slurry high wear-heat resistant parts electronic component composite coils beryllium Be4, magnesium Mg12, copper Cu29 and carbon nanofoam C6, spun wound windings beryllium Be4, magnesium Mg12, copper Cu29 and carbon nanofoam C6 annealing, drawn, spun, coils, windings, wire, woven textile mesh, shielding, brushes, inductors, antinode couplers, electric rheostats, starters, motors, alternators, generators, ionic suspension element enhanced composite coils, composite windings, spun wound coils beryllium Be4, magnesium Mg12, copper Cu29 and carbon nanofoam C6, spun wound windings beryllium Be4, magnesium Mg12, copper Cu29 and carbon nanofoam C6 annealing, drawn, spun, coils, windings, wire, woven textile mesh, shielding, brushes, capacitors, battery cells, rheostats, electronic resistors, transformers, transducers, rectifiers, power supplies, or heat, preform slurry high wear-heat resistant parts aerospace, automotive, and transportation brake calipers, rotors, pads, and bushings, preform slurry non ionic or electrolyte mechanically refined and nanoparticle high wear-heat resistant parts precision casting molds 2.5 phase die cast molding and covalent bonding sequence drawing and spinning formula solutions mechanically refined and nanoparticle dispersion fine concrete, mortar, brick, and tiles. The variable hydraulic preform slurry non ionic or electrolyte mechanically refined and nanoparticle dispersion high wear-heat resistant parts press with FIG. 1 numbers 1 to 18 specific components that conform to specified requirements to unique American Society for Testing and Materials International Standards Worldwide Identifiers. Variable hydraulic preform slurry non ionic or electrolyte mechanically refined and nanoparticle dispersion high wear-heat resistant parts press the center of the utility patent application specification slurry formula in three scientific forms of 6—Solids, 7—Liquids and 8—Gases Noble gaseous element Argon and other gaseous element specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 56 elements and/or Specification 57 alloys manufactured preform slurry non ionic or electrolyte mechanically refined and nanoparticle high wear-heat resistant parts. The variable hydraulic preform slurry non ionic or electrolyte mechanically refined and nanoparticle dispersion high wear-heat resistant parts press FIG. 1 numbers 1 to 18. The 1—Hydraulic control wheel is connected to the 2—Electronic servo processor and allows the operator to expand and contract 7—Slurry non ionic and electrolyte tool steel press plate primarily to expand the 10—Slurry non ionic and electrolyte tool steel reservoir by moving the 1—Hydraulic control wheel in a fully counter clockwise fashion. This allows the operator to initiate a separate machine to pump Slurry non ionic and electrolyte into the 8—Slurry non ionic and electrolyte tool steel line in, subsequently to the 9—Gravity feed collector line out and finally to the 10—Slurry non ionic and electrolyte tool steel reservoir. Slurry non ionic and electrolyte is defined here as specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 56 elements and/or Specification 57 alloys manufactured preform slurry non ionic or electrolyte mechanically refined and nanoparticle high wear-heat resistant parts. After the 10—Slurry non ionic and electrolyte tool steel reservoir is filled the operator can electronically disengage or manually remove the manual stop control release pull pin. The operator then closes the 9B—Tool steel control to prepare for the extrusion. The operator would proceed by rotating the 1—Hydraulic control wheel in a clockwise fashion contracting the 7—Slurry non ionic and electrolyte tool steel press plate and forcing the Slurry non ionic and electrolyte comprised of non ionic or electrolyte mechanically refined and nanoparticle slurry formula into the 17—Tool steel extrusion die cast design internal cavity. The specified amount of Slurry non ionic and electrolyte is compressed to preform slurry non ionic or electrolyte mechanically refined and nanoparticle specification pressure measured in millibars Mb until the specified Slurry non ionic and electrolyte required to fill the 17—Tool steel extrusion die cast design internal cavity has been reached. The 1—Hydraulic control wheel is then locked until the 17—Tool steel extrusion die cast design internal cavity has been removed. The 2—Electronic servo processor sends an electrical signal to the 3—Hydraulic pump of the 7—Slurry non ionic and electrolyte tool steel press plate position that is calibrated to the 1—Hydraulic control wheel. The 3—Hydraulic pump receives an electrical signal from the 2—Electronic servo processor of the 7—Slurry non ionic and electrolyte tool steel press plate position that is calibrated to the 1—Hydraulic control wheel. The 3—Hydraulic pump pumps fluids to the 4—Hydraulic pipe. The 4—Hydraulic pipe receives fluids from the 3—Hydraulic pump and conveys the fluids to the 5—Hydraulic actuator. The 5—Hydraulic actuator receives fluids from the 4—Hydraulic pipe and the force from the fluids is transferred through the actuator as vertical up-and-down movement to an affixed 6—Hydraulic arm. The 6—Hydraulic arm moves vertically up-and-down and forces the 7—Slurry non ionic and electrolyte tool steel press plate to expand and contract. The 7—Slurry non ionic and electrolyte tool steel press plate is forced by the 6—Hydraulic arm to expand and contract. The 8—Slurry non ionic and electrolyte tool steel line in receives Slurry non ionic and electrolyte from an external pump and conveys them to the 9A—Gravity feed tool steel collector. The 8—Slurry non ionic and electrolyte tool steel line in can be ionic process tool steel interface positive or negative electrode electronically charged for enhanced formulation. The 9A—Gravity feed tool steel collector receives Slurry non ionic and electrolyte from the 8—Slurry non ionic and electrolyte tool steel line in and conveys them to the 10—Slurry non ionic and electrolyte tool steel reservoir. The 10—Slurry non ionic and electrolyte tool steel reservoir receives Slurry non ionic and electrolyte from the 9A—Gravity feed tool steel collector line out. After the 10—Slurry non ionic and electrolyte tool steel reservoir is filled the 9B—Tool steel control is utilized to close the opening to prepare for the extrusion and may be provisionally locked and stopped at any position. The 11—Slurry non ionic and electrolyte reservoir regulated tool steel carbonaceous-polyamide, polyamide and nanoparticle c 6 waste filtration and may liquids and gaseous removes waste from the 10—Slurry non ionic and electrolyte tool steel reservoir while it is being filled with Slurry non ionic and electrolyte from common recovery distillation heated interface tool steel and thermometer gauge, ordinary atmospheric pressure, vacuum pump barometric pressure measured in millibars Mb, and fractional distillation all waste gases are processed to flu gas detoxification system. The 12—Slurry non ionic and electrolyte reservoir expanded. The 13—Slurry non ionic and electrolyte reservoir contracted. The 14—Slurry non ionic and electrolyte reservoir brass or tool steel aperture and 15—Tool steel extrusion die cast design brass or tool steel fitting connects directly and conveys Slurry non ionic and electrolyte to the 17—Tool steel extrusion die cast design internal cavity. The 18—Tool steel extrusion die cast design internal cavity regulator carbonaceous-polyamide, polyamide and nanoparticle c 6 waste filtration and may liquids and gaseous and 18B—Tool steel vacuum release control and portal works in unison with the press plate drawing expanding and contracting Slurry non ionic and electrolyte removing waste from the 17—Tool steel extrusion die cast design internal cavity while it is being filled with Slurry non ionic and electrolyte from common recovery distillation heated interface tool steel and thermometer gauge, ordinary atmospheric pressure, vacuum pump barometric pressure measured in millibars Mb, and fractional distillation all waste gases are processed to flu gas detoxification system. The 17—Tool steel extrusion die cast internal cavity is designed as a tool steel extrusion die cast mold for each highly pure naturally occurring carbon and allotropes of carbon filler and adhesive insulator part comprised of two master extrusion tool steel halves. This is accomplished by first utilizing engineering drafting and computer aided design with the most advanced tool steel part manufacture process and tool steel part machining techniques and/or by utilizing replacement ceramic molds specification number 36 to supplement the development of extrusion die cast master molding may L1 L2 processor design L1 L2 processor master fabrication design, construction engineering, box framing casting preform tool steel hydraulic preform modular high purity preform, And tool steel die cast molds. Highly pure naturally occurring carbon, hybrid allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator vacuum control of nitrogen, hydrogen, chlorine, ether, amino acid, or element dispersion brake pads, electronic brushes and parts require two master extrusions tool steel mold halves for each specification part. Highly pure naturally occurring carbon, hybrid allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator parts precision casting molds requires a minimum two and a maximum of six master extrusion tool steel mold halves for each specification part. Highly pure naturally occurring carbon, hybrid allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator parts precision casting molds are utilized to manufacture highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator 1.0 to 2.5 phase extrusions and two to six master highly pure naturally occurring carbon, hybrid allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator mold halves per specification part. The manufacture process of 1.0 to 2.5 phase extrusions and die cast design for highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina all 3, synthetic polymers, natural polymers, or natural polymers rubber filtered and non filtered beads, gels, cables; lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator requires two to six master extrusion tool steel halves for each two to six reciprocal highly pure naturally occurring carbon, hybrid allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator master precision casting molds parts allowing two A and B highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator to be combined. The 0.5 phase extrusion equals two die cast mold halves both equal to or less than one half 0.5 phase extrusion molten pour. The utility patent application specification concrete control room and monitoring station manufacturing in a complete vacuum area less than atmospheric gaseous and gases produced or added comprise the partial vacuum and may supply rich oxygen from capillary feeders at varying points to the specified highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator part molten fill A and B fills up to four pours. The highly pure naturally occurring carbon, ACNFI filler and adhesive insulator half shell or 0.5 phase extrusion are designed and utilized for state of the art manufacture process when combining highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina all 3, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator in combination of layered foundry fills, parts may be sprayed and dipped non conductive adhesives insulator films, and all waste gases are processed to flu gas detoxification system. The highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator is a layered greater than 0% to less than 100% alloy component A and greater than 0% to less than 100% alloy component B part that is created in combination of layered foundry fills by utilizing two to six master highly pure naturally occurring carbon, hybrid allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator parts precision casting molds per specification part by pouring molten fill as a layered alloying component highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator four molten metal or other fill pours equal to 1.0 to 2.5 phase extrusions. The highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator is a layered greater than 0% to less than 100% highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator A component part, and greater than 0% to less than 100% highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator B component part created in combination of layered fills of two to six master highly pure naturally occurring carbon, hybrid allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator extrusion die cast mold halves equal to 1.0 to 2.5 phase extrusions. Distillation reservoir and recovery basin made of super alloy, and/or ceramic, and/or allotropes of carbon or beryllium Be4 inductor, magnesium Mg12 inductor, carbon C6 nanoparticle conductor, copper Cu29 conductor and alternate carbon nanofoam C6 inductor ACNFI filler and adhesive insulator including variable hydraulic press plate for specification distillation processing. Polarized windshields, optical glass, polymers gels distillation positively and negatively charging electrolysis of molten glass, optical glass, reflective beads, polymer gels, lenses, up to or greater >1.25 inch left to right vertical and horizontal picture resolution integrated and polarized photogray, photocolor and photochemical light filtered light identification photo chemically active electron molecule film mirrors, polarized windshield casted or molten diffusion forged, and molten specification materials 1.0 to 2.0 phase casted or extruded and distillation processing of specification highly pure metal, super alloy, ceramic, and alkaline. Windshield and specification materials are chemically surface treated distillation processed with specification acid and bases and Specification 56 elements or mechanically refined and nanoparticle specification acid and bases dispersions. Molten diffusion-plating with or without electrolysis of mechanically refined and nanoparticle Specification 56 elements, Specification 57 alloys, copper nanoparticles, colloidal gold, silver nanoparticles, iron nanoparticles, molecular tool steel, molecular super alloy, element nanoparticles, platinum nanoparticles printed circuits, super alloy including allotropes of carbon printed circuits, allotropes of carbon printed circuits, beryllium Be4 inductor, magnesium Mg12 inductor, carbon C6 nanoparticle conductor, copper Cu29 conductor and alternate carbon nanofoam C6 inductor ACNFI printed circuits, allotropes of carbon ionic suspension element printed circuits nickel, cadmium, lithium, magnesium, and nanoparticle alumina molecular ionic dispersion or molecular ionic covalent bonding series, parallel printed circuits, random access memory RAM and writable random access memory WRAM. Electrolysis distillation positively and negatively charged electron molecules allotropes of carbon, beryllium Be4 inductor, magnesium Mg12 inductor, carbon C6 nanoparticle conductor, copper Cu29 conductor and alternate carbon nanofoam C6 inductor ACNFI, nanoparticle alumina, Specification 56 elements, and Specification 57 alloys with greater and lesser than normal atmospheric pressure, super heating, super cooling scientific molecular diffusion, and fractional distillation are accomplished. Distillation processing mechanically refined particles measure in microns Symbol μ lower-case letter mu metric SI equivalent silica mineral, mineral sands, heavy minerals, alumina, nanoparticle alumina, highly pure naturally occurring carbon, alkaline, acid solids, allotropes of carbon, beryllium Be4 inductor, magnesium Mg12 inductor, carbon C6 nanoparticle conductor, copper Cu29 conductor and alternate carbon nanofoam C6 inductor ACNFI, gold, platinum, lead, acrylic and synthetic polymers, catalyst gaseous and electrolysis process materials for sintering and smelting pouring molten materials to apertures of variable hydraulic press plate, die cast extrusion molds, crucibles, and mold casings. Other distillation processing mechanically refined and nanoparticle preform slurry non ionic or electrolyte dispersion or molten highly pure metal, super alloy, highly pure naturally occurring carbon, allotropes of carbon, beryllium Be4 inductor, magnesium Mg12 inductor, carbon C6 nanoparticle conductor, copper Cu29 conductor and alternate carbon nanofoam C6 inductor ACNFI, nanoparticle alumina, alumina, silica alumina or molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, silica mineral, mineral sands, heavy minerals, glass, acrylic, synthetic polymer, acid solid, impedance matching ceramic red brick insulator, molybdenum, ceramic zirconia, ceramic silica, ceramic clay, Aragonite crystalline mineral CaCO3, calcium carbonate CaCO3, Potassium Selenite K2SeO3, Calcium sulfate CaSO4, Gypsum hydrate CaSO4 2H2O, silicon dioxide SiO2, sodium oxide Na₂O, calcium oxide CaO, alkalines, minerals, including ionic suspension elements and ceramic silica mineral insulator for Specification 56 elements highly pure metal, and Specification 57 alloys. Distillation reservoir specification manufactured battery conservation of energy cool and cold low temperature operating range made Series of right angles 2 π radians or one full turn the sum of the exterior angles form convex regular polygons corrugated and compartmented light makeweight fabrication monocombe shapes of triangle, square, pentagon, hexagon, heptagon, octagon, nonagon, polynumber and planess and right angle combinations light makeweight design electromagnetic conductive Group 17 the halogens, antimony Sb, Polysaccharide And ionic suspension electrolyte Phosphate Sodium carbon C 6 P 3 S 3 Na 3 particulate matter including Salts, Sulfosalts and Sulfides condensation metal, Hexafluorophosphate carbon C 6 PF 6 particulate matter condensation metal, Nitronium carbon C 6 NC 4 particulate matter condensation metal, Hydrogen chloride carbon C 6HCl particulate matter condensation metal, Phosphorus chlorides carbon C 6 PCl3, POCl3 and PCl5 particulate matter condensation metal, Phosphorus pentachloride carbon C 6 P4O10 particulate matter condensation metal, Nitronium chloride carbon C 6 PCl 3 2 NO2Cl particulate matter condensation metal, Chloride carbon C 6 Cl 4 particulate matter condensation metal, Hydrocarbon C 6 HC 4 particulate matter condensation metal, Methane carbon C 6 CH 4 particulate matter condensation metal, Ammonia carbon C 6 NH 3 particulate matter condensation metal, Sulfuric acid carbon C 6 H2SO 4 particulate matter condensation metal and/or ceramic alkali and clay And Sodium potassium carbon C 6 Na K particulate matter condensation metal mechanically refined particles measure in microns Symbol μ lower-case letter mu metric SI equivalent alumina particles, alkaline particles, nickel particles, cadmium particles, lithium particles, magnesium particles, fused ionic material complex mechanically refined particles measure in microns Symbol μ lower-case letter mu metric SI equivalent acid complex particles, alkaline complex particles, antimonide complex particles, halide complex particles, alkalide complex particles, mechanically refined particles measure in microns Symbol μ lower-case letter mu metric SI equivalent Specification 56 conductive elements and Specification 57 conductive alloys, allotropes of carbon, beryllium Be4 inductor, magnesium Mg12 inductor, carbon C6 nanoparticle conductor, copper Cu29 conductor, alternate carbon nanofoam C6 inductor ACNFI and nanoparticle alumina measure in nanometers Nm. Distillation processing and/or for up to four molten pours 1.0 to 2.5 phase casted or extruded molten material or preform slurry non ionic or electrolyte. Molten pours and variable hydraulic press plate preform slurry non ionic or electrolyte mechanically refined and nanoparticle dispersion under vacuum control room scientific distillation ordinary atmospheric pressure less than ordinary atmospheric pressure catalyst gases other Specification 56 elements argon, carbon monoxide, carbon dioxide, or other gases mechanically refined or nanoparticle suspension catalyst greater or lesser than ordinary atmospheric pressure molecular diffusion, super cooling, and fractional distillation specification suspension may also accomplish allotropes of carbon hybridizations. Super alloy super cooling refrigeration vacuum pump and super alloy curved or linear expression comprising a scientific aperture, a divergence measured in angulation, and a scientific aperture diffusive gaseous particle vacuum pump negative pressurized stream accelerator super cooling refrigeration deceleration with or without nanoparticle synthesizing laser ablation and multi-waveform ablation X, Y, Z alignment with or without fluxing agents, molecular alumina al13, and fractional vacuum distillation gaseous and/or positive and negative ionic charges recovery and super alloy and/or ceramics and/or highly pure naturally occurring carbon and allotropes of carbon filler and adhesive insulator distillation reservoir variable hydraulic press plate expanded and contracted greater or lesser than ordinary atmospheric pressure distillation recovery fractional vacuum distillation gaseous and/or positive distillation and variable hydraulic press plate expanded and contracted greater or lesser than ordinary atmospheric pressure distillation recovery allotropes of 6 C carbon, carbon, solid, liquid, and gases chemical non ionic groups of amphoteric polysaccharide linear or branched alkyl compounds or electrolytes and/or liquid ions and/or ionic melts and/or fused and/or acid and bases catalyst and/or catalyst slurry reservoir 6 C allotropes of carbon and liquid and/or liquid vapours and/or gaseous electrolyte catalyst acids and solid materials highly pure metal, super alloy, highly pure naturally occurring carbon, allotropes of carbon, beryllium Be4 inductor, magnesium Mg12 inductor, carbon C6 nanoparticle conductor, copper Cu29 conductor and alternate carbon nanofoam C6 inductor ACNFI, nanoparticle alumina, alumina, silica alumina or molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, silica mineral, mineral sands, heavy minerals, glass, acrylic, synthetic polymer, acid solid, impedance matching ceramic red brick insulator, molybdenum, ceramic zirconia, ceramic silica, ceramic clay, Aragonite crystalline mineral CaCO3, calcium carbonate CaCO3, Potassium Selenite K2SeO3, Calcium sulfate CaSO4, Gypsum hydrate CaSO4 2H2O, silicon dioxide SiO2, sodium oxide Na₂O, calcium oxide CaO, alkalines, minerals, including ionic suspension elements and ceramic silica mineral insulator for Specification 56 elements highly pure metal, and Specification 57 alloys for building materials Number 4. preform slurry specification formula non ionic or electrolyte acid, base, or alkyl distillation reservoir specification vacuum processing with or without scientific electrolysis covalent bonding sequence drawing and spinning formula solutions mechanically refined and nanoparticle dispersion fine concrete, mortar, brick, and tiles, and high wear-heat resistant parts brushes, windings, coils, battery cells, electronic resistors, capacitors, brake pads, washers, spacers, bushings, annealing, drawn, spun, coils, windings, wire, woven textile mesh, shielding, and 1.0 to 2.5 phase casted or extruded die cast molding. An insulate, electronic part, brake calipers part, rotors part, brake pads, washers, spacers, shims, dowels, bushings part light weight chemical ionic acid usually an amino acid, non ionic bases usually nitrogen/hydrogen or non ionic groups of amphoteric polysaccharide linear or branched alkyl compounds usually methyl continuous sheets cut films insulate, specification formula non ionic or electrolyte acid, base, or alkyl distillation reservoir specification vacuum processing scientific electrolysis covalent bonding sequence drawing and spinning formula solutions mechanically refined and nanoparticle dispersion continuous spinning yarn and thread, spinning yarn and thread, preform optical grade silica and forged optical grade silica with or without natural polymer, natural polymer rubber, synthetic polymer, natural polyamide, natural polyamide rubber, allotropes of C6 carbon, and all specification materials. Variable hydraulic press, plate or distillation reservoir liquid dispersion and particulate matter PM specifications of nanoparticle and condensation-nuclei type size particles measure in microns Symbol μ lower-case letter mu metric SI equivalent natural polymer, natural polymer rubber, synthetic polymer, allotropes of C6 carbon, and all specification materials slurry non ionic heated or chilled interface 8—Slurry non ionic tool steel line in heated or chilled chemical ionic acid usually an amino acid, non ionic bases usually nitrogen/hydrogen or non ionic groups of amphoteric polysaccharide linear or branched alkyl compounds usually methyl liquid dispersion liquid dispersion heated chemical non ionic groups of amphoteric polysaccharide linear or branched alkyl compounds methyl liquid dispersion natural polymer carbon, natural polymer or synthetic polymer carbon, allotropes of carbon, allotropes of carbon silica, allotropes of carbon silica alumina/nano alumina and allotropes of carbon alumina/nano alumina and all specification materials or liquid dispersion chilled polysaccharide linear or branched alkyl compounds and reinforcement of allotropes of carbon networks in suspension drying over usually fifteen minutes result network light weight natural polymer carbon, natural polymer or synthetic polymer carbon, allotropes of carbon, allotropes of carbon silica, allotropes of carbon silica alumina/nano alumina and allotropes of carbon alumina/nano alumina and all specification materials controllable, high purity, connectivity, strength, conductivity, and/or shape. Specification of molten diffusion particulate matter PM melts carbonaceous-polyamide, crystalline silica optical, crystalline silica synthetic polymer optical, crystalline silica cellulosic natural polymer, and crystalline silica cellulosic rubber natural polymer optical filtered and non filtered specifications condensation-nuclei type size particles measure in microns Symbol μ lower-case letter mu metric SI equivalent crystalline silica optical, crystalline silica synthetic polymer optical, crystalline silica cellulosic natural polymer, and crystalline silica cellulosic rubber natural polymer optical added molten diffusive particulate matter PM filtered condensation-nuclei type size particles measure in microns Symbol μ lower-case letter mu metric SI equivalent filtered versions of crystalline silica optical, crystalline silica synthetic polymer optical, crystalline silica cellulosic natural polymer, and crystalline silica cellulosic rubber natural polymer optical are filtered alumina, filtered nano alumina, filtered naturally occurring carbon, filtered allotropes of—alternate carbon nanotube inductor and infrared spectrum light analogous identification, filtered radioactive radiation protection precious metals, and filtered Specification 56 Elements spectrum. Formula enhanced molten diffusion mechanically shattered crystalline needlelike chards and refined particulate matter PM Sio² gaseous suspension are drawn into heated 2200° C. molten diffusion C−6 allotropes of carbon reservoir flash forming carbonaceous-silica Si+C6 allotropes of carbon is SiC silica allotropes of C6 carbon or Sio²+2 C6(s) is SiC6(s)+2 O(g) thus allotropes of carbon Silicon-C6 is formed, formula enhanced molten diffusion mechanically shattered crystalline needlelike chards, refined or nanoparticle particulate matter PM Sio² and al13 gaseous suspension are drawn into heated 2200° C. molten diffusion C−6 allotropes of carbon reservoir flash forming carbonaceous-alumina silica Si+al13+C6 allotropes of carbon al13 alumina is Sial13C silica allotropes of carbon al13 alumina or Sio²+al13+2 C6(s) is SiC6al13(s)+2 O(g) thus allotropes of carbon alumina Silicon-C6al13 is formed. Vacuum or compression variable hydraulic press plate and pump specification gaseous negative or positive pressure in atmospheres mechanically refined and nanoparticle molecules, vacuum gaseous distillation reservoir mechanically refined and nanoparticle molecule transfer and mixing compounds, and vacuum gaseous mechanically refined and nanoparticle molecule preparation for control room casting, molding, sintering, and smeltering. Additional distillation reservoir dioxide CO₂ and carbon monoxide CO gaseous super alloy super cooling refrigeration molten diffusion particulate matter PM quenching by vacuum pump and super alloy curved or linear expression comprising a scientific aperture, a divergence measured in angulation, and a scientific aperture diffusive gaseous particle vacuum pump negative pressurized stream accelerator super cooling refrigeration deceleration and distillation reservoir supercooled quenching variable hydraulic press plate less than normal atmospheric with or without negatively pressurized distillation reservoir gaseous molecular diffusion and super alloy heated interface tool steel or supercooled temperature deceleration carbon dioxide CO₂ and carbon monoxide CO fractional distillation hybridizations that may releasing oxides of O₂ and O₁. Distillation reservoir with or without Multi waveform laser X, Y, Z field alignment carbon dioxide CO₂ and carbon monoxide CO ablation and fractional distillation synthesizing. Distillation processing particulate matter PM with or without Carbon dioxide CO₂ and Carbon Monoxide CO are vacuum pump distillation reservoir negatively charged—allotropes of carbon electron molecule electrolysis processed and reinforced with extenders and fillers negatively charged—allotropes of alternate carbon nanotube inductor ACNTI particles. The distillation reservoir may contain of a gaseous mixture consisting of carbon dioxide CO₂, carbon monoxide CO, oxides O₂, oxides O₁, and negatively charged—allotropes of alternate carbon nanotube inductor ACNTI particles. Specification of particulate matter PM carbonaceous-polyimide, crystalline silica optical, crystalline silica synthetic polymer optical, crystalline silica cellulosic natural polymer, and crystalline silica cellulosic rubber natural polymer optical filtered and non filtered specifications condensation-nuclei type size particles measure in microns Symbol μ lower-case letter mu metric SI equivalent, carbonaceous-polyamide, crystalline silica optical, crystalline silica synthetic polymer optical, crystalline silica cellulosic natural polymer, and crystalline silica cellulosic rubber natural polymer optical filtered and non filtered specifications negative charging chemical electron molecule electrolysis drawing and spinning, solution Liquid or gaseous quenching, vacuum processing evaporation and carbonaceous-polyamide, crystalline silica optical, crystalline silica synthetic polymer optical, crystalline silica cellulosic natural polymer, and crystalline silica cellulosic rubber natural polymer optical filtered and non filtered specifications high molecular-weight carbonaceous particulate matter PM in condensation-nuclei type size particles measure in microns Symbol μ lower-case letter mu metric SI equivalent fine beads are collected and vacuum packed sealed for secondary phase Function-specific optical properties manufacturing, and carbonaceous-polyamide beads vacuum packed sealed for fiberaceous filament yarn and thread Function-specific properties manufacturing. Universal pulp agro-fiberaceous cellulosic filaments and subsequent fatty acids and oils extractions cellulosic natural polymer using common distillation processing techniques. The primary agro-fiberaceous filaments sought come from agro-fiberaceous agriculture and waste materials hulls, husks, pits, straw, and peels. The end resultant filament is assorted lipid, lignin, liber, linnet, rosin and viscose. Characteristics and carbonaceous products of these woody-type plants are extracting cellulosic filaments for specification formula non ionic or electrolyte acid, base, or alkyl distillation reservoir specification vacuum processing scientific electrolysis covalent bonding sequence drawing and spinning formula solutions mechanically refined and nanoparticle dispersion continuous spinning yarn and thread while subsequent textile manufacturing. The process begins with collecting and pulverizing-shredding in specification mesh sizes massive tonnage of agro-fiberaceous agriculture and waste materials hulls, husks, pits, straw, and peels. The massive tonnage is batch processed exposure to steam begins cellulosic extractions and convections under ordinary atmospheric pressure, quenching, evaporation, condensing, solution purifying electrolysis particle separations, and chemical pH probe. From here due the complexity of the blend agro-fiberaceous materials follows a simple sequence in order of distillation techniques with varying applications of aging oxidation agents, solution oxidations, solution and vacuum pumping extraction, hydraulic fracturing, centrifuge and electrolysis spinning separation, electron molecule positive and negative electrolysis preparations, steam extractions, pH probe, solution spinning and drawing electrolysis, cooling, chopping continuous filament yarn immersion pressing, aging reagents, pH probe, dissolving, filtering, ripening, simple super alloy or highly pure metal covalent compounds Sulfate SO 4 and Methane CH 4 chemical extrusion, electrolysis solution spinning drawing and spinning filaments, wet process and gaseous purification, bleaching with chloride, ultra-violet UV lamps, or Sunlight, dying with pigments, filament yarn washing, cutting, drying, specialized vacuum packing and preservation storage. Number 5. Building Materials preform slurry specification formula non ionic or electrolyte acid, base, or alkyl distillation reservoir specification vacuum processing with or without scientific electrolysis covalent bonding sequence drawing and spinning formula solutions mechanically refined and nanoparticle dispersion fine concrete, mortar, brick, and tiles. Building materials preform modular fine concrete arrives in trucks readymade utilized with manufacture process connector system die cast super alloy or tool steel molten-forged crimping tool heated or cooled particulate matter carbonaceous-polyamide interwoven textile mesh, and molten-forged super alloy or tool steel connectors that work with easy to build box framing techniques, hydraulic cement on-site preform modular casting molds and preform modular fine readymade concrete poured directly from hydraulic and vacuum pumps on readymade truck. Precast or preform modular numeric screened mesh range sizes from fine to superfine concrete sand and fine to ultrafine concrete clinker hydraulic cement designation code specification in series readymade wall, doorway, ceiling, floor, corner end, window frame, fixture, and ornament precast or preform modular hydraulic dispersion formed installation system. Preform modular manufacture process connector system surveying tools and techniques ionic paint markers and alidade Very high frequency VHF and Ultra high frequency UHF industrial/business narrowband 12.5 kHz bandwidth efficiency technology utilizing crystal quartz transceiver transmitting and receiving to crystal quartz transceiver ground mode-C marker Earth Positioning System EPS transmitting and receiving mode-C for construction generator carrier phase L1 and L2 waveform transponder pulse train signals modes 4 four mode-1 convex waveform cycle ˜less than < and equal to carrier narrowband 12.5 kHz bandwidth, mode-2 polynumber waveform cycle ˜ less than < and equal to carrier narrowband 12.5 kHz bandwidth N1, N2, N3, N4, N5, N6, N7, N8, N9, N10, N11 & N12, mode-3 inclination waveform cycle [symbol] less than < and equal to carrier narrowband 12.5 kHz bandwidth and mode-4 declination waveform cycle [symbol] less than < and equal to carrier narrowband 12.5 kHz bandwidth wavenumber data added and subtracted order identification in nanoseconds processing geodetic spatial datum reference Universal Transverse Mercator UTM geographic six-ten digit grid coordinates, distance, azimuth, and level reference identification Cartesian system datum numeric generation returns coordinates in a local east-north-up ENU Cartesian system corresponding to coordinates X, Y, Z in an Earth-Centered Earth-Fixed ECEF spheroid-centric Cartesian system. Ready mix mortar is packaged and distributed in specially made thermoplastic sealed injection molded preformed containers and airtight dispenser system. Specialized construction abatement and miners suit carbonaceous-polyamide textile interwoven mesh push to talk PTT and self-actuating microphone intercommunication system, textile woven rip-stop technique sewn fibers, liners, air tight light makeweight head gear, crystalline silica optical with or without natural polyamide, natural rubber polyamide, allotropes of C6 carbon, alumina al13, synthetic polymers, natural polymers, or natural polymers rubber filtered and non filtered visor, inner layer air pressurized isolated breathable oxygen gaseous mixture supplied by light makeweight textile woven carbonaceous-polyamide, carbonaceous-fiberaceous and composite materials knitted/stitched interwoven textile fabrics, and woven-mesh in X, Y, and Z alignment rip-stop reinforcing technique weaving thick reinforcement threads interwoven at regular intervals in a crosshatch pattern fabrics having thin and light makeweight structure from thick threads being interwoven in a thinner cloth sewn fibers oxygen tank and second inner layer carbon dioxide CO₂ accelerated negative pressurized supercooled system powered by magnesium nanoparticle light makeweight battery cell. Number 6. Specialized construction abatement and miners suit carbonaceous-polyamide textile interwoven mesh push to talk PTT and self-actuating microphone intercommunication system, textile woven carbonaceous-polyamide, carbonaceous-fiberaceous and composite materials knitted/stitched interwoven textile fabrics, and woven-mesh in X, Y, and Z alignment carbonaceous-polyamide, carbonaceous-fiberaceous and composite materials knitted/stitched interwoven textile fabrics, and woven-mesh in X, Y, and Z alignment rip-stop reinforcing technique weaving thick reinforcement threads interwoven at regular intervals in a crosshatch pattern fabrics having thin and light makeweight structure from thick threads being interwoven in a thinner cloth reinforcing technique weaving thick reinforcement threads interwoven at regular intervals in a crosshatch pattern fabrics having thin and light makeweight structure from thick threads being interwoven in a thinner cloth fibers, liners, air tight light makeweight head gear, crystalline silica optical with or without natural polyamide, natural rubber polyamide, allotropes of C6 carbon, alumina al13, synthetic polymers, natural polymers, or natural polymers rubber filtered and non filtered visor, inner layer air pressurized isolated breathable oxygen gaseous mixture supplied by light makeweight textile woven carbonaceous-polyamide, carbonaceous-fiberaceous and composite materials knitted/stitched interwoven textile fabrics, and woven-mesh in X, Y, and Z alignment rip-stop reinforcing technique weaving thick reinforcement threads interwoven at regular intervals in a crosshatch pattern fabrics having thin and light makeweight structure from thick threads being interwoven in a thinner cloth sewn fibers oxygen tank and second inner layer carbon dioxide CO₂ accelerated negative pressurized supercooled system powered by magnesium nanoparticle light makeweight battery cell. Number 7. Supplemental super alloy super cooling refrigeration vacuum pump and super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to less than −109 degrees Fahrenheit or −78.5 degrees Celsius supercooled gaseous refrigerant super cooling super alloy or super alloy. Refrigerant specification of naturally occurring carbon dioxide CO₂ and distillation reservoir specification hybridizations of allotropes of carbon, solution pure oxides O₂, distillation reservoir covalent bonding, electrolysis, and molecular diffusion produce hybrid allotropes of carbon and molecular dioxide C O₂ compound, silica hybrid allotropes of carbon molecular dioxide Si C O₂ compound, chloride hybrid allotropes of carbon C Cl compound, methane Ch4, nitrate hybrid allotropes of carbon N C compound, and hydrogen hybrid allotropes of carbon H C compound. High negative pressurized levels are maintained by vacuum pump circuit. Self contained naturally occurring carbon dioxide CO₂, hybrid allotropes of carbon and molecular dioxide C O₂ compound, methane Ch4, nitrate hybrid allotropes of carbon N C compound, and hydrogen hybrid allotropes of carbon H C compound refrigeration units commercial, residential, or portable super alloy vacuum pump drawing gaseous refrigerant through Insulated super alloy feeder tubes in a parallel circuit to separate super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to less than −109 degrees Fahrenheit or −78.5 degrees Celsius supercooled gaseous refrigerant is then passed over super alloy and through cooling fan. High negative pressurized levels are maintained by vacuum pump circuit. Self contained naturally occurring carbon dioxide CO₂, hybrid allotropes of carbon and molecular dioxide C O₂ compound, methane Ch4, nitrate hybrid allotropes of carbon N C compound, and hydrogen hybrid allotropes of carbon H C compound refrigeration units commercial, residential, or portable super alloy vacuum pump rated alternating current AC or direct current DC drawing gaseous refrigerant through insulated super alloy feeder tubes in a parallel circuit to separate numeric super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to less than −109 degrees Fahrenheit or −78.5 degrees Celsius supercooled gaseous refrigerant passes over super alloy and through cooling fan. Numeric isolated super alloy cylinders in series and parallel thermo conductive circuits are connected to the refrigeration unit from super alloy connecting rods super cooling the outside walls of the cylinders. The outer cylinder cools activating an electronic air compressor rated alternating current AC or direct current DC filling the inner variable cylinders with compressed air providing diffusive compensation expanding or contracting the inner cylinders as fluctuating compensator forcing the carbon dioxide CO₂ filled outer cylinders through a continuous circuit of super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to greater than −109 degrees Fahrenheit or −78.5 degrees Celsius carbon dioxide CO₂ forming dry ice in the outer internal press plate mold and Super alloy, and/or ceramic, and allotropes of carbon, and alternate carbon cylinders. High negative pressurized levels are maintained by vacuum pump circuit. Number 8. Distillation and recovery basin automation mass production variable hydraulic press plate mold Super alloy, and/or ceramic, carbon C6 nanoparticle conductor, and alternate carbon nanoparticle C6 inductor ACNFI filler and adhesive insulator pour aperture located in the center and hydraulic cylinder located on the right expanded and contracted for molten pouring highly pure metal printed circuits and cells, super alloy including allotropes of carbon printed circuits and cells nickel, cadmium, lithium, lead, antimonide, halide, alkalide, Specification 56 elements printed circuits and cells, or Specification 57 alloys printed circuits and cells and/or ceramic insulator for 1.0, and 2.0 phase extrusion plates, sheets, foil, leaf and films central processing Unit CPU processor circuit, generator circuit, transceiver circuit, relay circuit, switch circuit, sensor circuit, electronic part cell circuit, battery cell circuit, electronic part circuit highly pure metals, specification 57 alloys, super alloys, specification 56 elements, beryllium Be4, beryllium Be4 inductor, magnesium Mg12, magnesium Mg12 inductor, copper Cu29 conductor, aluminum al13 conductor, carbon C6 nanoparticle conductor and alternate C6 carbon nanoparticle inductor ACNFI. Electronic storage medium data plates, sheets, foil, leaf, and films or series and parallel circuits, battery cell series and parallel circuits rated conductive, ceramic silica mineral insulator or ceramic alumina silica allotropes of carbon insulator. Distillation and recovery basin automation mass production crucible casted molten highly pure metal printed circuits and cells, super alloy, allotropes of carbon printed circuits and cells nickel, cadmium, lithium, lead, antimonide, halide, alkalide, Specification 56 elements printed circuits and cells, or Specification 57 alloys printed circuits and cells and/or ceramic insulator for 1.0, and 2.0 phase castings plates, sheets, foil, leaf, and films central processing Unit CPU processor circuit, generator circuit, transceiver circuit, relay circuit, switch circuit, sensor circuit, electronic part cell circuit, battery cell circuit, electronic part circuit highly pure metals, specification 57 alloys, super alloys, specification 56 elements, beryllium Be4, beryllium Be4 inductor, magnesium Mg12, magnesium Mg12 inductor, copper Cu29 conductor, aluminum al13 conductor, carbon C6 nanoparticle conductor and alternate C6 carbon nanoparticle inductor ACNFI. Electronic storage medium data plates, sheets, foil, leaf, and films or series and parallel circuits, battery cell series and parallel circuits rated conductive, ceramic silica mineral insulator or ceramic alumina silica allotropes of carbon insulator. Distillation and recovery basin automation mass production variable hydraulic press plate mold Super alloy, and/or ceramic, carbon C6 nanoparticle conductor, and alternate carbon nanoparticle C6 inductor ACNFI filler and adhesive insulator pour aperture located in the center and hydraulic cylinder located on the right expanded and contracted for pouring non ionic or electrolyte preform slurry with mechanically refined and nanoparticle dispersion fine printing highly pure metal printed circuits and cells, allotropes of carbon, alumina nanoparticles, copper nanoparticles, colloidal gold, silver nanoparticles, iron nanoparticles, molecular tool steel, molecular super alloy, element nanoparticles, platinum nanoparticles printed circuits and cells, super alloy including allotropes of carbon printed circuits and cells, allotropes of carbon printed circuits and cells, beryllium Be4 inductor, magnesium Mg12 inductor, carbon C6 nanoparticle conductor, copper Cu29 conductor and alternate carbon nanofoam C6 inductor ACNFI printed circuits and cells, allotropes of carbon ionic suspension element printed circuits and cells nickel, cadmium, lithium, magnesium, lead, antimonide, Specification 56 elements printed circuits and cells, or Specification 57 alloys printed circuits and cells and/or ceramic insulator for 1.0, and 2.0 phase extrusion plates, sheets, foil, leaf, and films central processing Unit CPU processor circuit, generator circuit, transceiver circuit, relay circuit, switch circuit, sensor circuit, electronic part cell circuit, battery cell circuit, electronic part circuit highly pure metals, specification 57 alloys, super alloys, specification 56 elements, beryllium Be4, beryllium Be4 inductor, magnesium Mg12, magnesium Mg12 inductor, copper Cu29 conductor, aluminum al13 conductor, carbon C6 nanoparticle conductor and alternate C6 carbon nanoparticle inductor ACNFI. Electronic storage medium data plates, sheets, foil, leaf, and films or series and parallel circuits, battery cell series and parallel circuits rated conductive, ceramic silica mineral insulator or ceramic alumina silica allotropes of carbon insulator. Distillation and recovery basin automation mass production crucible casted non ionic or electrolyte preform slurry with mechanically refined or nanoparticle dispersion fine printing highly pure metal printed circuits and cells, allotropes of carbon, alumina nanoparticles, copper nanoparticles, colloidal gold, silver nanoparticles, iron nanoparticles, molecular tool steel, molecular super alloy, element nanoparticles, platinum nanoparticles printed circuits and cells, super alloy including allotropes of carbon printed circuits and cells, allotropes of carbon printed circuits and cells, beryllium Be4 inductor, magnesium Mg12 inductor, carbon C6 nanoparticle conductor, copper Cu29 conductor and alternate carbon nanofoam C6 inductor ACNFI printed circuits and cells, allotropes of carbon ionic suspension element printed circuits and cells nickel, cadmium, lithium, magnesium, lead, antimonide, Specification 56 elements printed circuits and cells, or Specification 57 Alloys printed circuits and cells and/or ceramic for 1.0, and 2.0 phase castings plates, sheets, foil, leaf, and films central processing Unit CPU processor circuit, generator circuit, transceiver circuit, relay circuit, switch circuit, sensor circuit, electronic part cell circuit, battery cell circuit, electronic part circuit highly pure metals, specification 57 alloys, super alloys, specification 56 elements, beryllium Be4, beryllium Be4 inductor, magnesium Mg12, magnesium Mg12 inductor, copper Cu29 conductor, aluminum al13 conductor, carbon C6 nanoparticle conductor and alternate C6 carbon nanoparticle inductor ACNFI. Electronic storage medium data plates, sheets, foil, leaf, and films or series and parallel circuits, battery cell series and parallel circuits rated conductive, ceramic silica mineral insulator or ceramic alumina silica allotropes of carbon insulator. Distillation reservoir interchangeable combinations of preform slurry non ionic, electrolyte, or molten ceramic and conductive circuits 2.0 extrusions or castings are accomplished for each specification part. Specification of molten diffusion particulate matter PM melts carbonaceous-polyamide, crystalline silica optical, crystalline silica synthetic polymer optical, crystalline silica cellulosic natural polymer, and crystalline silica cellulosic rubber natural polymer optical filtered and non filtered specifications condensation-nuclei type size particles measure in microns Symbol μ lower-case letter mu metric SI equivalent crystalline silica optical, crystalline silica synthetic polymer optical, crystalline silica cellulosic natural polymer, and crystalline silica cellulosic rubber natural polymer optical added molten diffusive particulate matter PM filtered condensation-nuclei type size particles measure in microns Symbol μ lower-case letter mu metric SI equivalent filtered versions of crystalline silica optical, crystalline silica synthetic polymer optical, crystalline silica cellulosic natural polymer, and crystalline silica cellulosic rubber natural polymer optical are filtered alumina, filtered nano alumina, filtered naturally occurring carbon, filtered allotropes of—alternate carbon nanotube inductor and infrared spectrum light analogous identification, filtered radioactive radiation protection precious metals, and filtered Specification 56 Elements spectrum. Number 9. Specification of molten diffusion particulate matter PM melts carbonaceous-polyamide, crystalline silica optical, crystalline silica synthetic polymer optical, crystalline silica cellulosic natural polymer, and crystalline silica cellulosic rubber natural polymer optical filtered and non filtered specifications condensation-nuclei type size particles measure in microns Symbol μ lower-case letter mu metric SI equivalent crystalline silica optical, crystalline silica synthetic polymer optical, crystalline silica cellulosic natural polymer, and crystalline silica cellulosic rubber natural polymer optical added molten diffusive particulate matter PM filtered condensation-nuclei type size particles measure in microns Symbol μ lower-case letter mu metric SI equivalent filtered versions of crystalline silica optical, crystalline silica synthetic polymer optical, crystalline silica cellulosic natural polymer, and crystalline silica cellulosic rubber natural polymer optical are filtered alumina, filtered nano alumina, filtered naturally occurring carbon, filtered allotropes of—alternate carbon nanotube inductor and infrared spectrum light analogous identification, filtered radioactive radiation protection precious metals, and filtered Specification 56 Elements spectrum. Number 10. Manufacture process of 1.0 to 2.5 phase extrusions die cast molding for precision casting of highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina all 3, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields and optical No₃-diamond dust mineralization transceiver alignment integrated, polarized casted and molten diffusion forged reflective beads translucent, blue, white, purple, yellow, red, green and orange-red radiate outwards up to and greater than 400 percent magnification for aircraft and airway systems, beryllium Be4 inductor, magnesium Mg12 inductor, carbon C6 nanoparticle conductor, copper Cu29 conductor and alternate carbon nanofoam C6 inductor ACNFI filler and adhesive insulator. The precision casting of highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields and optical No₃-diamond dust mineralization transceiver alignment integrated, polarized casted and molten diffusion forged reflective beads translucent, blue, white, purple, yellow, red, green and orange-red radiate outwards up to and greater than 400 percent magnification for aircraft and airway systems, beryllium Be4 inductor, magnesium Mg12 inductor, carbon C6 nanoparticle conductor, copper Cu29 conductor and alternate carbon nanofoam C6 inductor ACNFI filler and adhesive insulator is a layered greater than 0% to less than 100% precision casting of highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields and optical No₃-diamond dust mineralization transceiver alignment integrated, polarized casted and molten diffusion forged reflective beads translucent, blue, white, purple, yellow, red, green and orange-red radiate outwards up to and greater than 400 percent magnification for aircraft and airway systems, beryllium Be4 inductor, magnesium Mg12 inductor, carbon C6 nanoparticle conductor, copper Cu29 conductor and alternate carbon nanofoam C6 inductor ACNFI filler and adhesive insulator and greater than 0% to less than 100% other precision casting of highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields and optical No₃-diamond dust mineralization transceiver alignment integrated, polarized casted and molten diffusion forged reflective beads translucent, blue, white, purple, yellow, red, green and orange-red radiate outwards up to and greater than 400 percent magnification for aircraft and airway systems, beryllium Be4 inductor, magnesium Mg12 inductor, carbon C6 nanoparticle conductor, copper Cu29 conductor and alternate carbon nanofoam C6 inductor ACNFI filler and adhesive insulator part that is created by pouring molten metal, alloy, halide, alkalide, antimonide, ceramic, glass, acid solid, alkaline, synthetic polymer, non molten formula ceramic slip, acid solid, alkaline, and preform slurry non ionic or electrolyte allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator into a cast mold over a process of 1.0 to 2.5 phase extrusions that create two to six molded casts for each designed master tool steel part that is manually machined and manufactured named part X external layer highly pure metal, super alloy, halide, alkalide, antimonide, ceramic, glass, acid solid, alkaline, synthetic polymer, including preform slurry non ionic or electrolyte allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator and Part Z the internal layer other highly pure metal, super alloy, halide, alkalide, antimonide, ceramic, glass, synthetic polymer, acid solid, alkaline, including preform slurry non ionic or electrolyte allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator. Manufactured process of 1.0 to 2.5 phase extrusions die cast molding for precision casting of super alloy, ceramic, and material ultimately create a single part identical to the master designed and machine manufactured part with the exception to the chemical element is now a super alloy, super alloy ceramic, or super material that may be layered greater than 0% to less than 100% highly pure metal, super alloy, super material, including allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator and greater than 0% to less than 100% other highly pure metal, super alloy, super material including allotropes of carbon, and beryllium Be4 inductor, magnesium Mg12 inductor, carbon C6 nanoparticle conductor, copper Cu29 conductor and alternate carbon nanofoam C6 inductor ACNFI filler and adhesive insulator. Processing molded halves sequence 1 to 9 of manufacture process 1.0 to 2.5 phase extrusions die cast molding for precision casting of highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields and optical No₃-diamond dust mineralization transceiver alignment integrated, polarized casted and molten diffusion forged reflective beads translucent, blue, white, purple, yellow, red, green and orange-red radiate outwards up to and greater than 400 percent magnification for aircraft and airway systems, beryllium Be4 inductor, magnesium Mg12 inductor, carbon C6 nanoparticle conductor, copper Cu29 conductor and alternate carbon nanofoam C6 inductor ACNFI filler and adhesive insulator part X and part Z side profile not shown here of casting for part X two halves sequence 1, side profile not shown here of casting for part Z two halves sequence 2, side profile not shown here of casting for part Z extruded halves sequence 3, cast 1 half of part X sequence 4, cast 3 half of part Z sequence 5, extruded cast 5 half of part Z sequence 6, side profile not shown here of cast 5 on top cast 1 on bottom sequence 7, side profile not shown here of cast 6 on top and cast two on bottom sequence 8, fill halves joined in cast 1 and 2 filled with molten on non molten formula materials including preform slurry non ionic or electrolyte allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator sequence 9. The manufacture process begins by a designed and machined manufactured master part named part X. The master part X is used to create two external cast halves. This is accomplished by casting the master part X into the center of two ceramic molded halves with newly poured ceramic slip. After the ceramic slip dries the master part X is removed and the two ceramic molded halves are ignited and cured in a furnace. The second master part named part Z is designed and machined manufactured greater than 0% to less than 100% less than tolerances that of the master part X or the external cast halves. Again, the master part Z is used to create two internal cast halves. This is accomplished by casting the master part Z into the center of two ceramic molded halves with newly poured ceramic slip. After the ceramic cast dries the master part Z is removed and the two ceramic molded halves are ignited and cured in a furnace. After the two ceramic cast halves cool they are used separately to make two reciprocal extrusion halves by again pouring ceramic slip into the recesses and joining both halves with new cast covers to dry. The external tolerances of all of the four cast covers X and Z are identical opposing so that X and Z halves can be joined and prepared for two separate halves molten or non molten formula highly pure metal, super alloy, or material including allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator fills. After the poured molten highly pure metal, super alloy, or materials including allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator cools or cures then both extruded halves are removed and stored. The remainder halves with highly pure metal, super alloy, or materials including allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator are then joined and prepared for a second molten fill of greater than 0% to less than 100% highly pure metal, super alloy, or materials including allotropes of carbon, or beryllium Be4 inductor, magnesium Mg12 inductor, carbon C6 nanoparticle conductor, copper Cu29 conductor and alternate carbon nanofoam C6 inductor ACNFI filler and adhesive insulator. After the fill is cooled the whole part is removed from the cast halves and may be inspected, deburred, and/or finished. Number 11. Utility patent application specification concrete control room and monitoring station manufacturing in a complete vacuum area less than atmospheric gaseous and gases produced or added comprise the partial vacuum and may supply rich oxygen from capillary feeders at varying points to utility patent application specification for with die cast mold extrusion or printing hot smelters casting manufacturing of specified highly pure metal, super alloy, halide, alkalide, antimonide, ceramic, acid solid, alkaline, integrated or polarized molten diffusion forged crystalline silica optical with or without natural polyamide, natural rubber polyamide, allotropes of C6 carbon, alumina al13, synthetic polymers, natural polymers, or natural polymers rubber filtered and non filtered beads, gels, cables, lenses, glasses, up to or greater >1.25 inch left to right vertical and horizontal picture resolution integrated and polarized photogray, photocolor and photochemical light filtered light identification photo chemically active electron molecule film mirrors, visors, panels, and windshields, spectra No₃-diamond dust mineralization transceiver integrated or polarized beads, beryllium Be4 inductor, magnesium Mg12 inductor, carbon C6 nanoparticle conductor, copper Cu29 conductor and alternate carbon nanofoam C6 inductor ACNFI filler and adhesive insulator including two to six master extrusion halves 1.0 to 2.5 phase extrusions per specification part molten foundry fill up to four pours and the manufacture process or assembly for each specification component or part thereof and all waste gases are processed to flu gas detoxification system. Utility patent application specification concrete control room and monitoring station manufacturing in a complete vacuum area less than atmospheric gaseous and gases produced or added comprise the partial vacuum and may supply rich oxygen from capillary feeders at varying points to utility patent application specification manufacturing of highly pure metal, super alloy, carbon, ceramics, acid solid, alkaline, glass, acrylic, synthetic polymer, halide, alkalide, nonconductive zirconia, allotropes of carbon, beryllium Be4 inductor, magnesium Mg12 inductor, carbon C6 nanoparticle conductor, copper Cu29 conductor, alternate carbon nanofoam C6 inductor ACNFI and impedance matching load or signal ceramic red brick clay insulator hot pouring casting printing with molten foundry fill of die cast mold precision casting of bars, rods, plates, sheets, foil, leaf, alumina, copper, wire, annealing, drawing, and spun coils and windings for electronic component, highly pure metal, super alloy drawing, annealing, and spinning process for wire, spun cable, interwoven rebar mesh with or without interwoven textile mesh heated or supercooled particulate matter synthetic and polymer resins carbonaceous-polyamide unit of measurement in gage manufacture process connector system super alloy die cast tool steel molten-forged crimping tool that works with molten-forged mesh connectors. Other construction tools include powders nitrate hardened nitride steel grit unit of measurement in mesh or grit size. Utility patent application specification concrete control room and monitoring station manufacturing in a complete vacuum area less than atmospheric gaseous and gases produced or added comprise the partial vacuum and may supply rich oxygen from capillary feeders at varying points to utility patent application specification 1.0 to 2.5 phase extrusions manufacturing of highly pure metal or super alloy precision casting of airframe, bearings, and assemblies, motor casings, aircraft landing gear, turbine blades, assemblies, and housings parts may be sprayed and dipped non conductive adhesives insulator films and all waste gases are processed to flu gas detoxification system. Utility patent application specification concrete control room and monitoring station manufacturing in a complete vacuum area less than atmospheric gaseous and gases produced or added comprise the partial vacuum and may supply rich oxygen from capillary feeders at varying points to highly pure metal copper pre and post foundry mechanically refined copper ore anticorrosive treatment chemical submersion bath sodium, tolyltriazole, and methyl, benziotriole flake and prill washing and screening tables and chemical submersion bath techniques are utilized and in manufacturing of highly pure other metals mechanically refined ore iron, molybdenum, aluminum, zinc, zirconium, titanium, tungsten, or metal pre and post foundry anticorrosive treatment chemical submersion bath hydrochloric acid, ammonia from nitrogen, and hydrogen anticorrosive purification treatment and all waste gases are processed to flu gas detoxification system. Utility patent application specification concrete control room and monitoring station manufacturing in a complete vacuum area less than atmospheric gaseous and gases produced or added comprise the partial vacuum and may supply rich oxygen from capillary feeders at varying points to mechanically refined metal ore sintered and smeltered non metallic additive allotropes of carbon alloyed super alloy, steel super carbon steel, tungsten super carbon tungsten, or additive sintered and smeltered molybdenum for homogenization steel molybdenum steel, or tungsten molybdenum tungsten and all waste gases are processed to flu gas detoxification system. Number 12. Utility patent application specification manufacturing of highly pure metal, super alloy, carbon, ceramics, acid solid, alkaline, glass, acrylic, synthetic polymer, halide, alkalide, nonconductive zirconia, allotropes of carbon, beryllium Be4 inductor, magnesium Mg12 inductor, carbon C6 nanoparticle conductor, copper Cu29 conductor, alternate carbon nanofoam C6 inductor ACNFI and impedance matching load or signal ceramic red brick clay insulator 1.0 to 2.5 phase extrusions or half shell casted composite coils beryllium Be4, magnesium Mg12, copper Cu29 and carbon nanofoam C6, spun wound windings beryllium Be4, magnesium Mg12, copper Cu29 and carbon nanofoam C6 annealing, drawn, spun, coils, windings, wire, woven textile mesh, shielding, brushes, inductors, antinode couplers, electric rheostats, starters, motors, alternators, generators, ionic suspension element enhanced composite coils, composite windings, spun wound coils beryllium Be4, magnesium Mg12, copper Cu29 and carbon nanofoam C6, spun wound windings beryllium Be4, magnesium Mg12, copper Cu29 and carbon nanofoam C6 annealing, drawn, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts highly pure metal, super alloy, acid solid, alkaline, glass, acrylic, synthetic polymer, halide, alkalide, nonconductive zirconia, impedance matching load or signal ceramic red brick clay insulator, allotropes of carbon, or beryllium Be4 inductor, magnesium Mg12 inductor, carbon C6 nanoparticle conductor, copper Cu29 conductor and alternate carbon nanofoam C6 inductor ACNFI six sides rectangle, or square, or three sides continuous rod or cylinder highly pure metal, super alloy, acid solid, alkaline, glass, acrylic, synthetic polymer, halide, alkalide, non conductive zirconia, impedance matching load or signal ceramic red brick clay insulator, allotropes of carbon, or beryllium Be4 inductor, magnesium Mg12 inductor, carbon C6 nanoparticle conductor, copper Cu29 conductor and alternate carbon nanofoam C6 inductor ACNFI, or three sides zircon, nitrate zircon, and nitrate silica with or without molecular reinforcements nanoparticle alumina and allotropes of carbon cutting tools, or two sides continuous for drill bits half shell casted tools measured in gage. Number 13. Utility patent application specification concrete control room and monitoring station manufacturing in a complete vacuum area less than atmospheric gaseous and gases produced or added comprise the partial vacuum and may supply rich oxygen from capillary feeders at varying points to utility patent application specification manufacturing of highly pure metal, super alloy, carbon, ceramics, acid solid, alkaline, glass, acrylic, synthetic polymer, halide, alkalide, nonconductive zirconia, allotropes of carbon, beryllium Be4 inductor, magnesium Mg12 inductor, carbon C6 nanoparticle conductor, copper Cu29 conductor, alternate carbon nanofoam C6 inductor ACNFI and impedance matching load or signal ceramic red brick clay insulator hot pouring casting printing with molten foundry fill of die cast mold precision casting of bars, rods, plates, sheets, foil, leaf, alumina, copper, wire, annealing, drawing, and spun coils and windings for electronic component, highly pure metal, super alloy drawing, annealing, and spinning process for wire, spun cable, interwoven rebar mesh with or without interwoven textile mesh heated or supercooled particulate matter synthetic and polymer resins carbonaceous-polyamide unit of measurement in gage manufacture process connector system super alloy die cast tool steel molten-forged crimping tool that works with molten-forged mesh connectors. Other construction tools include powders nitrate hardened nitride steel grit unit of measurement in mesh or grit size. Utility patent application specification manufacture process of replacement ceramic precision casting molds specification number 36 for with manufacturing highly pure metal, super alloy, acid solid, alkaline, glass, acrylic, synthetic polymer, halide, alkalide, nonconductive zirconia, impedance matching load or signal ceramic red brick clay insulator, allotropes of carbon, or beryllium Be4 inductor, magnesium Mg12 inductor, carbon C6 nanoparticle conductor, copper Cu29 conductor and alternate carbon nanofoam C6 inductor ACNFI. Differential pressurization molten melts extrusion or supercritical gaseous suspension particulate matter are drawn into heated chamber flash forming vapour melts molten diffusion specific material density, temperature and pressure controlled by scientific specification hydraulic automation central processing unit CPU server L1 L2 processor server hydroelectric scientific distillation hydraulic variable press plate extruding, forging, molding, casting, rod and plate casted released dropped rods drawn, annealing, spinning, rolled-wound wire, wound and wrapped coils, wound and wrapped windings, wound flat strips, woven and interwoven shielding and mesh are conductive liquid metal solder plated submersion or sprayed C 6 carbon nanoparticle, cesium, chromate, silver, gold, platinum, titanium, tungsten, niobium, manganese, steel, tin, beryllium, copper, aluminum, gallium, nickel, cadmium, zinc, potassium, magnesium, lithium, indium, salts, sulfosalts, sulfides, antimonide, halide, alkalide, acid complex, nitronium, anodize, galvanize, and benzotriazole, methyl, tolyltriazole, sodium under normal atmospheric pressure liquid metal alloy and/or carbon nanoparticle C 6 alloy drawn, rolled, wound, mechanical spinning. Particulate matter mechanical spinning unrolled and rolled synthetic and/or fiber insulate non conductive wire, strips and shielding are conductive liquid metal solder plated.

2. Electronic parts utility patent application specification manufacture process of preform slurry non ionic or electrolyte mechanically refined and nanoparticle dispersion allotropes of carbon with or without ionic suspension element Specification 56 elements or Specification 57 alloys extrusion or casted highly pure metal, super alloy, allotropes of carbon with or without ionic suspension element Specification 56 elements, Specification 57 alloys, and alkaline, halide, antimonide, or alkalide, nonconductive zirconia, and impedance matching load or signal ceramic red brick clay insulator casted electronic part equivalent to one composite coil, composite winding, battery cell, capacitor, and brush one, or more gradated in even intervals of electric rheostat, battery, starter, motor, alternator, generator, transformer, transducer, rectifier, power supply, junction box, or heat sink series and parallel circuits two positive and negative terminal poles commonly copper alloy measured in Volts, or of preform slurry non ionic or electrolyte beryllium Be4 inductor, magnesium Mg12 inductor, carbon C6 nanoparticle conductor, copper Cu29 conductor and alternate carbon nanofoam C6 inductor ACNFI extrusion, or casted highly pure metal, super alloy, beryllium Be4 inductor, magnesium Mg12 inductor, carbon C6 nanoparticle conductor, copper Cu29 conductor and alternate carbon nanofoam C6 inductor ACNFI, nonconductive zirconia, and impedance matching load or signal ceramic red brick clay insulator electronic part equivalent to one resistor, sensor, switch, relay, or electronic part inductor, antinode coupler, and ground series and parallel circuits two negative terminal poles commonly copper alloy measure in Ohms of inductor, antinode coupler, and ground or two positive and negative terminal poles commonly copper alloy measured in Volts. All electronic parts two sides casted conductive plate, sheet, foil, or leaf highly pure metal, super alloy, halide, antimonide, or alkalide rectangle, square, continuous rod or cylinder. Rectangle or square six sides, five sides nonconductive zirconia, impedance matching load or signal ceramic red brick clay insulator, allotropes of carbon, or beryllium Be4 inductor, magnesium Mg12 inductor, carbon C6 nanoparticle conductor, copper Cu29 conductor and alternate carbon nanofoam C6 inductor ACNFI, plate, sheet, foil, or leaf casted insulated, and one side layered or non layered conductive highly pure metal, super alloy, and/or alkaline, halide, antimonide, or alkalide, plate, sheet, foil, or leaf casted conductive, or four sides nonconductive zirconia, impedance matching load or signal ceramic red brick clay insulator, allotropes of carbon, or beryllium Be4 inductor, magnesium Mg12 inductor, carbon C6 nanoparticle conductor, copper Cu29 conductor and alternate carbon nanofoam C6 inductor ACNFI casted plate, sheet, foil, or leaf insulated, and two conductive highly pure metal, super alloy, and/or alkaline, halide, antimonide, or alkalide, plate, sheet, foil, or leaf casted series and parallel circuits and two positive and negative terminal poles commonly copper alloy measured in Volts or two negative terminal poles commonly copper alloy measured in Ohms to antinode coupler, or continuous rod or cylinder three sides, one continuous side nonconductive zirconia, impedance matching load or signal ceramic red brick clay insulator, allotropes of carbon, or beryllium Be4 inductor, magnesium Mg12 inductor, carbon C6 nanoparticle conductor, copper Cu29 conductor and alternate carbon nanofoam C6 inductor ACNFI, plate, sheet, foil, or leaf casted insulated, and two sides conductive highly pure metal, super alloy, and/or alkaline, halide, antimonide, or alkalide, plate, sheet, foil, or leaf casted series and parallel circuits and two positive and negative terminal poles commonly copper alloy measured in Volts or two negative terminal poles commonly copper alloy measured in Ohms to antinode coupler preform slurry non ionic or electrolyte casted ionic suspension element allotropes of carbon battery cell outstanding one or two sides plate, sheet, foil, or leaf casted conductive highly pure metal, super alloy, halide, antimonide, or alkalide series and parallel circuits and two positive and negative terminal poles commonly copper alloy measured in Volts or two negative terminal poles commonly copper alloy measured in Ohms to antinode coupler or electronic parts requires one, or two, or more brushes in even intervals and two or more inductors and antinode couplers with one or two sides conductive plate, sheet, foil, or leaf casted highly pure metal, super alloy, halide, antimonide, or alkalide series and parallel circuits and two positive and negative terminal poles commonly copper alloy measured in Volts or two negative terminal poles commonly copper alloy measured in Ohms to antinode coupler. Number 14. An insulate, electronic part, brake calipers part, rotors part, brake pads, washers, spacers, shims, dowels, bushings part light weight chemical non ionic groups of amphoteric polysaccharide linear or branched alkyl compounds usually methyl continuous sheets cut films insulate, variable hydraulic press, plate or distillation reservoir liquid dispersion specifications of condensation-nuclei type size particles measure in microns Symbol μ lower-case letter mu metric SI equivalent silica, allotropes of carbon silica and alumina/nano alumina silica allotropes of carbon slurry non ionic heated or chilled interface 8—Slurry non ionic tool steel line in liquid dispersion heated or chilled chemical ionic acid usually an amino acid, non ionic bases usually nitrogen/hydrogen or non ionic groups of amphoteric polysaccharide linear or branched alkyl compounds usually methyl liquid dispersion heated chemical non ionic groups of amphoteric polysaccharide linear or branched alkyl compounds methyl liquid dispersion Silica, and allotropes of carbon alumina/nano alumina or liquid dispersion chilled polysaccharide linear or branched alkyl compounds and reinforcement of allotropes of carbon networks in suspension drying over usually fifteen minutes result network light weight Silica allotropes of carbon and/or alumina/nano alumina controllable, high purity, connectivity, strength, conductivity, and shape. Number 15. Battery crucible casted or 1.0 to 2.5 phase extrusions highly pure metal or super alloy battery cells layered, spaced and casted conductive in series and parallel circuits even or odd interval number combinations varying complex, battery cells highly pure acid solid chemical and/or highly pure chemical alkali solid complex, crucible casted conductive or 1.0 to 2.5 phase extrusions highly pure metal or super alloy layered and interval spaced conductive in series and parallel circuits. Distillation reservoir specification manufactured all conservation of energy law insulated lightweight battery cold cell Group 17 the halogens, antimony Sb, Polysaccharide And ionic suspension electrolyte Phosphate Sodium carbon C 6 P 3 S 3 Na 3 particulate matter including Salts, Sulfosalts and Sulfides condensation metal, Hexafluorophosphate carbon C 6 PF 6 particulate matter condensation metal, Nitronium carbon C 6 NC 4 particulate matter condensation metal, Hydrogen chloride carbon C 6HCl particulate matter condensation metal, Phosphorus chlorides carbon C 6 PCl3, POCl3 and PCl5 particulate matter condensation metal, Phosphorus pentachloride carbon C 6 P4O10 particulate matter condensation metal, Nitronium chloride carbon C 6 PCl 3 2 NO2Cl particulate matter condensation metal, Chloride carbon C 6 Cl 4 particulate matter condensation metal, Hydrocarbon C 6 HC 4 particulate matter condensation metal, Methane carbon C 6 CH 4 particulate matter condensation metal, Ammonia carbon C 6 NH 3 particulate matter condensation metal, Sulfuric acid carbon C 6 H2SO 4 particulate matter condensation metal and/or ceramic alkali and clay And Sodium potassium carbon C 6 Na K particulate matter condensation metal with or without ionic suspension element beryllium Be4 inductor, magnesium Mg12 inductor, carbon C6 nanoparticle conductor, copper Cu29 conductor and alternate carbon nanofoam C6 inductor ACNFI, nanoparticle alumina, alumina, and ionic suspension element Specification 56 highly pure metals or ionic suspension element Specification 57 super alloys. Battery crucible casted conductive or 1.0 to 2.5 phase extrusions highly pure metal or super alloy layered, and interval spaced series and parallel circuits and/or complex, continuous sheets cut films insulate, crucible casted conductive or 1.0 to 2.5 phase extrusions variable hydraulic preform slurry non ionic silicate alumina allotropes of carbon dispersion high wear-heat compression resistant light weight battery cells. Highly pure alkali silica, alumina, nanoparticle alumina, or elements lithium, cadmium, nickel, lead, copper, Specification 56 elements or Specification 57 alloys. One by one each battery cell crucible casted non conductive or submersion bath synthetic polymer sealed control room vacuum protocol manufacture process. Motor frame protected by synthetic woven textile fiber, silica fiber high heat-resistant insulator shielding, continuous sheets cut films insulate, preform slurry non ionic silicate allotropes of carbon dispersion high wear-heat compression resistant light weight insulator, and/or or high tensile strength super alloy woven textile shielding. One by one each battery cell crucible casted or submersion bath synthetic polymer sealed control room vacuum protocol manufacture process. All four conductive or non conductive heat-wear high tensile strength and compression resistant insulators made in light makeweight monocombe design series 2 π radians or one full turn and right angles corrugated compartmented techniques composite combinations thermoplastic sealed, layered or woven shielded. Number 16. Motor crucible casted or 1.0 to 2.5 phase extrusions highly pure metal or super alloy composite coils beryllium Be4, magnesium Mg12, copper Cu29 and carbon nanofoam C6, spun wound windings beryllium Be4, magnesium Mg12, copper Cu29 and carbon nanofoam C6, and alumina, copper, wire annealing, drawing, and spun coils, highly pure metal, super alloy drawing and annealing process for wire. Motor composite coils beryllium Be4, magnesium Mg12, copper Cu29 and carbon nanofoam C6, spun wound windings beryllium Be4, magnesium Mg12, copper Cu29 and carbon nanofoam C6 commonly copper or super alloy include continuous or numeric interval mechanical advantage spools series and parallel conversion order shapes of rod, cylinder, sphere, rectangle, or square crucible casted or 1.0 to 2.5 phase extrusions. Motor electronic components brushes allotropes of carbon with or without ionic suspension elements each brush alternate carbon nanofoam inductors, and antinode coupler continuous or numeric alternating current AC electronic load supply ramps positive and negative terminal measured in Volts and monitors positive and negative terminal measured in Volts and negative and negative terminal poles commonly copper alloy measure in Ohms of inductor, antinode coupler, and ground series and parallel circuits. Spun numeric wrapped super alloy copper wire are synthetic polymer dipped or protected synthetic woven fibers, silica woven fibers, or high tensile strength super alloy allotropes of carbon shielding. Motor frame protected by synthetic woven textile fiber, silica fiber high heat-resistant insulator shielding, continuous sheets cut films insulate, preform slurry non ionic silicate allotropes of carbon dispersion high wear-heat compression resistant light weight insulator, and/or or high tensile strength super alloy woven textile shielding. One by one all composite or wire motor coils and windings are crucible casted or submersion bath synthetic polymer sealed control room vacuum protocol manufacture process. Three heat-wear high tensile strength, continuous sheets cut films insulate and variable hydraulic preform slurry non ionic silicate allotropes of carbon dispersion high wear-heat compression resistant light weight insulators made Series of right angles 2 π radians or one full turn the sum of the exterior angles form convex regular polygons corrugated and compartmented light makeweight fabrication monocombe shapes of triangle, square, pentagon, hexagon, heptagon, octagon, nonagon, polynumber and planess and right angle combinations light makeweight design. Crucible casted or 1.0 to 2.5 phase extrusions motor rods, bearings, casings, housings, and assemblies are manufactured and assembled.

3. One and two or more star systems order of the universe or well-lit source radiate light onto parallel 1-optical glass lens and 2-lightweight universal spectra camera and monitor panel shell numeric horizontal and vertical sectors receiving light of added and subtracted magnification and telescopic lenses travelling to scientific mirrors reflecting light onto ˜1.25-inch analogous scanning photo chemical electron molecule film and 2-numeric horizontal and vertical sectors ˜10 inch lightweight universal spectra camera and monitor linearized panel shell integrated or polarized alignment numeric optical lenses, glass beads, and polymer gels form scientific optical light reception and identification receiving emissions of light added and subtracted magnification and telescopic lenses transposed onto analogous scanning photo chemical electron molecule enriched conductive allotropes of carbon, alumina nanoparticles, copper nanoparticles, colloidal gold, silver nanoparticles, iron nanoparticles, molecular tool steel, molecular super alloy, element nanoparticles, platinum nanoparticles series and parallel circuit film element and complex element acid, base, alkyl, ionic and non ionic film enriched conductive acid, base, alkyl, ionic and non ionic, element and enriched complex element Liquids of condensation paste, gel or vapour suspended cells occupying vertical and horizontal segments equal to photo graphic picture resolution. Numeric molecular photovoltaic reception cell and circuit chlorophyll A ionic or anionic electron valences particle parts 1+part and/or 1−part highly pure electron molecule enrichment, chlorophyll B ionic or anionic electron valences particle parts 1+part and/or 1−part highly pure electron molecule enrichment, chlorophyll A complex ionic or anionic electron valences particle parts 1+part and/or 1−part highly pure electron molecule enrichment and chlorophyll B complex ionic or anionic electron valences particle parts 1+part and/or 1−part highly pure electron molecule enrichment. Chlorophyll positive or negative parts are specification element paste, gel, liquid, vapour or gaseous suspended in comparative series and/or parallel circuit cell receptors centers and/or delineations fabricated in polynumber and planes, trifocal, trigonal and linear 1-molar, 2-planar, 3-declination, 4-inclination, 5-convex, and 6-All-star system transform-noise molecular geometry. Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy identification key tone in resonant wavelength frequency atomic orbital as a mathematical function order of spheroid-centric cell parts receptors centers and/or delineations fabricated in polynumber and planes, trifocal, trigonal and linear 1-molar, 2-planar, 3-declination, 4-inclination, 5-convex, and 6-All-star system transform-noise molecular geometry of one to three electrons in an atom involving d, s and/or p orbitals polynumber and planes, linear σ and/or π 3.1415926535897932384626433832795 bonds series and/or parallel circuit and terminals greater than > or less than <Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal and/or Vertical−Horizontal from Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy data streamidentification key tone in resonant wavelength frequency order of spheroid-centric cell and photovoltaic film series and/or parallel circuit data stream reception and signal wavelength frequency emission. Numeric molecular photovoltaic reception cell and circuit chlorophyll A ionic or anionic charged electron valences particle parts 1+part and/or 1−part highly pure electron molecule enrichment, chlorophyll B ionic or anionic charged electron valences particle parts 1+part and/or 1−part highly pure electron molecule enrichment, chlorophyll A complex ionic or anionic charged electron valences particle parts 1+part and/or 1−part highly pure electron molecule enrichment and chlorophyll B complex ionic or anionic charged electron valences particle parts 1+part and/or 1′−part highly pure electron molecule enrichment. Chlorophyll positive or negative parts are specification element paste, gel, liquid, vapour or gaseous suspended in comparative series and/or parallel circuit cell receptors centers and/or delineations fabricated in polynumber and planes, trifocal, trigonal and linear 1-molar, 2-planar, 3-declination, 4-inclination, 5-convex, and 6-All-star system transform-noise molecular geometry. Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy identification key tone in resonant wavelength frequency atomic orbital as a mathematical function order of spheroid-centric cell parts receptors centers and/or delineations fabricated in polynumber and planes, trifocal, trigonal and linear 1-molar, 2-planar, 3-declination, 4-inclination, 5-convex, and 6-All-star system transform-noise molecular geometry of one to three electrons in an atom involving d, s and/or p orbitals polynumber and planes, linear σ and/or π 3.1415926535897932384626433832795 bonds series and/or parallel circuit and terminals greater than > or less than <Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal and/or Vertical−Horizontal from Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy data streamidentification key tone in resonant wavelength frequency order of spheroid-centric cell and photovoltaic film series and/or parallel circuit data stream reception and signal wavelength frequency emission. Numeric molecular photovoltaic reception cell and circuit acid A ionic or anionic electron valences particle parts 1+part and/or 1−part highly pure electron molecule enrichment, acid B ionic or anionic electron valences particle parts 1+part and/or 1−part highly pure electron molecule enrichment, acid A complex ionic or anionic electron valences particle parts 1+part and/or 1−part highly pure electron molecule enrichment and acid B complex ionic or anionic electron valences particle parts 1+part and/or 1−part highly pure electron molecule enrichment. Acid positive or negative parts are specification element paste, gel, liquid, vapour or gaseous suspended in comparative series and/or parallel circuit cell receptors centers and/or delineations fabricated in polynumber and planes, trifocal, trigonal and linear 1-molar, 2-planar, 3-declination, 4-inclination, 5-convex, and 6-All-star system transform-noise molecular geometry. Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy identification key tone in resonant wavelength frequency atomic orbital as a mathematical function order of spheroid-centric cell parts receptors centers and/or delineations fabricated in polynumber and planes, trifocal, trigonal and linear 1-molar, 2-planar, 3-declination, 4-inclination, 5-convex, and 6-All-star system transform-noise molecular geometry of one to three electrons in an atom involving d, s and/or p orbitals polynumber and planes, linear σ and/or π 3.1415926535897932384626433832795 bonds series and/or parallel circuit and terminals greater than > or less than <Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal and/or Vertical−Horizontal from Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy data stream identification key tone in resonant wavelength frequency order of spheroid-centric cell and photovoltaic film series and/or parallel circuit data stream reception and signal wavelength frequency emission. Numeric molecular photovoltaic reception cell and circuit base A ionic or anionic electron valences particle parts 1+part and/or 1−part highly pure electron molecule enrichment, base B ionic or anionic electron valences particle parts 1+part and/or 1−part highly pure electron molecule enrichment, base A complex ionic or anionic electron valences particle parts 1+part and/or 1−part highly pure electron molecule enrichment and base B complex ionic or anionic electron valences particle parts 1+part and/or 1−part highly pure electron molecule enrichment. Base positive or negative parts are specification element paste, gel, liquid, vapour or gaseous suspended in comparative series and/or parallel circuit cell receptors centers and/or delineations fabricated in polynumber and planes, trifocal, trigonal and linear 1-molar, 2-planar, 3-declination, 4-inclination, 5-convex, and 6-All-star system transform-noise molecular geometry. Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy identification key tone in resonant wavelength frequency atomic orbital as a mathematical function order of spheroid-centric cell parts receptors centers and/or delineations fabricated in polynumber and planes, trifocal, trigonal and linear 1-molar, 2-planar, 3-declination, 4-inclination, 5-convex, and 6-All-star system transform-noise molecular geometry of one to three electrons in an atom involving d, s and/or p orbitals polynumber and planes, linear σ and/or π 3.1415926535897932384626433832795 bonds series and/or parallel circuit and terminals greater than > or less than <Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal and/or Vertical−Horizontal from Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy data streamidentification key tone in resonant wavelength frequency order of spheroid-centric cell and photovoltaic film series and/or parallel circuit data stream reception and signal wavelength frequency emission. Numeric molecular photovoltaic reception cell and circuit element A ionic or anionic electron valences particle parts 1+part and/or 1−part highly pure electron molecule enrichment, element B ionic or anionic electron valences particle parts 1+part and/or 1−part highly pure electron molecule enrichment, element A complex ionic or anionic electron valences particle parts 1+part and/or 1−part highly pure electron molecule enrichment and element B complex ionic or anionic electron valences particle parts 1+part and/or 1−part highly pure electron molecule enrichment. Element positive or negative parts are specification element paste, gel, liquid, vapour or gaseous suspended in comparative series and/or parallel circuit cell receptors centers and/or delineations fabricated in polynumber and planes, trifocal, trigonal and linear 1-molar, 2-planar, 3-declination, 4-inclination, 5-convex, and 6-All-star system transform-noise molecular geometry. Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy identification key tone in resonant wavelength frequency atomic orbital as a mathematical function order of spheroid-centric cell parts receptors centers and/or delineations fabricated in polynumber and planes, trifocal, trigonal and linear 1-molar, 2-planar, 3-declination, 4-inclination, 5-convex, and 6-All-star system transform-noise molecular geometry of one to three electrons in an atom involving d, s and/or p orbitals polynumber and planes, linear σ and/or π 3.1415926535897932384626433832795 bonds series and/or parallel circuit and terminals greater than > or less than <Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal and/or Vertical−Horizontal from Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy data stream identification key tone in resonant wavelength frequency order of spheroid-centric cell and photovoltaic film series and/or parallel circuit data stream reception and signal wavelength frequency emission. Numeric molecular photovoltaic reception cell and circuit element A ionic or anionic electron valences particle parts 1+part and/or 1−part highly pure electron molecule enrichment, element B ionic or anionic electron valences particle parts 1+part and/or 1−part highly pure electron molecule enrichment, element A complex ionic or anionic electron valences particle parts 1+part and/or 1−part highly pure electron molecule enrichment and element B complex ionic or anionic electron valences particle parts 1+part and/or 1−part highly pure electron molecule enrichment. Element positive or negative parts are specification element paste, gel, liquid, vapour or gaseous suspended in comparative series and/or parallel circuit cell receptors centers and/or delineations fabricated in polynumber and planes, trifocal, trigonal and linear 1-molar, 2-planar, 3-declination, 4-inclination, 5-convex, and 6-All-star system transform-noise molecular geometry. Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy identification key tone in resonant wavelength frequency atomic orbital as a mathematical function order of spheroid-centric cell parts receptors centers and/or delineations fabricated in polynumber and planes, trifocal, trigonal and linear 1-molar, 2-planar, 3-declination, 4-inclination, 5-convex, and 6-All-star system transform-noise molecular geometry of one to three electrons in an atom involving d, s and/or p orbitals polynumber and planes, linear σ and/or π 3.1415926535897932384626433832795 bonds series and/or parallel circuit and terminals greater than > or less than <Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal, Vertical−Horizontal, Left+Right, Left−Right, Vertical+Horizontal and/or Vertical−Horizontal from Central processing unit CPU photovoltaic electron molecule generator wavelength frequency counter and analyzer added and subtracted changes order of wavenumber data stream output nanoseconds processing in series and/or parallel circuit numeric cell electron molecule signal wavelength frequency emission and numeric cell electron molecule key tone in atomic polynumber and planes, linear σ and/or π 3.1415926535897932384626433832795 bonds emissions in electron volts electron volts eV, Joules J, and Coulombs C volts of data stream generation series and/or parallel circuit memory alloy data stream identification key tone in resonant wavelength frequency order of spheroid-centric cell and photovoltaic film series and/or parallel circuit data stream reception and signal wavelength frequency emission. Two sided panel shell thermoelectrically sealed vertical and horizontal sectors in series and parallel circuits highly pure metal alumina atomic symbol Al number, 13 annealing, drawing, and spun rolled-wound fine wire or press rolled flat strips fine wire and shielding analogous scanning photo chemical electron molecule enriched conductive emissions data stream allotropes of carbon, alumina nanoparticles, copper nanoparticles, colloidal gold, silver nanoparticles, iron nanoparticles, molecular tool steel, molecular super alloy, element nanoparticles, platinum nanoparticles series circuit waveform generation symbol light of CMY cyan, magenta, yellow, RGB red, green, blue, and analogous scanning photo chemical electron molecule enriched conductive emissions data stream allotropes of carbon, alumina nanoparticles, copper nanoparticles, colloidal gold, silver nanoparticles, iron nanoparticles, molecular tool steel, molecular super alloy, element nanoparticles, platinum nanoparticles series circuit waveform generation symbol light of beryllium Be4 inductor, magnesium Mg12 inductor, carbon C6 nanoparticle conductor, copper Cu29 conductor and alternate carbon nanofoam C6 inductor ACNFI atomic number 6 symbol C pure light, filtered light, colored light and reflective light wavelength frequency received in nanoseconds processing by Central processing unit CPU photovoltaic electron molecule wavelength shift generator frequency counter and frequency analyzer order of Central processing unit CPU photovoltaic electron molecule wavelength shift generator added and subtracted changes order of wavenumber data stream output nanoseconds processor spectra wavelength frequency pure light, filtered light, colored light, and reflective light data stream generation random access memory RAM and Electronic Storage Medium writable random access memory WRAM compact disc. The universal spectra camera and monitor glass bead molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered optical cables light emissions data stream wavelength frequency photogray, photocolor and photochemical element optical lens light filtered light wavelength generation identification and photo active chemical electron molecule element scanning analogous series and parallel alumina atomic symbol Al and number 13 wire and shielding+/−wavelength shift generator data stream generation random access memory RAM and Electronic Storage Medium writable random access memory WRAM compact disc data streams series viewing of the universal spectra camera and monitor panel shell thermoelectrically sealed sectors numeric 1-highly pure mineral or complex element electrolyte Liquid, gel or vapour crystal mineralization acid, base or alkyl light emitting diode LED and 2-symbol generator light optical reflective beads reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead, Liquid, gel or vapour crystal mineralization acid, base or alkyl light emitting diode LED reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead, and Liquid crystal mineralization light emitting diode LED reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead alumina Al13 strips occupying vertical and horizontal segments of photo graphic picture resolution light emitting diode LED cells in CMY cyan, magenta, yellow, RGB red, green, blue, filtered light and specification colors series and parallel highly pure metal alumina atomic symbol Al number 13 annealing, drawing, and spun rolled-wound fine wire or press rolled flat strips fine wire and shielding equal to vertical and horizontal picture resolution. Chlorophyll A ionic or anionic 2-parts 1+positive and 1−negative enriched chemical electron molecules and B ionic or anionic 2-parts 1+positive and 1−negative enriched chemical electron molecules photo active chemical electron molecule element film cells in series and parallel circuits Chlorophyll A ionic or anionic 2-parts 1+positive and 1−negative enriched chemical electron molecules and B ionic or anionic 2-parts 1+positive and 1−negative enriched chemical electron molecules photo active chemical electron molecule element film cells emissions data stream in wavelength frequency counter and analyzer order of photo emissions data stream photogray, photocolor and photochemical element optical lens light filtered light wavelength generation identification scanning analogous photo active chemical electron molecule element film cells circuits data stream output+/−wavelength shift generator. The CMY cyan, magenta, yellow, RGB red, green, blue, and beryllium Be4 inductor, magnesium Mg12 inductor, carbon C6 nanoparticle conductor, copper Cu29 conductor and alternate carbon nanofoam C6 inductor ACNFI atomic number 6 symbol C pure light, filtered light, colored light and reflective light wavelength frequency received in nanoseconds processing by Central processing unit CPU photovoltaic electron molecule wavelength shift generator frequency counter and frequency analyzer order of Central processing unit CPU photovoltaic electron molecule wavelength shift generator added and subtracted changes of the order of wavenumber data stream output nanoseconds processor spectra wavelength frequency pure light, filtered light, colored light, and reflective light data streams series viewing sectors numeric 1-highly pure mineral or complex element electrolyte Liquid, gel or vapour crystal mineralization acid, base or alkyl light emitting diode LED and 2-symbol generator light optical reflective beads reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead, Liquid, gel or vapour crystal mineralization acid, base or alkyl light emitting diode LED reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead, and Liquid crystal mineralization light emitting diode LED reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead alumina Al13 strips occupying vertical and horizontal segments of photo graphic picture resolution light emitting diode LED cells in CMY cyan, magenta, yellow, RGB red, green, blue, filtered light and specification colors series and parallel highly pure metal alumina atomic symbol Al number 13 annealing, drawing, and spun rolled-wound fine wire or press rolled flat strips fine wire and shielding equal to the vertical and horizontal picture resolution. Two sided panel shell consists numeric sums of reflected delineations occupying vertical and horizontal segments equal to photo graphic picture resolution of integrated or polarized greater than higher temperatures of ˜1700° C. and 2200° C. crystalline silica optical reflective glass beads spectra light filtered and non filtered specifications, lower and greater than lower temperatures of ˜178° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications. Similarly greater than higher temperatures of ˜1700° C. and 2200° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications, lower and greater than lower temperatures of ˜178° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications. Liquid dispersion supersaturated liquids of condensation-nuclei matters one, two or more composites 0° C. or 32° F. of optical beads and optical cable line manufacturing are light makeweight heated or chilled chemical ionic acid usually an amino acid, non ionic bases usually nitrogen/hydrogen or non ionic groups of amphoteric polysaccharide linear or branched alkyl compounds usually methyl liquid dispersion optical grade Silica spectra light filtered and non filtered specifications, optical grade polyamide silica spectra light filtered and non filtered specifications, continuous forged liquid dispersion optical grade silica line cable spectra light filtered and non filtered specifications, continuous forged liquid dispersion optical grade polyamide silica line cable spectra light filtered and non filtered specifications equivalent condensation-nuclei type size particles measure in microns Symbol μ lower-case letter mu metric SI. Integrated or polarized alignment circuit optical reflective beads emissions of light spectra wavelength frequency onto optical reflective cables process in nanoseconds spectra wavelength frequency to central processing unit CPU wavelength shift and light symbol generator frequency counter and frequency analyzer order of wavelength frequency added and subtracted changes order of wavenumber data stream output in nanoseconds processing spectra wavelength frequency and light symbol generation pure light, filtered light, colored light, and reflective light and data stream generation random accessible memory RAM and Electronic Storage Medium writable random accessible memory WRAM compact disc. Two sided panel shell consists numeric sums of reflected centers occupying vertical and horizontal segments equal to photo graphic picture resolution of integrated or polarized greater than higher temperatures of ˜1700° C. and 2200° C. crystalline silica optical reflective glass beads spectra light filtered and non filtered specifications, lower and greater than lower temperatures of ˜178° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications. Similarly greater than higher temperatures of ˜1700° C. and 2200° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications, lower and greater than lower temperatures of ˜178° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications. Liquid dispersion supersaturated liquids of condensation-nuclei matters one, two or more composites 0° C. or 32° F. of optical beads and optical cable line manufacturing are light makeweight heated or chilled chemical ionic acid usually an amino acid, non ionic bases usually nitrogen/hydrogen or non ionic groups of amphoteric polysaccharide linear or branched alkyl compounds usually methyl liquid dispersion optical grade Silica spectra light filtered and non filtered specifications, optical grade polyamide silica spectra light filtered and non filtered specifications, continuous forged liquid dispersion optical grade silica line cable spectra light filtered and non filtered specifications, continuous forged liquid dispersion optical grade polyamide silica line cable spectra light filtered and non filtered specifications equivalent condensation-nuclei type size particles measure in microns Symbol μ lower-case letter mu metric SI. Integrated or polarized alignment circuit optical reflective beads emissions of light spectra wavelength frequency onto optical reflective cables process in nanoseconds spectra wavelength frequency to central processing unit CPU wavelength shift and light symbol generator frequency counter and frequency analyzer order of wavelength frequency added and subtracted changes order of wavenumber data stream output in nanoseconds processing spectra wavelength frequency and light symbol generation pure light, filtered light, colored light, and reflective light and data stream generation random accessible memory RAM and Electronic Storage Medium writable random accessible memory WRAM compact disc. Two sided panel shell consists numeric sums of reflective centers of integrated or polarized greater than higher temperatures of ˜1700° C. and 2200° C. crystalline silica optical reflective glass beads spectra light filtered and non filtered specifications, lower and greater than lower temperatures of ˜178° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications. Similarly greater than higher temperatures of ˜1700° C. and 2200° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications, lower and greater than lower temperatures of ˜178° C. molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications. Liquid dispersion supersaturated liquids of condensation-nuclei matters one, two or more composites 0° C. or 32° F. of optical beads and optical cable line manufacturing are light makeweight heated or chilled chemical ionic acid usually an amino acid, non ionic bases usually nitrogen/hydrogen or non ionic groups of amphoteric polysaccharide linear or branched alkyl compounds usually methyl liquid dispersion optical grade Silica spectra light filtered and non filtered specifications, optical grade polyamide silica spectra light filtered and non filtered specifications, continuous forged liquid dispersion optical grade silica line cable spectra light filtered and non filtered specifications, continuous forged liquid dispersion optical grade polyamide silica line cable spectra light filtered and non filtered specifications equivalent condensation-nuclei type size particles measure in microns Symbol μ lower-case letter mu metric SI. Integrated or polarized alignment circuit optical reflective cables emissions of light spectra wavelength frequency symbol generator light onto optical reflective beads processed in nanoseconds spectra wavelength frequency from central processing unit CPU wavelength shift and light symbol generator frequency counter and frequency analyzer order of wavelength frequency added and subtracted changes order of wavenumber data stream output in nanoseconds processing spectra wavelength frequency and light symbol generation pure light, filtered light, colored light, and reflective light emissions data stream. The KIOSK universal spectra camera and monitor panel shell thermoelectrically sealed vertical and horizontal sectors numeric 1-highly pure mineral or complex element electrolyte Liquid, gel or vapour crystal mineralization acid, base or alkyl light emitting diode LED and 2-symbol generator light optical reflective beads reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead, Liquid, gel or vapour crystal mineralization acid, base or alkyl light emitting diode LED reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead, and Liquid crystal mineralization light emitting diode LED reflective magnification molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels glass bead alumina Al13 strips occupying vertical and horizontal segments of photo graphic picture resolution light emitting diode LED cells in CMY cyan, magenta, yellow, RGB red, green, blue, filtered light and specification colors integrated or polarized alignment optical high purity panel, molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels molten diffusion particulate matter PM melts crystalline silica optical, crystalline silica carbon nanoparticle and/or alumina nanoparticle optical, crystalline silica natural polyamide synthetic polymer optical, crystalline silica cellulosic natural polyamide, and crystalline silica cellulosic rubber natural polyamide, filtered and non filtered specifications beads, gels, cables, lenses, up to or greater >1.25 inch left to right vertical and horizontal picture resolution integrated and polarized photogray, photocolor and photochemical light filtered light identification photo chemically active electron molecule film mirrors, visors and panels gels finished touch screen kiosk in series circuits highly pure metal alumina atomic symbol Al number 13 annealing, drawing, and spun rolled-wound fine wire or press rolled flat strips fine wire and shielding receiving negative electron molecules wavelength frequency beryllium Be4 inductor, magnesium Mg12 inductor, carbon C6 nanoparticle conductor, copper Cu29 conductor and alternate carbon nanofoam C6 inductor ACNFI touch screen kiosk sensory cells panel shell thermoelectrically sealed vertical and horizontal sectors series circuits highly pure metal alumina atomic symbol Al number 13 annealing, drawing, and spun rolled-wound fine wire or press rolled flat strips fine wire and shielding process in nanoseconds negative electron molecules wavelength frequency to central processing unit CPU wavelength generator added and subtracted changes of the order of wavenumber data stream output nanoseconds processor negative electron molecules wavelength frequency. Keyboard computing device typewriter-style arrangement of keys supplied by a central processing unit CPU processor made up of a manual mechanical arrangement of keys in series and parallel circuits occupying a horizontal plane with various ports, and plug-ins connectivity. Keyboard key parts in series and parallel analogous circuits of enriched highly pure metal molecular copper atomic symbol Cu and number 29, and alumina atomic symbol Al number 13 annealing, drawing, and spun rolled-wound fine wire or press rolled flat strips fine wire and shielding receiving negative electron molecules wavelength frequency keys from keyboard process in nanoseconds electron molecules wavelength frequency keys to central processing unit CPU processor wavelength generator added and subtracted changes of the order of wavenumber data stream output nanoseconds processing electron molecules wavelength frequency keys identification and series data stream generation random access memory RAM and Electronic Storage Medium writable random access memory WRAM compact disc data streams+/−connectivity. The keys consist of and not limited Arabic number keys 0, 1, 2, 3, 4, 5, 6, 7, 8, and 9, various symbol keys transposed on top of number keys !, @, #, $, %, A, &, *, (, and ), various symbol keys occupy their own keys and keys transposed on top of various symbol keys −, =, [, ], \, ;, ′, ,, ., /, ', _, +, {, }, |, :, ″, <, >, ?, and ˜, The International Organization for Standardization ISO basic Latin-script alphabet consists of the following 26 letters alphabet keys in upper-case Q, W, E, R, T, Y, U, I, O, P, A, S, D, F, G, H, J, K, L, Z, X, C, V, B, N, and M, alphabet key in lower-case q, w, e, r, t, y, u, I, o, p, a, s, d, f, g, h, j, k, l, z, x, c, v, b, n, and m, function specific keys space bar, enter, escape, shift, tab, alternate, escape, control, number lock, caps lock, backspace, right arrow, left arrow, up arrow, down arrow, all direction arrow, page-up, page-down, control, function, consecutive Function F1 to F12, home, end, pause, insert, and delete. Central processing unit CPU data stream generator transfer and exchange carrier phase L1 and L2 waveform pulse train signals modes 4 four mode-1 convex waveform cycles ˜ less than < and equal to carrier narrowband 12.5 kHz bandwidth, mode-2 polynumber waveform cycle ˜ less than < and equal to carrier narrowband 12.5 kHz bandwidth N1, N2, N3, N4, N5, N6, N7, N8, N9, N10, N11 & N12, mode-3 inclination waveform cycle [symbol] less than < and equal to carrier narrowband 12.5 kHz bandwidth and mode-4 declination waveform cycle [symbol] less than < and equal to carrier bandwidth wavenumber data added and subtracted order identification in nanoseconds processing Carrier phase L1 and L2 waveform frequency received by analogous efficiency data stream generator transfer and exchange Federal Communication Commission FCC industrial bandwidth kHz random access memory processing integrated internet access and search, photovoltaic video processing, audio processing, scientific calculator, drafting, plotting, drawing, keyboard entry, alidade paint marker input, level, square, force transducer, surveying measurement device, and computer integrated federal airspace system in latitudinal and longitudinal universal transverse Mercator UTM and aviation sectional data. The pure light, filtered light, colored light, and reflective light data stream output spectra wavelength frequency is received by Central processing unit CPU photovoltaic electron molecule wavelength shift generator printer of pure light, filtered light, colored light, and reflective light supersaturated particulate matter colored and shaded scale pigments natural polymer-carbonaceous inks, toner powders and printed films. Number 17. Analogous series and parallel circuits highly pure metals, super alloys, specification 56 elements, beryllium Be4, beryllium Be4 inductor, magnesium Mg12, magnesium Mg12 inductor, copper Cu29 conductor, aluminum al13 conductor, carbon C6 nanoparticle conductor and alternate C6 carbon nanoparticle inductor ACNFI drawing, annealing, spun and wound coils, windings, extremely fine insulated wire, strips and insulated shielding are made for analogous series and parallel intelligence chemical electron molecule circuits photon and sensor. The analogous series and parallel intelligence chemical electron molecule circuits photon and sensor serve relays, switches, sensors, battery cells, audio processors, spectrometric processors, spectrometric processor flight computer L1 and L2 central processing unit processors spectrometric artificial horizon All-star system transform-noise visual display up VDU optical lens and optical lenses into sexton optical alidade scientific optical mirror or touch-tone key pad Universal Transverse Mercator UTM numbered coordinate entry integrated server L1 and L2 central processing unit CPU processors. The analogous series and parallel intelligence chemical electron molecule circuits photon and sensor serve relays, switches, sensors, battery cells, audio processors, spectrometric processors, spectrometric processor flight computer L1 and L2 central processing unit processors spectrometric artificial horizon All-star system transform-noise visual display up VDU optical lens and optical lenses into sexton optical alidade scientific optical mirror or touch-tone key pad Universal Transverse Mercator UTM numbered coordinate entry integrated server L1 and L2 central processing unit CPU processors component Liquids of condensation molecular enriched purification parts spheroid-centric cells analogous processors scientific g-force instrument, motion sensor, pitch-lateral flight/rate, roll-longitudinal flight/rate, yaw-directional flight/rate, magnetic-flux compensator C 6 nanoparticle brush-inductor antinode coupler compass, aircraft pitot static system super alloy pitot tube and static air barometric pressure airspeed indication, vertical speed indicator and altitude altimeter force transducer scientific measure of change in super alloy insulated scientific barometric pressure chambers and outside static air temperature-humidity processors computation not limited to Specification 56 molecular elements including and not limited to chemical compositions Acid hydrogen fluoride HF, and Alkaline phenyl Lithium C₆H₅⁺Li⁺. Microphone/Speaker component Liquids of condensation molecular enriched purification parts microphone spheroid-centric cells and speaker spheroid-centric cells serve molecular audio component circuits with or without printed audio processors. Microphone/Speaker component Liquids of condensation molecular enriched purification parts microphone spheroid-centric cells and speaker spheroid-centric cells enriched platinum Pt78, colloidal gold Au79, silver Ag47, Specification 56 molecular element, super alloy, beryllium Be4 inductor, magnesium Mg12 inductor, carbon C6 nanoparticle conductor, copper Cu29 conductor, alternate carbon nanofoam C6 inductor ACNFI, allotropes of carbon ionic suspension molecular element and complex element spheroid-centric cell including nickel Ni28 and aluminum Al13. Generators/Transceivers component Liquids of condensation molecular enriched purification and/or molecular enriched oxygen 2 0 2 enrichment crystallization and mineralization parts, molecular element and complex element spheroid-centric cell, chemical element acid, base, alkyl, specification 56 element, and super alloy. Generators/Transceivers component Liquids of condensation molecular enriched purification and/or molecular enriched oxygen 2 0 2 enrichment molecular part spheroid-centric cell and/or allotropes of carbon ionic suspension molecular element and complex element spheroid-centric cell including molecular enriched oxygen 2 0 2 enrichment part quartz S16, diamond No3, silicon dioxide SiO2, allotropes of carbon ionic suspension element molecular enriched part including nickel Ni28, cadmium Cd48, lithium Li4, magnesium Mg12, beryllium Be4, platinum Pt78, colloidal gold Au79, silver Ag47, Specification 56 molecular element, including and not limited to chemical compositions Acid hydrogen fluoride HF, Alkaline phenyl Lithium C₆H₅⁻Li⁺ and super alloy.
